(19) United States
(12) Patent Application Publication
(10) Pub. No.: US 2026/0135996 A1
(43) Pub. Date: May 14, 2026

(54) POINT CLOUD CODING METHOD AND STORAGE MEDIUM

(71) Applicant: GUANGDONG OPPO MOBILE TELECOMMUNICATIONS CORP., LTD., Dongguan (CN)

(72) Inventor: Zexing SUN, Dongguan (CN)

(21) Appl. No.: 19/443,162

(22) Filed: Jan. 8, 2026

Related U.S. Application Data
(63) Continuation of application No. PCT/CN2023/106659, filed on Jul. 10, 2023.

(51) Int. Cl. H04N 19/107; H04N 19/503; H04N 19/593; H04N 19/61

(52) U.S. Cl. CPC H04N 19/107; H04N 19/503; H04N 19/593; H04N 19/61

(57) ABSTRACT

A point cloud coding method is provided in embodiments of the disclosure. A point cloud decoding method includes the following. A bitstream is parsed to determine a region adaptive hierarchical transform (RAHT) coding mode for a current layer and attribute coding information of nodes in the current layer, where the RAHT coding mode for the current layer is determined by an encoder based on at least one coding cost corresponding to the nodes in the current layer, and the at least one coding cost corresponding to the nodes is determined by the encoder by encoding attribute information of the nodes using at least one RAHT coding mode. Decoding reconstruction is performed on the attribute coding information of the nodes in the current layer based on the RAHT coding mode for the current layer, to determine reconstructed attribute information of the nodes.

### CROSS-REFERENCE TO RELATED APPLICATION(S)

This application is a continuation of International Application No. PCT/CN2023/106659, filed Jul. 10, 2023, the entire disclosure of which is hereby incorporated by reference.

### TECHNICAL FIELD

Embodiments of the disclosure relate to the field of point cloud compression technology, in particular to a point cloud coding method and a storage medium.

### BACKGROUND

In a geometry-based point cloud compression (G-PCC) coding framework or a video-based point cloud compression (V-PCC) coding framework provided by the moving picture experts group (MPEG), geometry information and attribute information of the point cloud are encoded separately.

Currently, encoding of the attribute information mainly aims at encoding of colour information. During encoding of the colour information, there are mainly three transform methods, including predicting transform (PT) and lifting transform (LT) which rely on level of detail (LOD) partitioning, and octree-based region adaptive hierarchical transform (RAHT).

For RAHT coding, when a condition for RAHT prediction transform coding is satisfied, an RAHT coding layer in which an RAHT inter prediction transform mode is used for coding is specified in a point cloud to-be-coded, and only an RAHT intra prediction coding mode is used for a lower RAHT coding layer(s). In a current RAHT coding scheme, whether the condition for RAHT prediction transform coding is satisfied is determined according to the number of neighbourhood nodes of a current node. If the condition for RAHT prediction transform coding is satisfied, RAHT prediction transform coding is performed on attribute information of the current node. Otherwise, only RAHT transform is performed on the attribute information of the current node. In this coding method, only spatial correlation, especially neighbourhood geometric spatial correlation, of each node is used to determine an RAHT coding mode for attribute information of each node, resulting in low coding efficiency of the attribute information.

### SUMMARY

In a first aspect, a decoding method is provided in embodiments of the disclosure. The method is applied to a decoder and includes the following. A bitstream is parsed to determine a region adaptive hierarchical transform (RAHT) coding mode for a current layer and attribute coding information of nodes in the current layer, where the RAHT coding mode for the current layer is determined by an encoder based on at least one coding cost corresponding to the nodes in the current layer, and the at least one coding cost corresponding to the nodes is determined by the encoder by encoding attribute information of the nodes using at least one RAHT coding mode. Decoding and reconstruction is performed on the attribute coding information of the nodes in the current layer based on the RAHT coding mode for the current layer, to determine reconstructed attribute information of the nodes.

In a second aspect, an encoding method is provided in embodiments of the disclosure. The method is applied to an encoder and includes the following. Attribute information of nodes in a current layer is encoded using at least one RAHT coding mode, to determine at least one candidate attribute coding information and at least one coding cost corresponding to the nodes. An RAHT coding mode for the current layer is determined based on the at least one coding cost corresponding to the nodes, and attribute coding information of the nodes is determined from the at least one candidate attribute coding information. A bitstream is generated based on the RAHT coding mode for the current layer and the attribute coding information of the nodes.

In a third aspect, a non-transitory storage medium is provided in embodiments of the disclosure. The non-transitory storage medium is configured to store a computer program and a bitstream. When executed by a processor, the computer program causes the processor to implement the encoding method of the second aspect to generate the bitstream.

### BRIEF DESCRIPTION OF THE DRAWINGS

FIG. 1A is a schematic diagram of a three-dimensional (3D) point cloud picture.

FIG. 1B is a partial enlarged view of a 3D point cloud picture.

FIG. 2A is a schematic diagram illustrating six viewing angles of a point cloud picture.

FIG. 2B is a schematic diagram of a data storage format of a point cloud picture.

FIG. 3 is a schematic diagram of a network architecture of point cloud coding.

FIG. 4A is a schematic diagram of a framework of a geometry-based point cloud compression (G-PCC) encoder.

FIG. 4B is a schematic diagram of a framework of a G-PCC decoder.

FIG. 5A is a schematic diagram illustrating low plane positions in a z-axis direction.

FIG. 5B is a schematic diagram illustrating high plane positions in a z-axis direction.

FIG. 6 is a schematic diagram of a node encoding order.

FIG. 7A is a schematic diagram of planar flag information.

FIG. 7B is another schematic diagram of planar flag information.

FIG. 8 is a schematic diagram of sibling nodes of a current node.

FIG. 9 is a schematic diagram illustrating intersection of a lidar with nodes.

FIG. 10 is a schematic diagram of a neighbourhood node at the same partitioning depth and the same coordinate.

FIG. 11 is a schematic diagram of a current node at a low plane position of a parent node.

FIG. 12 is a schematic diagram of a current node at a high plane position of a parent node.

FIG. 13 is a schematic diagram illustrating predictive coding of plane position information of a lidar point cloud.

FIG. 14 is a schematic diagram illustrating inferred direct coding mode (IDCM) coding.

FIG. 15 is a schematic diagram illustrating coordinate transform of a point cloud obtained by a rotating lidar.

FIG. 16 is a schematic diagram illustrating predictive coding in an x-axis or y-axis direction.

FIG. 17A is a schematic diagram illustrating a y-planar angle predicted using a horizontal azimuth angle.

FIG. 17B is a schematic diagram illustrating an x-planar angle predicted using a horizontal azimuth angle.

FIG. 18 is another schematic diagram illustrating predictive coding in an x-axis or y-axis direction.

FIG. 19A is a schematic diagram illustrating three vertices in a block.

FIG. 19B is a schematic diagram illustrating a triangle soup (trisoup) fitted using three vertices.

FIG. 19C is a schematic diagram illustrating up-sampling of a trisoup.

FIG. 20 is a schematic diagram illustrating distance-based level of detail (LOD) construction.

FIG. 21 is a schematic diagram illustrating a visualization result of LOD generation.

FIG. 22 is a schematic flowchart of attribute prediction coding.

FIG. 23 is a schematic diagram of composition of a pyramid structure.

FIG. 24 is another schematic diagram of composition of a pyramid structure.

FIG. 25 is a schematic diagram of an LOD structure for inter-layer nearest-neighbour search.

FIG. 26 is a schematic structural diagram illustrating nearest-neighbour search based on a spatial relationship.

FIG. 27A is a schematic diagram illustrating a coplanar spatial relationship.

FIG. 27B is a schematic diagram illustrating a coplanar or collinear spatial relationship.

FIG. 27C is a schematic diagram illustrating a coplanar, collinear, or concurrent spatial relationship.

FIG. 28 is a schematic diagram illustrating inter-layer prediction based on fast search.

FIG. 29 is a schematic diagram of an LOD structure for attribute intra-layer nearest-neighbour search.

FIG. 30 is a schematic diagram illustrating intra-layer prediction based on fast search.

FIG. 31 is a schematic structural diagram illustrating block-based neighbourhood search.

FIG. 32 is a schematic flowchart of lifting transform coding.

FIG. 33 is a schematic structural diagram illustrating region adaptive hierarchical transform (RAHT) transform.

FIG. 34 is a schematic diagram illustrating RAHT transform along x, y, and z directions.

FIG. 35A is a schematic diagram illustrating RAHT forward transform.

FIG. 35B is a schematic diagram illustrating RAHT inverse transform.

FIG. 36 is a schematic structural diagram of an attribute coding block.

FIG. 37 is a schematic diagram of an overall process of RAHT attribute prediction transform coding.

FIG. 38 is a schematic diagram illustrating a neighbourhood prediction relationship of a current block.

FIG. 39 is a schematic diagram illustrating calculation of an attribute transform coefficient.

FIG. 40 is a schematic structural diagram illustrating RAHT attribute inter prediction coding.

FIG. 41 is a schematic flowchart of a point cloud encoding method provided in embodiments of the disclosure.

FIG. 42 is a schematic flowchart of a point cloud decoding method provided in embodiments of the disclosure.

FIG. 43 is a schematic structural diagram of an encoder provided in embodiments of the disclosure.

FIG. 44 is a schematic diagram of a specific hardware structure of an encoder provided in embodiments of the disclosure.

FIG. 45 is a schematic structural diagram of a decoder provided in embodiments of the disclosure.

FIG. 46 is a schematic diagram of a specific hardware structure of a decoder provided in embodiments of the disclosure.

FIG. 47 is a schematic structural diagram of a coding system provided in embodiments of the disclosure.

### DETAILED DESCRIPTION

To enable a more detailed understanding of features and technical content in embodiments of the disclosure, the embodiments of the disclosure will be described in detail below in conjunction with the accompanying drawings, which are provided for illustrative purposes only and are not intended to limit embodiments of the disclosure.

Unless otherwise defined, all technical and scientific terms used herein have the same meaning as commonly understood by those skilled in the art. The terms used herein are for the purpose of describing embodiments of the disclosure only and are not intended to limit the disclosure.

In the following description, reference to “some embodiments” describes a subset of all possible embodiments, but it will be understood that “some embodiments” may refer to the same or different subsets of all possible embodiments and may be combined with each other without conflict.

It may be further noted that the terms “first/second/third” in embodiments of the disclosure are merely for distinguishing similar objects and do not imply a particular ordering with respect to the objects, and it will be understood that “first/second/third” may, where appropriate, be interchanged in a particular order or sequence so that embodiments of the disclosure described herein can be implemented in an order other than that illustrated or described herein.

A point cloud coding method, an encoder, a decoder, a bitstream, and a storage medium are provided in embodiments of the disclosure. In embodiments of the disclosure, the decoder performs decoding and reconstruction on attribute coding information of nodes in a current layer according to an RAHT coding mode transmitted by the encoder, to determine reconstructed attribute information of the nodes. The RAHT coding mode for the current layer is an optimal coding mode for the current layer determined by the encoder according to at least one coding cost corresponding to each node in the current layer. In particular, through comprehensive consideration of attribute distribution characteristics and spatial distribution characteristics of each node, the encoder encodes each node in the current layer using at least one RAHT coding mode, to determine the at least one coding cost corresponding to each node. Accordingly, the decoder selects a decoding mode for decoding according to the RAHT coding mode for the current layer, so that attribute information of the current layer can be decoded according to the optimal RAHT coding mode for the current layer transmitted by the encoder. As such, by adaptively selecting an optimal coding mode from multiple coding modes, the RAHT attribute coding efficiency and the decoding efficiency of attribute information of a point cloud are improved, and thus the decoding performance of the point cloud is improved.

Point cloud is a three-dimensional (3D) representation of the surface of an object. The point cloud (data) of the surface of the object can be collected by means of a collection device such as a photo radar, a lidar, a laser scanner, and a multi-view camera.

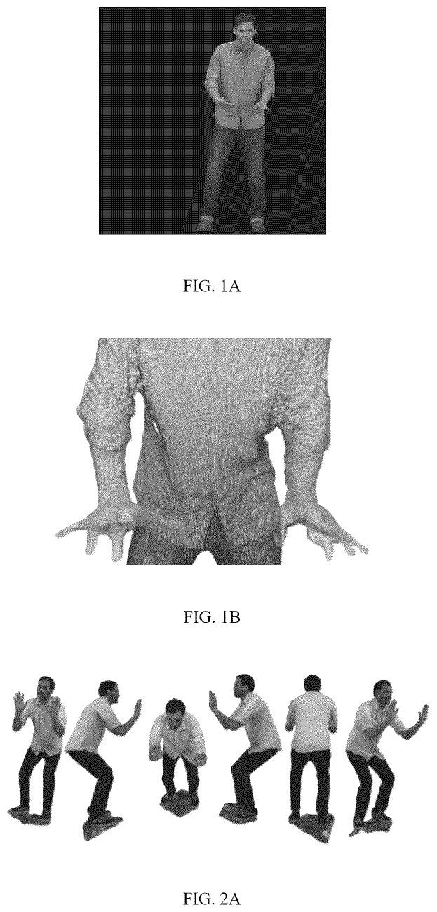

Point cloud is a collection of irregularly-distributed discrete points in space that represent the spatial structure and surface attributes of a 3D object or scene. FIG. 1A illustrates a 3D point cloud picture, and FIG. 1B is a partial enlarged view of a 3D point cloud picture. As can be seen, a surface of the point cloud is composed of densely-distributed points.

Since a two-dimensional picture has information representation at each pixel distributed regularly, position information thereof does not need to be recorded additionally. However, since points in the point cloud are distributed randomly and irregularly in 3D space, a position of each point in the space needs to be recorded, so that the point cloud can be represented completely. Similar to the two-dimensional picture, each position has corresponding attribute information in a collection process, that is, usually a red green blue (RGB) colour value. A colour value reflects a colour of an object. For the point cloud, in addition to colour information, the attribute information corresponding to each point often includes a reflectance value. The reflectance value reflects a surface material of an object. Therefore, point cloud data usually includes geometry information consisting of 3D position information and attribute information consisting of 3D colour information and one-dimensional reflectance information. A point in the point cloud may include both position information and attribute information of the point. For example, the position information of the point may be 3D coordinate information (x, y, z) of the point. The position information of the point may also be referred to as geometry information of the point. For example, the attribute information of the point may include colour information (3D colour information) and/or reflectance (one-dimensional reflectance information r), etc. For example, the colour information may be information on any colour space. For example, the colour information may be RGB information, where R represents red, G represents green, and B represents blue. Another example of the colour information may be luminance-chrominance (YCbCr, YUV) information, where Y represents brightness (Luma), Cb (U) represents blue chrominance, and Cr (V) represents red chrominance.

For a point cloud obtained based on laser measurement, a point in the point cloud may include 3D coordinate information of the point and a reflectance value of the point. For a point cloud obtained based on photogrammetry, a point in the point cloud may include 3D coordinate information of the point and 3D colour information of the point. For a point cloud obtained based on laser measurement and photogrammetry, a point in the point cloud may include the 3D coordinate information of the point, the reflectance value of the point, and the 3D colour information of the point.

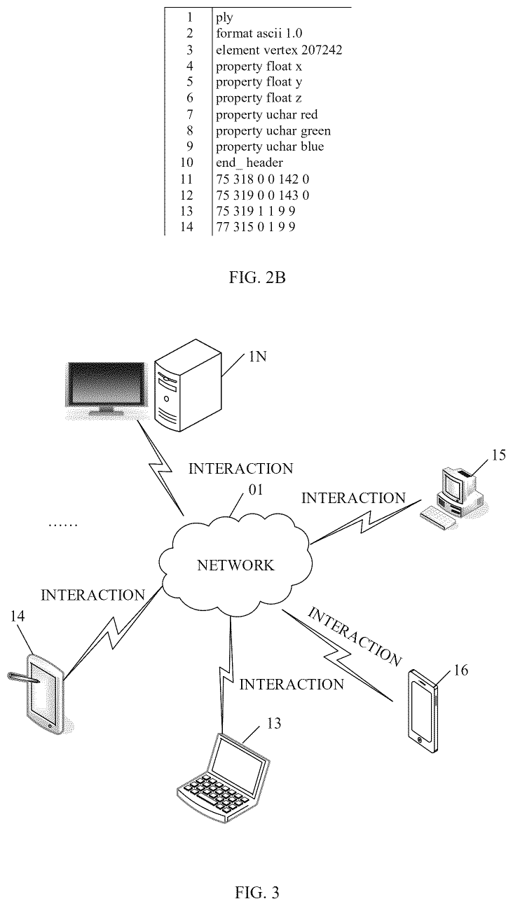

FIG. 2A and FIG. 2B illustrate a point cloud picture and a data storage format of the point cloud picture, respectively. FIG. 2A provides six viewing angles of the point cloud picture. FIG. 2B consists of header information and data. The header information contains a data format, a data representation type, the total point number of the point cloud, and the content represented by the point cloud. For example, the point cloud is in “.ply” format and represented by ASCII codes, with the total point number of 207242. Each point has 3D coordinate information (x, y, z) and 3D colour information (r, g, b).

Point clouds may be classified according to the obtaining manners as:
a static point cloud, i.e., the object is stationary and the point cloud obtaining device is also stationary;
a dynamic point cloud: the object is in motion, but the point cloud obtaining device is stationary; and
a dynamically-obtained point cloud: the point cloud obtaining device is in motion.

For example, point clouds may be classified into two main categories according to usage:
category 1: machine perception point cloud, which may be used in scenarios such as autonomous navigation systems, real-time inspection systems, geographic information systems, visual sorting robots, and rescue and disaster relief robots; and
category 2: human eye perception point cloud, which may be used in scenarios such as digital cultural heritage, free point-of-view broadcasting, 3D immersive communication, and 3D immersive interaction.

The point cloud can represent the spatial structure and surface attributes of the 3D object or scene in a flexible and convenient manner. In addition, since the point cloud is obtained by directly sampling a real object, which can exhibit an extremely realistic effect on the premise of ensuring precision, the point cloud has a wide range of application, including virtual reality games, computer-aided design, geographic information systems, autonomous navigation systems, digital cultural heritage, free point-of-view broadcasting, 3D immersive telepresence, 3D reconstruction of biological tissues and organs, and the like.

The point cloud may be mainly collected in the following ways: computer generation, 3D laser scanning, 3D photogrammetry, and the like. Point cloud of a virtual 3D object or scene may be generated by the computer. Point cloud of a 3D object or scene in a static real world may be obtained through 3D laser scanning, with millions of points obtained every second. Point cloud of a 3D object or scene in a dynamic real world may be obtained through 3D photogrammetry, with tens of millions of points obtained every second. These technologies have reduced the acquisition cost and the time period of point cloud data, and improved the precision of the data. The transformation of the method for acquiring point cloud data makes it possible to acquire a large amount of point cloud data. With an increase in application demand, the processing of massive 3D point cloud data is constrained by storage space and transmission bandwidth.

For example, a point cloud video has a frame rate of 30 frames per second (fps). The number (quantity) of points in each frame of point cloud is 700 thousand. Each point has coordinate information xyz (float) and colour information RGB (uchar). In this case, a 10s point cloud video has a data volume of approximately 3.15 GB (0.7 million×(4 Byte×3+1 Byte×3)×30 fps×10s=3.15 GB), where 1 Byte corresponds to 10 bit. For a 1280×720 two-dimensional video with a YUV sampling format of 4:2:0 and a frame rate of 24 fps, the data volume of the 10s video is approximately 0.33 GB (1280×720×12 bit×24 fps×10s≈0.33 GB). A 10s two-view 3D video has a data volume of approximately 0.66 GB (0.33×2=0.66 GB). As can be seen, the data volume of the point cloud video is much greater than the data volume of the two-dimensional video and the data volume of the 3D video with the same duration. Therefore, in order to better achieve data management, save storage space of a server, and reduce transmission traffic and transmission time between the server and a client, point cloud compression has become a key issue to promote the development of point cloud industry.

That is to say, since the point cloud is a collection of massive amounts of points, storing the point cloud not only consumes a lot of memory, but is not conducive to transmission. Also, there is no such large bandwidth available to support the transmission of the point cloud directly across the network layer without compression. Therefore, the point cloud needs to be compressed.

Currently, a point cloud coding framework that can compress the point cloud may be a geometry-based point cloud compression (G-PCC) coding framework or a video-based point cloud compression (V-PCC) coding framework provided by the moving picture experts group (MPEG), or may be the audio video standard (AVS)-PCC coding framework provided by the AVS. The G-PCC coding framework may be used for compression of the first-type static point cloud and the third-type dynamically-obtained point cloud, which may be based on test model compression 13 (TMC13). The V-PCC coding framework may be used for compression of the second-type dynamic point cloud, which may be based on test model compression 2 (TMC2). Therefore, the G-PCC coding framework is also known as the point cloud codec TMC13, and the V-PCC coding framework is also known as the point cloud codec TMC2.

A network architecture of a point cloud coding system including a decoding method and an encoding method is provided in embodiments of the disclosure. FIG. 3 is a schematic diagram of a network architecture of point cloud coding provided in embodiments of the disclosure. As illustrated in FIG. 3, the network architecture includes one or more electronic devices 13 to IN and a communication network 01. The electronic devices 13 to IN can perform video interaction through the communication network 01. The electronic device may be various types of devices having video coding functions during implementation. For example, the electronic device may include a mobile phone, a tablet computer, a personal computer, a personal digital assistant, a navigator, a digital phone, a video phone, a television, a sensing device, a server, etc., which is not limited in embodiments of the disclosure. The decoder or the encoder in embodiments of the disclosure may be the electronic device.

The electronic devices in embodiments of the disclosure have a point cloud coding function, and generally include a point cloud encoder (namely, an encoder) and a point cloud decoder (namely, a decoder).

The following will describe the related art by taking the G-PCC coding framework as an example.

It may be understood that, in a point cloud G-PCC coding framework, point cloud data to-be-encoded is first partitioned into multiple slices through slice partitioning. In each slice, geometry information of the point cloud and attribute information corresponding to each point are encoded separately.

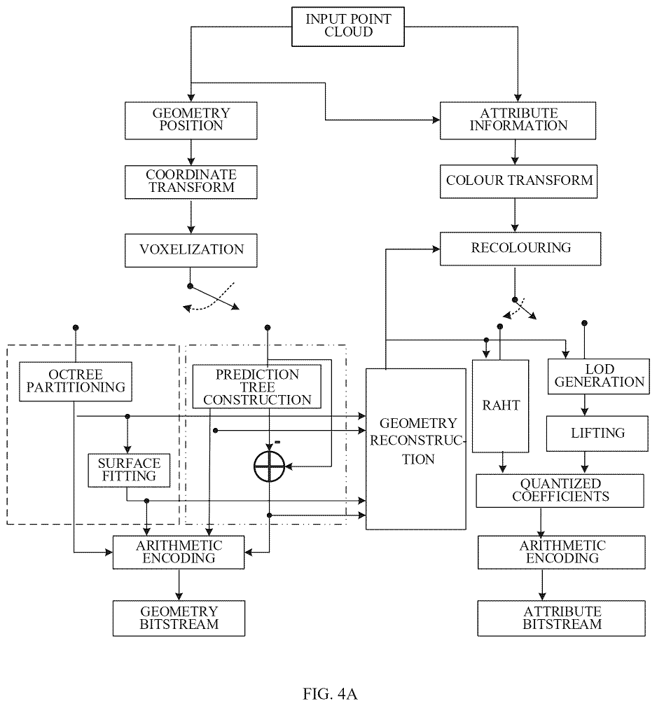

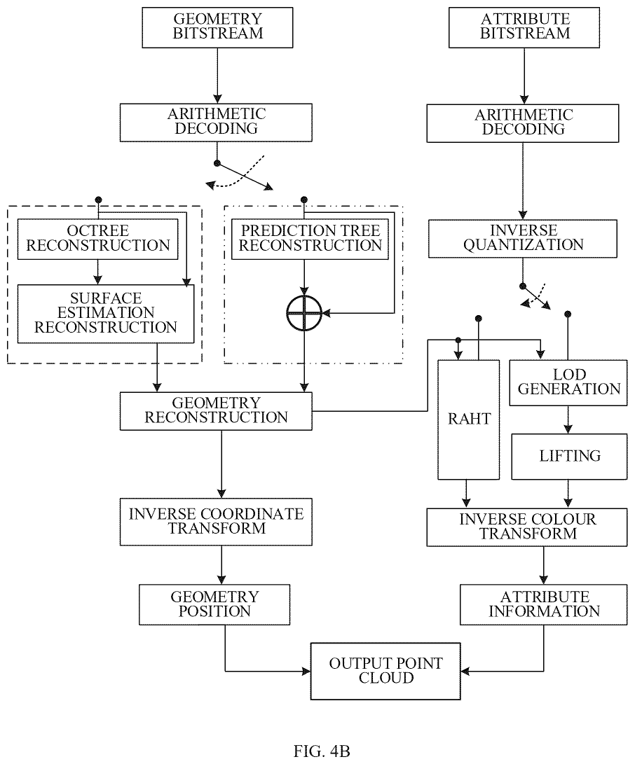

FIG. 4A is a schematic diagram of a framework of a G-PCC encoder. As illustrated in FIG. 4A, during geometry encoding, coordinate transform is performed on geometry information, so that the whole point cloud is contained in a bounding box. This is followed by quantization, which is mainly a scaling process. Due to rounding in the quantization, the geometry information of part of the point cloud is the same, and thus whether to remove duplicate points is determined based on parameters. The process of quantization and removal of the duplicate points is also referred to as voxelization. Next, octree partitioning or prediction tree construction is performed on the bounding box. In this process, arithmetic encoding is performed on points in leaf nodes obtained through partitioning, to generate a binary geometry bitstream, or arithmetic encoding (surface fitting based on vertices) is performed on vertices generated through partitioning, to generate a binary geometry bitstream. During attribute encoding, after the geometry encoding is completed and the geometry information is reconstructed, colour transform needs to be performed first, and colour information (namely, attribute information) is transformed from RGB colour space to YUV colour space. Then, the reconstructed geometry information is used to recolour the point cloud, so that the uncoded attribute information can correspond to the reconstructed geometry information. The attribute encoding is mainly performed on colour information. During encoding of the colour information, there are mainly two transform methods. One is distance-based lifting transform which relies on level of detail (LOD) partitioning, and the other is direct region adaptive hierarchical transform (RAHT), both of which transform the colour information from the spatial domain to the frequency domain to obtain high-frequency coefficients and low-frequency coefficients through transform, and finally quantize and encode the coefficients to generate the binary bitstream. Both methods make the colour information be transformed from the spatial domain to the frequency domain, to obtain a high-frequency coefficient and a low-frequency coefficient through transform. Finally, the coefficients are quantized, and then arithmetic encoding is performed on quantized coefficients to generate a binary attribute bitstream.

FIG. 4B is a schematic diagram of a framework of a G-PCC decoder. As illustrated in FIG. 4B, for an obtained binary bitstream, a geometry bitstream and an attribute bitstream in the binary bitstream are first decoded separately. During decoding of the geometry bitstream, geometry information of the point cloud is obtained through arithmetic decoding-octree reconstruction/prediction tree reconstruction-geometry reconstruction-inverse coordinate transform. During decoding of the attribute bitstream, attribute information of the point cloud is obtained through arithmetic decoding-inverse quantization-LOD partitioning/RAHT-inverse colour transform. Point cloud data to-be-encoded (i.e., output point cloud) is restored based on the geometry information and the attribute information.

It may be noted that as illustrated in FIG. 4A and FIG. 4B, currently, the G-PCC geometry coding may be octree geometry coding (indicated by a dashed box) or predictive geometry coding (indicated by a dash-dotted box).

The octree geometry encoding (OctGeomEnc) includes the following operations. First, coordinate transform is performed on geometry information, so that the whole point cloud is contained in a bounding box. This is followed by quantization, which is mainly a scaling process. Due to rounding in the quantization, some points have the same geometry information. Whether to remove duplicate points is determined based on parameters. The process of quantization and removal of the duplicate points is also referred to as voxelization. Next, tree (for example, octree, quadtree, and binary tree) partitioning is continuously performed on the bounding box in the order of breadth-first search, and an occupancy code of each node is encoded. In the related art, some company has proposed an implicit geometry partitioning method. First, a bounding box (2^{d}^{ₓ}, 2^{d}^{_{y}}, 2^{d}^{_{z}}) of the point cloud is calculated. It is assumed that dₓ>d_{y}>d_{z}, and this bounding box corresponds to a rectangular cuboid. During geometry partitioning, first, binary tree partitioning proceeds based on the x-axis to obtain two child nodes. Then, quadtree partitioning proceeds based on the x and y axes only when a condition dₓ=d_{y}>d_{z} is satisfied, to obtain four child nodes. Finally, when a condition dₓ=d_{y}=d_{z} is satisfied, octree partitioning proceeds until a resulting leaf node is 1×1×1 unit cube. Points in the leaf node are encoded to generate a binary bitstream. During binary tree/quadtree/octree-based partitioning, two parameters K and M are introduced. Parameter K indicates the maximum number of binary tree/quadtree partitions before octree partitioning. Parameter M indicates that a side length of a corresponding minimum block is 2^{M} during binary tree/quadtree partitioning. In addition, K and M need to satisfy the following conditions: assuming dₘₐₓ=max(dₓ,d_{y},d_{z}) and dₘᵢₙ=min(dₓ,d_{y},d_{z}), parameter K satisfies K≥dₘₐₓ−dₘᵢₙ, and parameter M satisfies M≥dₘᵢₙ. The reason why parameters K and M satisfy the above conditions is that during implicit geometry partitioning for G-PCC, the priority of the partitioning method is currently a binary tree, a quadtree, and an octree. Octree partitioning is continuously performed on a node only when the size of a node block does not satisfy conditions for the binary tree/quadtree, until a resulting leaf node reaches the minimum unit of 1×1×1. In an octree-based geometry information encoding mode, correlation between neighbouring points in space can be used for effectively encoding geometry information of the point cloud, and for some relatively flat nodes or nodes with planar characteristics, the encoding efficiency of the geometry information of the point cloud can be further improved through planar coding.

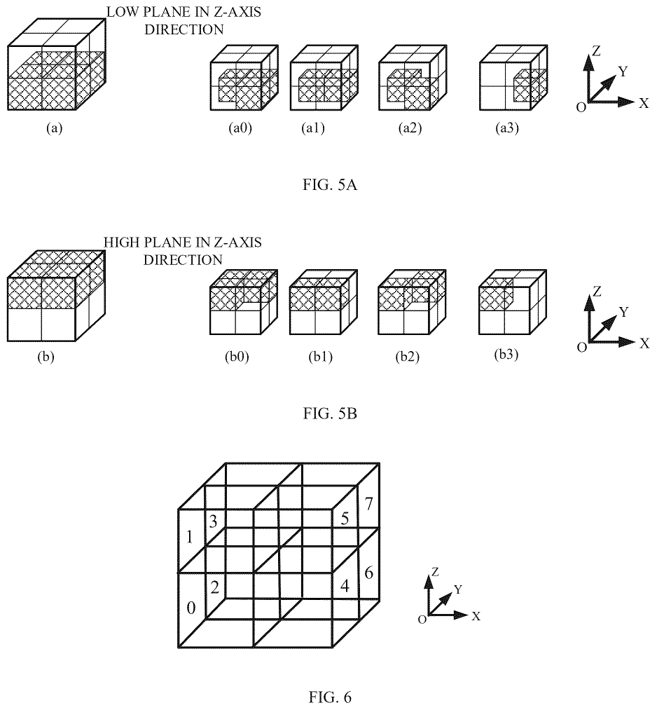

Exemplarily, FIG. 5A and FIG. 5B provide schematic diagrams illustrating plane positions, FIG. 5A is a schematic diagram illustrating low plane positions in a z-axis direction, and FIG. 5B is a schematic diagram illustrating high plane positions in a z-axis direction. As illustrated in FIG. 5A, (a), (a0), (a1), (a2), and (a3) herein all belong to the low plane positions in the z-axis direction. Taking (a) as an example, it can be seen that four occupied child nodes in a current node are all located at low plane positions of the current node in the z-axis direction, and in this case, it can be considered that the current node belongs to a z-plane and is at a low plane in the z-axis direction. Similarly, as illustrated in FIG. 5B, (b), (b0), (b1), (b2), and (b3) herein all belong to the high plane positions in the z-axis direction. Taking (b) as an example, it can be seen that four occupied child nodes in a current node are located at high plane positions of the current node in the z-axis direction, and in this case, it can be considered that the current node belongs to a z-plane and is at a high plane in the z-axis direction.

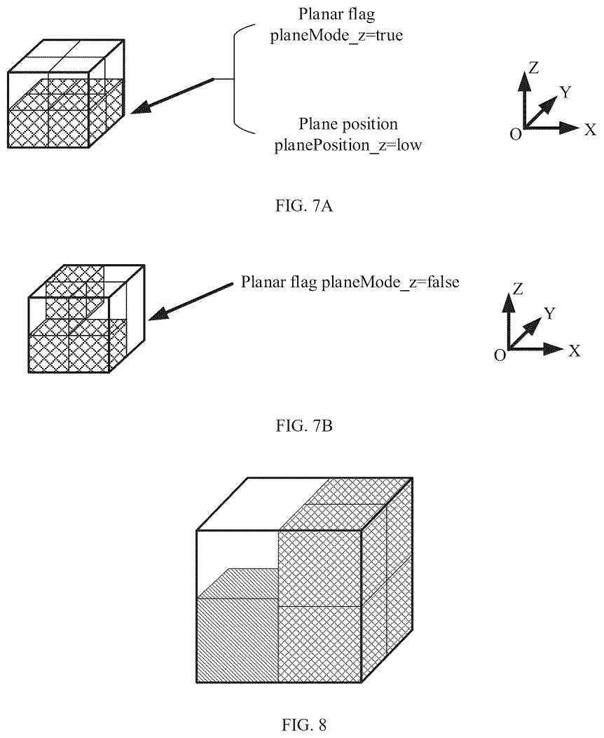

Further, taking (a) in FIG. 5A as an example, the efficiency of octree coding and the efficiency of planar coding are compared. FIG. 6 provides a schematic diagram of a node encoding order, that is, node encoding is performed in the order of 0, 1, 2, 3, 4, 5, 6, and 7 illustrated in FIG. 6. Herein, if an octree coding mode is used for (a) in FIG. 5A, occupancy information of the current node is represented by 11001100. However, if a planar coding mode is used, a flag needs to be first encoded to indicate that the current node is planar in the z-axis direction. Then, if the current node is planar in the z-axis direction, a plane position of the current node also needs to be indicated. Next, only occupancy information of nodes at the low plane in the z-axis direction (i.e., occupancy information of four child nodes 0, 2, 4, and 6) needs to be encoded. Therefore, for encoding the current node based on the planar coding mode, only six bits need to be encoded, and compared with octree coding in the related art, two bits can be reduced. Based on this analysis, the coding efficiency is more significant in planar coding compared with octree coding. Therefore, in a certain dimension, if an occupied node is encoded using the planar coding mode, planar flag information (planarMode) and plane position (PlanePos) information of the current node in this dimension need to be first indicated, and then occupancy information of the current node is encoded based on planar information of the current node. Exemplarily, FIG. 7A is a schematic diagram of planar flag information. As illustrated in FIG. 7A, it indicates a low plane in a z-axis direction; and correspondingly, a value of the planar flag information is true or 1, i.e., planarMode_z=true, and plane position information indicates low, i.e., PlanePosition_z=low. FIG. 7B is another schematic diagram of planar flag information. As illustrated in FIG. 7B, it is not planar in a z-axis direction; and correspondingly, a value of the planar flag information is false or 0, i.e., planarMode_z=false.

It may be noted that, for PlaneMode_i, 0 indicates that the current node is not planar in an i-axis direction, and 1 indicates that the current node is planar in the i-axis direction. If the current node is planar in the i-axis direction, then for PlanePosition_i, 0 indicates that the current node is planar in the i-axis direction and a plane position is low, and 1 indicates that the current node is at a high plane in the i-axis direction. Herein, i represents a coordinate dimension and may be an x-axis direction, a y-axis direction, or a z-axis direction, and thus i=0, 1, 2.

In the G-PCC standard, whether a node satisfies a condition for planar coding is determined, and when the node satisfies the condition for planar coding, predictive coding needs to be performed on planar flag information and plane position information of the node.

In embodiments of the disclosure, in the current G-PCC standard, there are three conditions for determining whether a node is eligible for planar coding, which will be elaborated below one by one.

I. Determining According to a Probability of a Node being Planar in Each Dimension
(1) A local region density (local_node_density) of a current node is determined.
(2) A probability Prob(i) of the current node in each dimension is determined.

When the local region density of the node is less than a threshold Th (for example, Th=3), probabilities Prob(i) of the current node being planar in three coordinate dimensions are compared with thresholds Th0, Th1, and Th2 respectively, where Th0<Th1<Th2 (for example, Th0=0.6, Th1=0.77, Th2=0.88). Herein, Eligibleᵢ (i=0, 1, 2) may indicate whether to enable planar coding in each dimension, and Eligibleᵢ=Prob(i)>=threshold.

It may be noted that, the threshold varies adaptively. For example, when Prob(0)>Prob(1)>Prob(2), Eligibleᵢ is set as follows:

$${Eligible}_{0} = Prob ( 0 ) >= Th 0 ;$$

$${Eligible}_{1} = Prob ( 1 ) >= Th 1 ;$$

$${Eligible}_{2} = Prob ( 2 ) >= Th 2.$$

When Prob(1)>Prob(0)>Prob(2), Eligible; is set as follows:

$${Eligible}_{0} = Prob ( 0 ) >= Th 0 ;$$

$${Eligible}_{1} = Prob ( 1 ) >= Th 1 ;$$

$${Eligible}_{2} = Prob ( 2 ) >= Th 2.$$

Herein, Prob(i) is updated as follows.

$$Prob {( i )}_{new} = ( L \times P r o b ( i ) + δ ( coded node ) ) / L + 1$$

In the above, L=255. In addition, if the coded node is planar, 8 (coded node) is 1, and otherwise, & (coded node) is 0.

Herein, local_node_density is updated as follows.

$$local\_node {\_density}_{new} = local\_node \_density + {4}^{*} numSiblings$$

In the above, local_node_density is initialized to 4, and numSiblings is the number of sibling nodes of the node. Exemplarily, FIG. 8 is a schematic diagram of sibling nodes of a current node. As illustrated in FIG. 8, when the current node is a node filled with diagonal lines, and grid-filled nodes are the sibling nodes, the number of sibling nodes of the current node is 5 (including the current node itself).

II. Determining whether a node in a current layer is eligible for planar coding according to a point cloud density of the current layer

Whether planar coding is performed on the node in the current layer is determined according to a density of points in the current layer. It is assumed that the number of points in a current point cloud to-be-encoded is pointCount, and the number of points that have been reconstructed through inferred direct coding mode (IDCM) coding is numPointCountRecon. In addition, since an octree is encoded in the order of breadth-first search, the number of nodes to-be-encoded in the current layer may be assumed to be nodeCount. In this case, it is determined that whether planar coding is enabled for the current layer is assumed to be planarEligibleKOctreeDepth. Specifically, planarEligibleKOctreeDepth=(pointCount-numPointCountRecon)<nodeCount×1.3.

If (pointCount-numPointCountRecon) is less than nodeCount×1.3, planarEligibleKOctreeDepth is true. If (pointCount-numPointCountRecon) is not less than nodeCount×1.3, planarEligibleKOctreeDepth is false. As such, when planarEligibleKOctreeDepth is true, planar coding is performed on all nodes in the current layer. Otherwise, planar coding is not performed on all the nodes in the current layer, and only octree coding is used.

### III. Determining Whether a Current Node is Eligible for Planar Coding According to a Collection Parameter of a Lidar Point Cloud

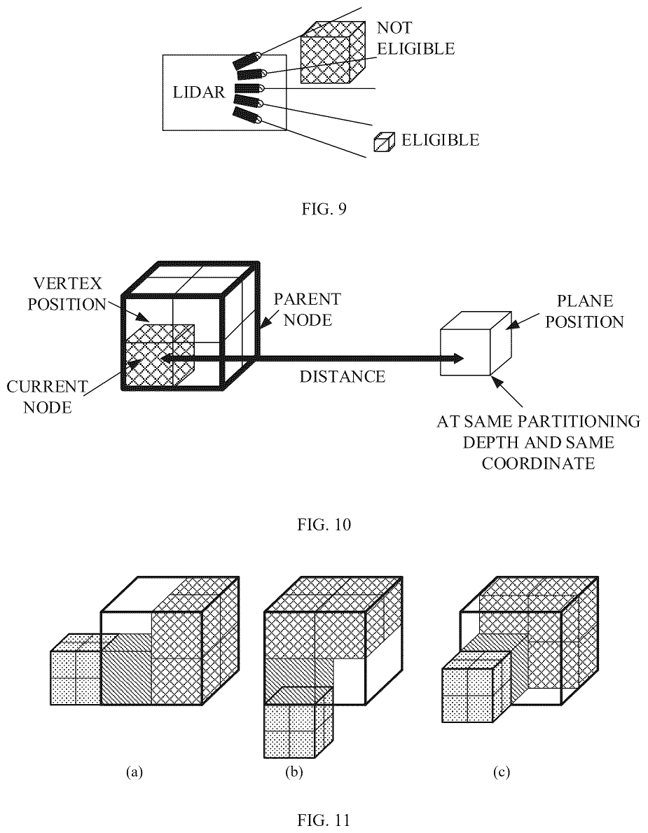

FIG. 9 is a schematic diagram illustrating intersection of a lidar with nodes. As illustrated in FIG. 9, a grid-filled node is crossed by two lasers at the same time, and thus the current node is not planar in a vertical direction of z-axis; and a node filled with diagonal lines is small enough not to be crossed by two lasers at the same time, and thus the node filled with diagonal lines may be planar in the vertical direction of z-axis.

Further, for a node satisfying the condition for planar coding, predictive coding may be performed on planar flag information and plane position information.

### First, Predictive Coding of the Planar Flag Information

Herein, only three context information is used for coding. That is, a planar flag in each coordinate dimension is designed with a separate context.

### Second, Predictive Coding of the Plane Position Information

It may be understood that, for coding of plane position information of a non-lidar point cloud, predictive coding of the plane position information may be as follows.
(a) Plane position information of the current node predicted by occupancy information of a neighbourhood node includes three elements: predicted as low, predicted as high, or unpredictable.
(b) A spatial distance between the current node and a node at the same partitioning depth and the same coordinate as the current node: “near” or “far”.
(c) If the node at the same partitioning depth and the same coordinate as the current node is planar, a plane position of the node is determined.
(d) Coordinate dimensions (i=0, 1, 2).

It may be noted that in embodiments of the disclosure, after the spatial distance between the current node and the node at the same partitioning depth and the same coordinate as the current node is determined, if the spatial distance is less than a preset distance threshold, then it may be determined that the spatial distance is “near”. Alternatively, if the spatial distance is greater than the preset distance threshold, then it may be determined that the spatial distance is “far”.

Exemplarily, FIG. 10 is a schematic diagram of a neighbourhood node at the same partitioning depth and the same coordinate. As illustrated in FIG. 10, a large cube in bold represents a parent node, a grid-filled small cube in the large cube represents a current node, and a vertex position of the current node is illustrated. A white-filled small cube represents the neighbourhood node at the same partitioning depth and the same coordinate, and a distance between the current node and the neighbourhood node is a spatial distance, which may be determined as “near” or “far”. In addition, if the neighbourhood node is planar, a plane position (also referred to as a planar position) of the neighbourhood node is needed.

As such, as illustrated in FIG. 10, if the current node is the grid-filled small cube, then at the same octree-partitioning-depth level and the same vertical coordinate, the neighbourhood node is found to be the white-filled small cube. The distance between the two nodes is determined to be “near” or “far”, and reference is made to the plane position of the neighbourhood node.

Further, in embodiments of the disclosure, FIG. 11 is a schematic diagram of a current node at a low plane position of a parent node. As illustrated in FIG. 11, (a), (b), and (c) illustrate three examples in which the current node is located at the low plane position of the parent node. Details are as follows.

\textcircled{1} If any one of child nodes 4 to 7 of a dot-filled node is occupied and all grid-filled nodes are unoccupied, it is strongly likely that there is a plane in the current node (filled with diagonal lines) and the plane position is low.

\textcircled{2} If the child nodes 4 to 7 of the dot-filled node are all unoccupied and any of the grid-filled nodes are occupied, it is strongly likely that there is a plane in the current node (filled with diagonal lines) and the plane position is high.

\textcircled{3} If the child nodes 4 to 7 of the dot-filled node are all empty nodes and the grid-filled nodes are all empty nodes, the plane position is unable to be inferred, and thus the plane position is labelled as unknown.

\textcircled{4} If any one of the child nodes 4 to 7 of the dot-filled node is occupied and any one of the grid-filled nodes is occupied, the plane position is unable to be inferred, and thus the plane position is labelled as unknown.

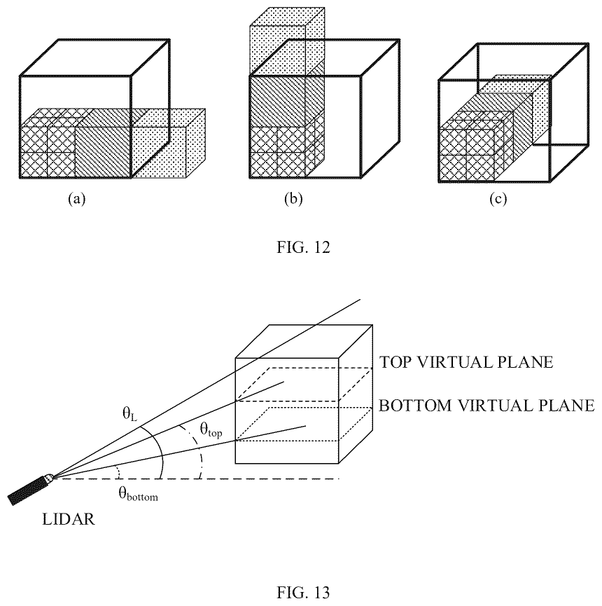

In embodiments of the disclosure, FIG. 12 is a schematic diagram of a current node at a high plane position of a parent node. As illustrated in FIG. 12, (a), (b), and (c) illustrate three examples in which the current node is located at the high plane position of the parent node. Details are as follows.

\textcircled{1} If any one of child nodes 4 to 7 of a grid-filled node is occupied and a dot-filled node is unoccupied, it is strongly likely that there is a plane in the current node (filled with diagonal lines) and the plane position is low.

\textcircled{2} If the child nodes 4 to 7 of the grid-filled node are all unoccupied and the dot-filled node is occupied, it is strongly likely that there is a plane in the current node (filled with diagonal lines) and the plane position is high.

\textcircled{3} If the child nodes 4 to 7 of the grid-filled node are all unoccupied and the dot-filled node is unoccupied, the plane position is unable to be inferred, and thus the plane position is labelled as unknown.

\textcircled{4} If one of the child nodes 4 to 7 of the grid-filled node is occupied and the dot-filled node is occupied, the plane position is unable to be inferred, and thus the plane position is labelled as unknown.

It may also be understood that, for coding of plane position information of a lidar point cloud, FIG. 13 is a schematic diagram illustrating predictive coding of plane position information of a lidar point cloud. As illustrated in FIG. 13, when a transmission angle of a lidar is θ_{bottom}, it may be mapped to a bottom virtual plane, or when the transmission angle of the lidar is θₜₒₚ, it may be mapped to a top virtual plane.

That is to say, a collection parameter of the lidar is used for predicting a plane position of the current node, and a position(s) where the current node intersects with a laser(s) is used for quantizing the plane position into multiple intervals, which are ultimately used as context information of the plane position of the current node. The specific calculation is as follows. Assuming that coordinates of the lidar are (x_{Lidar}, y_{Lidar}, z_{Lidar}) and geometry coordinates of the current node are (x, y, z), a vertical tangent value tan θ of the current node relative to the lidar is first calculated. A calculation formula is as follows.

$$tan θ = \frac{z - {z}_{Lidar}}{\sqrt{{( x - {x}_{Lidar} )}^{2} + {( y - {y}_{Lidar} )}^{2}}}$$

Further, since each laser has a certain offset angle relative to the lidar, a relative tangent value tan θ_{corr,L} of the current node relative to the laser also needs to be calculated. The specific calculation is as follows.

$$tan {θ}_{corr , L} = \frac{z - {z}_{{Lidar}^{- Z} L}}{\sqrt{{( x - {x}_{Lidar} )}^{2} + {( y - {y}_{Lidar} )}^{2}}} = tan θ - \frac{{z}_{L}}{r}$$

Finally, the relative tangent value tan θ_{corr,L} of the current node is used for predicting the plane position of the current node. Specifically, assuming that a tangent value of a bottom boundary of the current node is tan (θ_{bottom}), and a tangent value of a top boundary of the current node is tan (θₜₒₚ), the plane position is quantized into four quantization intervals according to tan θ_{corr,L}, to determine the context information of the plane position.

However, in an octree-based geometry information encoding mode, an efficient compression rate is achieved for only points with correlation in space, and for points at isolated positions in geometric space, complexity can be greatly reduced by using a direct coding mode (DCM). For all nodes in the octree, instead of being indicated by a flag, the usage of the DCM is inferred from information of a neighbour(s) and a parent node of a current node. There are three methods for determining whether the current node has eligibility for DCM coding. Details are as follows.
(1) The current node has no sibling child node, that is, the parent node of the current node has only one child node. In addition, a parent node of the parent node of the current node has only two occupied child nodes, that is, the current node has at most one neighbouring node.
(2) The parent node of the current node has only one occupied child node, i.e., the current node. In addition, six neighbouring nodes sharing a face with the current node all belong to empty nodes.
(3) The number of sibling nodes of the current node is greater than 1.

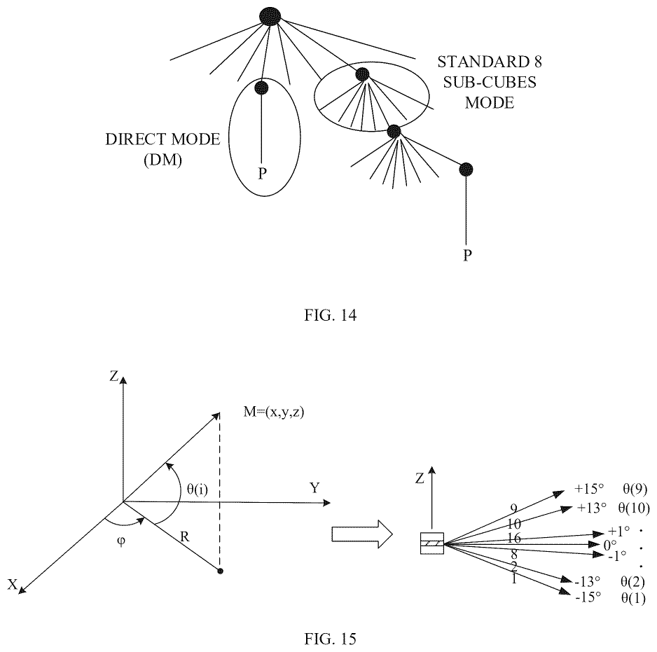

Exemplarily, FIG. 14 provides a schematic diagram illustrating IDCM coding. If the current node does not have eligibility for DCM coding, octree partitioning will be performed on the current node. If the current node has eligibility for DCM coding, the number of points contained in the current node will be further determined. If the number of points is less than a threshold (for example, 2), DCM coding is performed on the current node, and otherwise, octree partitioning is continued. For using a DCM coding mode, whether the current node is a real isolated point, i.e., IDCM_flag, needs to be first encoded. If IDCM_flag is true, DCM coding is used for the current node, and otherwise, octree coding is still used for the current node. When the current node is eligible for DCM coding, the DCM coding mode for the current node needs to be encoded. Currently, there are two DCM modes: (a) there is only one point (or multiple points which, however, belong to duplicate points); and (b) two points are contained. Finally, geometry information of each point needs to be encoded. Assuming that a side length of a node is 2^{d}, d bits are needed for encoding each component of geometry coordinates of the node, and information of these bits is directly signalled into a bitstream. Herein, it may be noted that for coding of the lidar point cloud, the collection parameter of the lidar is used for predictive coding of coordinate information in three dimensions, thereby further improving the coding efficiency of geometry information.

Further, the IDCM coding will be described in detail below.

When the current node is eligible for the DCM coding mode, the number numPoints of points in the current node is first encoded, and the number of points in the current node is encoded according to different DirectMode.

If the current node does not satisfy requirements for a DCM node, directly exit (that is, the number of points is greater than 2, and these points are not duplicate points).

If the number numPoints of points contained in the current node is less than or equal to 2, the encoding process is as follows.
1) Whether numPoints of the current node is greater than 1 is first encoded.
2) If the current node contains only one point and the geometry encoding environment is lossless geometry encoding, encode that the second point in the current node is not a duplicate point.

If the number numPoints of points contained in the current node is greater than 2, the encoding process is as follows.
1) First, whether numPoints of the current node is less than or equal to 1 is encoded.
2) Next, encode that the second point in the current node is a duplicate point. Then, whether the number of duplicate points in the current node is greater than 1 is encoded. When the number of duplicate points is greater than 1, exponential Golomb encoding needs to be performed on the number of remaining duplicate points.

After the number of points in the current node is encoded, coordinate information of a point(s) contained in the current node is encoded. Lidar point clouds and human eye-oriented point clouds will be separately described in detail below.

### (I) Human Eye-Oriented Point Clouds

(1) If the current node contains only one point, geometry information of the point in three dimension directions is directly encoded (bypass coding).
(2) If the current node contains two points, a coordinate axis dirextAxis to be preferentially encoded is first obtained based on geometry coordinates of the points. Herein, it may be noted that, coordinate axes currently compared include only the x-axis and the y-axis, and do not include the z-axis. Assuming that geometry coordinates of the current node are nodePos, the determination method is as follows.

$$dirextAxis = ! ( nodePos [ 0 ] < nodePos [ 1 ] )$$

That is, an axis with a small node-coordinate geometry position is determined as the coordinate axis dirextAxis to be preferentially encoded. Then, geometry information in the coordinate axis dirextAxis to be preferentially encoded is first encoded in the following manner. Assuming that a geometry bit depth to-be-encoded corresponding to the axis to be preferentially encoded is nodeSizeLog 2, and coordinates of the two points are pointPos[0] and pointPos[1] respectively, the specific encoding process is as follows.

```
  Bool sameBit=true;
  while(nodeSizeLog2&& sameBit){
    int mask=1<< nodeSizeLog2;
    --nodeSizeLog2;
    bool bit0=!!( pointPos[0]& mask)
bool bit1=!!( pointPos[1]& mask)
    sameBits=bit0==bit1;
    entropyCodeSameBit(sameBits); ///<entropy coding
    if(sameBits)
      encodePosBit(bit0);///<Bypass coding
    }
```

After the coordinate axis dirextAxis to be preferentially encoded is encoded, the geometry coordinates of the current node are further directly encoded. Assuming that a remaining coding bit depth of each point is nodeSizeLog 2, the specific encoding process is as follows.

for(int axisIdx=0;axisIdx<3;++axisIdx)
for(int mask=(1<<nodeSizeLog2[axisIdx])>>1;mask;mask>>1)
encodePosBit(!!(pointPos[axisIdx]&mask)).

### (II) Lidar-Oriented Point Clouds

If the current node contains two points, a coordinate axis dirextAxis to be preferentially encoded is first obtained based on geometry coordinates of the points. Assuming that geometry coordinates of the current node are nodePos, the determination method is as follows.

$$dirextAxis = ! ( nodePos [ 0 ] < nodePos [ 1 ] )$$

That is, an axis with a small node-coordinate geometry position is determined as the coordinate axis dirextAxis to be preferentially encoded. Herein, it may be noted that, coordinate axes currently compared include only the x-axis and the y-axis, and do not include the z-axis. Then, geometry information in the coordinate axis dirextAxis to be preferentially encoded is first encoded in the following manner. Assuming that a geometry bit depth to-be-encoded corresponding to the axis to be preferentially encoded is nodeSizeLog 2, and coordinates of the two points are pointPos[0] and pointPos[1] respectively, the specific encoding process is as follows.

```
  Bool sameBit=true;
  while(nodeSizeLog2&& sameBit){
    int mask=1<< nodeSizeLog2;
    --nodeSizeLog2;
    bool bit0=!!( pointPos[0]& mask)
bool bit1=!!( pointPos[1]& mask)
    sameBits=bit0==bit1;
    entropyCodeSameBit(sameBits);
    if(sameBits)
        encodePosBit(bit0);
      }
```

After the coordinate axis dirextAxis to be preferentially encoded is encoded, the geometry coordinates of the current node are encoded.

For the lidar point cloud, since a collection parameter of the lidar point cloud may be obtained, geometry coordinate information of the current node may be predicted based on the collection parameter, thereby further improving the encoding efficiency of geometry information of the point cloud. Similarly, a principal axis direction for direct coding is first obtained based on geometry information nodePos of the current node, and then predictive coding is performed on geometry information in another dimension based on encoded geometry information in the direction. Likewise, assuming that an axis direction for direct coding is directAxis, and a bit depth to-be-encoded in the direct coding is nodeSizeLog 2, the encoding is as follows.

for(int mask=(1<< nodeSizeLog2)>>1;mask;mask>>1)
encodePosBit(!!(pointPos[directAxis]&mask)).

Herein, it may be noted that, all geometry precision information in the direction directAxis is encoded.

Exemplarily, FIG. 15 provides a schematic diagram illustrating coordinate transform of a point cloud obtained by a rotating lidar. In the Cartesian coordinate system, coordinates (x, y, z) of each node may be transformed to be represented by (R, φ, i). In addition, a laser scanner may perform laser scanning according to a preset angle, and for different values of i, different θ(i) may be obtained. For example, when i is equal to 1, θ(1) may be obtained, and a corresponding scanning angle is −15°. When i is equal to 2, θ(2) may be obtained, and a corresponding scanning angle is −13°. When i is equal to 10, θ(10) may be obtained, and a corresponding scanning angle is +13°. When i is equal to 9, θ(19) may be obtained, and a corresponding scanning angle is +15°.

As such, after all precision in the coordinate direction directAxis is encoded, first, LaserIdx of a current point, i.e., pointLaserIdx in FIG. 15, is calculated, and LaserIdx of a current node, i.e., nodeLaserIdx, is calculated. Next, based on LaserIdx of the node, i.e., nodeLaserIdx, predictive coding is performed on LaserIdx of the point, i.e., pointLaserIdx. A calculation method for LaserIdx of the node or point is as follows. Assuming that geometry coordinates of the point are pointPos, start coordinates of a laser are LidarOrigin, the number of lasers is LaserNum, a tangent value of each laser is tan θᵢ, and an offset position of each laser in the vertical direction is Zᵢ, then:

```
    Int bestLaserIdx=0;
    Int Distoration=INT_MAX;
For(int LaserIdx=0; LaserIdx<numLaser; ++ LaserIdx){
  int radius = √(pointPos[0]−LidarOrigin[0])2+(pointPos[1]−LidarOrigin[1])2
    int invRadius=1/ radius
    int Z=pointPos[2]+ Zᵢ
    int tanTheta= Z×invRadius
    if(std::abs(tanTheta-tanθᵢ)< Distoration){
      Distoration= std::abs(tanTheta-tanθᵢ);
      bestLaserIdx= LaserIdx;
      }
    }
```

After LaserIdx of the current point is calculated, predictive coding is first performed on pointLaserIdx of the point based on LaserIdx of the current node. After coding of LaserIdx of the current point is completed, predictive coding is performed on geometry information of the current point in three dimensions based on a collection parameter of a lidar.

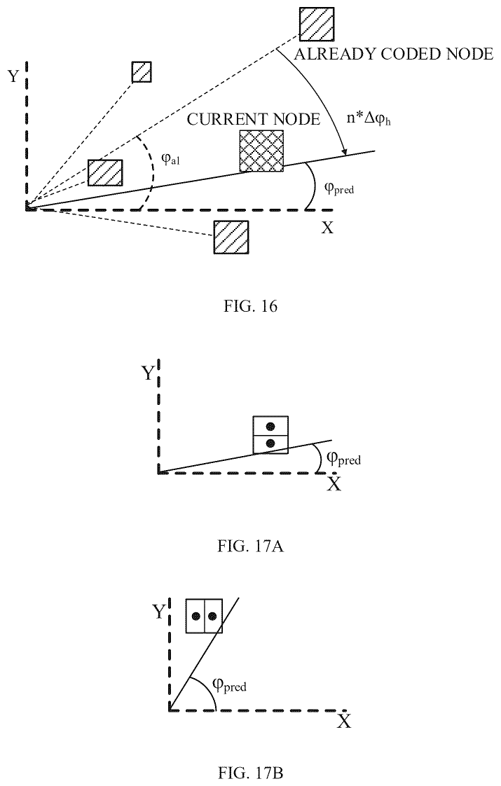

Exemplarily, FIG. 16 is a schematic diagram illustrating predictive coding in an x-axis or y-axis direction. As illustrated in FIG. 16, a grid-filled box represents a current node, and a box filled with diagonal lines represents an already coded node. Herein, a prediction value of a corresponding horizontal azimuth angle, i.e., φ_{pred}, is first obtained based on LaserIdx of the current node. Next, a horizontal azimuth angle φ_{node} of the node is obtained based on node geometry information of the current node. Assuming that geometry coordinates of the node are nodePos, a calculation method for a horizontal azimuth angle q and node geometry information is as follows.

$$φ = arctan ( nodePos [ 1 ] / nodePos [ 0 ] )$$

Based on a collection parameter of a lidar, the number numPoints of points per rotation of each laser may be obtained, which indicates the number of points obtained by each laser during one rotation. In this case, a rotational angular velocity deltaPhi of each laser can be calculated based on the number of points per rotation of each laser. A calculation method is as follows.

$$deltaPhi = \frac{2 π}{numPoints}$$

Further, a prediction value φ_{predPoint} of a horizontal azimuth angle of a current point, i.e., a prediction value of a horizontal azimuth angle as illustrated in FIG. 17A or FIG. 17B, is calculated based on the horizontal azimuth angle φ_{node} of the node and a horizontal azimuth angle φ_{pred} of a previous coded point for a laser corresponding to the current point. FIG. 17A is a schematic diagram illustrating a y-planar angle predicted using a horizontal azimuth angle, and FIG. 17B is a schematic diagram illustrating an x-planar angle predicted using a horizontal azimuth angle. Herein, a calculation method for the prediction value φ_{predPoint} of the horizontal azimuth angle of the current point is as follows.

$${φ}_{predPoint} = \frac{{φ}_{pred -} {φ}_{node}}{deltaPhi} \times deltaPhi + {φ}_{pred}$$

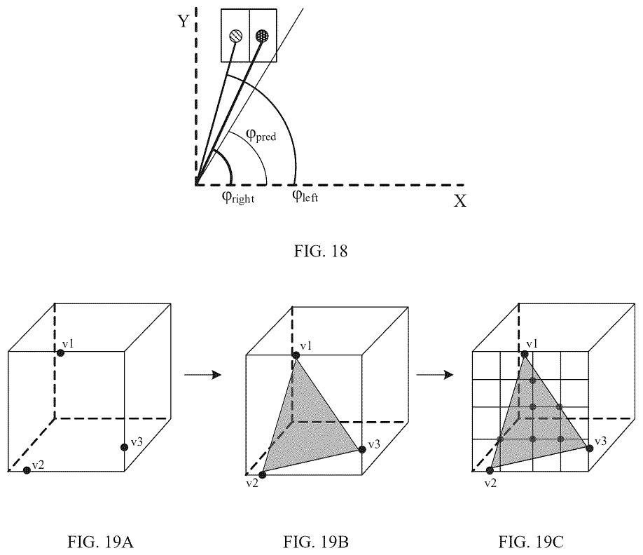

Exemplarily, FIG. 18 is another schematic diagram illustrating predictive coding in an x-axis or y-axis direction. As illustrated in FIG. 18, a grid-filled part (on the left) indicates a low plane, a dot-filled part (on the right) indicates a high plane, φ_{left} indicates a horizontal azimuth angle of a current node in the low plane, φ_{right} indicates a horizontal azimuth angle of the current node in the high plane, and φ_{pred} indicates a prediction value of a horizontal azimuth angle of the current node.

As such, predictive coding is performed on geometry information of the current node based on the prediction value φ_{predPoint} of the horizontal azimuth angle, the horizontal azimuth angle φ_{left} of the current node in the low plane, and the horizontal azimuth angle φ_{right} of the current node in the high plane. Details are as follows:

$$int angLel = {φ}_{left} - {φ}_{pred} ;$$

$$int angLeR = {φ}_{right} - {φ}_{pred} ;$$

$$int context = ( angLel \geq 0 \&\& angLeR \geq 0 ) \vert \vert angLel < 0 \&\& angLeR < 0 ) ? 0 : 2 ;$$

$$int minAngle = std \text{::} min ( abs ( angLel ) , abs ( angLeR ) ) ;$$

$$int maxAngle = std \text{::} max ( abs ( angLel ) , abs ( angLeR ) ) ;$$

$$context += maxAngle > minAngle ? 0 : 1 ;$$

$$context += maxAngle > minAngle ? 0 : 4.$$

After coding of LaserIdx of the point is completed, predictive coding is performed on a z-axis direction of the current point based on LaserIdx of the current point. That is, depth information “radius” in the radar coordinate system is currently calculated based on x and y information of the current point, and then a tangent value of the current point and an offset of the current point in the vertical direction are obtained based on LaserIdx of the current point. In this way, a prediction value Z_pred of the current point in the z-axis direction can be obtained. Details are as follows:

$$int radius = \sqrt{{( pointPos [ 0 ] - LidarOrigin [ 0 ] )}^{2} + {( pointPos [ 1 ] - LidarOrigin [ 1 ] )}^{2} ;}$$

$$int tanTheta = tan {θ}_{laserIdx} ;$$

$$int zOffset = {Z}_{laserIdx} ;$$

$$Z\_pred = radius \times tanTheta - zOffset .$$

Further, a prediction residual Z_res is obtained by performing predictive coding on geometry information of the current point in the z-axis direction based on Z_pred, and finally Z_res is encoded.

It may be noted that, when a node is partitioned into a leaf node, in case of lossless geometry encoding, the number of duplicate points in the leaf node needs to be encoded. Finally, occupancy information of all nodes is encoded to generate a binary bitstream. In addition, a planar coding mode is currently introduced in G-PCC. During geometry partitioning, whether child nodes of the current node are located at the same plane is determined. If the child nodes of the current node are at the same plane, the child nodes of the current node may be represented by this plane.

For the octree geometry decoding, before decoding occupancy information of each node in the order of breadth-first search, the decoding end first determines, based on reconstructed geometry information, whether planar decoding or IDCM decoding is performed on the current node. If the current node satisfies a condition for planar decoding, the decoding end first decodes planar flag information and plane position information of the current node, and then decodes occupancy information of the current node based on planar information. If the current node satisfies a condition for IDCM decoding, the decoding end first decodes whether the current node is a real IDCM node. If the current node is a real IDCM node, the decoding end further parses a DCM decoding mode for the current node, then obtains the number of points in a current DCM node, and finally decodes geometry information of each point. For a node that is eligible for neither planar decoding nor DCM decoding, occupancy information of the current node is decoded. An occupancy code of each node is obtained through continuous parsing in such a manner, and the node is sequentially partitioned until a 1×1×1 unit cube is obtained. The number of points contained in each leaf node is parsed out, and finally geometry-reconstructed point cloud information is restored.

The IDCM decoding will be described in detail below.

Similar to the processing at the encoding end, whether IDCM is enabled for a node is first determined based on prior information. That is, conditions for enabling IDCM are as follows.
(1) A current node has no sibling child node, that is, a parent node of the current node has only one child node. In addition, a parent node of the parent node of the current node has only two occupied child nodes, that is, the current node has at most one neighbouring node.
(2) The parent node of the current node has only one occupied child node, i.e., the current node. In addition, six neighbouring nodes sharing a face with the current node all belong to empty nodes.
(3) The number of sibling nodes of the current node is greater than 1.

Further, when the node satisfies a condition for DCM coding, whether the current node is a real DCM node, i.e., IDCM_flag, is first decoded. If IDCM_flag is true, DCM coding is used for the current node, and otherwise, octree coding is still used for the current node.

Next, the number numPoints of points in the current node is decoded. The specific decoding is as follows.
i) Whether numPoints of the current node is greater than 1 is first decoded.
ii) If numPoints of the current node obtained by decoding is greater than 1, whether the second point is a duplicate point is further decoded. If the second point is not a duplicate point, it may be implicitly inferred herein that a DCM mode is satisfied, that is, only two points are contained.
iii) If numPoints of the current node obtained by decoding is less than or equal to 1, whether the second point is a duplicate point is further decoded. If the second point is not a duplicate point, it may be implicitly inferred herein that a DCM mode is satisfied, that is, only one point is contained. If the second point obtained by decoding is a duplicate point, it may be inferred that a DCM mode is satisfied, that is, multiple points are contained but are all duplicate points. In this case, whether the number of duplicate points is greater than 1 is further decoded (entropy decoding). If the number of duplicate points is greater than 1, the number of remaining duplicate points is further decoded (exponential Golomb decoding).

If the current node does not satisfy requirements for a DCM node, directly exit (that is, the number of points is greater than 2, and these points are not duplicate points).

After the number of points in the current node is decoded, coordinate information of a point(s) contained in the current node is decoded. Lidar point clouds and human eye-oriented point clouds will be separately described in detail below.

### (I) Human Eye-Oriented Point Clouds

(1) If the current node contains only one point, geometry information of the point in three dimension directions is directly decoded (bypass coding).
(2) If the current node contains two points, a coordinate axis dirextAxis to be preferentially decoded is first obtained based on geometry coordinates of the points. Herein, it may be noted that, coordinate axes currently compared include only the x-axis and the y-axis, and do not include the z-axis. Assuming that geometry coordinates of the current node are nodePos, the determination method is as follows.

$$dirextAxis = ! ( nodePos [ 0 ] < nodePos [ 1 ] )$$

That is, an axis with a small node-coordinate geometry position is determined as the coordinate axis dirextAxis to be preferentially decoded. Then, geometry information in the coordinate axis dirextAxis to be preferentially decoded is first decoded in the following manner. Assuming that a geometry bit depth to-be-decoded corresponding to the axis to be preferentially decoded is nodeSizeLog 2, and coordinates of the two points are pointPos[0] and pointPos[1] respectively, the specific decoding process is as follows.

```
  Bool sameBit=true;
  while(nodeSizeLog2&& sameBit){
    pointPos[0][ dirextAxis]<<1;
    pointPos[1][ dirextAxis]<<1;
    --nodeSizeLog2;
      int bit=0;
        deEntropyCodeSameBit(sameBits); ///<entropy coding
      if(sameBits){
          bit =decodePosBit( );///<Bypass coding
          pointPos[0][ dirextAxis]|= bit
            pointPos[1][ dirextAxis]|= bit
      }else
              pointPos[1][ dirextAxis]|= 1///<The reason herein is
that during encoding, the two points are ordered in a direction of an axis to be preferentially
encoded, and thus it can be ensured that pointPos[0][dirextAxis]< pointPos[1][dirextAxis].
Therefore, during decoding, if bit information of the two points is different, it may be inferred
that a bit of the first point is 0 and a bit of the second point is 1.
      }
```

After the coordinate axis dirextAxis to be preferentially decoded is decoded, the geometry coordinates of the current point are further directly decoded. Assuming that a remaining coding bit depth of each point is nodeSizeLog 2, and coordinate information of the point is pointPos, the specific decoding process is as follows.

```
for(int axisIdx=0;axisIdx<3;++axisIdx)
for(int idx= nodeSizeLog2[axisIdx]; idx; idx--){
  pointPos[axisIdx]<<1;
  pointPos[axisIdx]|=decodePosBit( );
    }
```

### (II) Lidar-Oriented Point Clouds

If the current node contains two points, a coordinate axis dirextAxis to be preferentially decoded is first obtained based on geometry coordinates of the points. Assuming that geometry coordinates of the current node are nodePos, the determination method is as follows.

$$dirextAxis = ! ( nodePos [ 0 ] < nodePos [ 1 ] ) \qquad ( 11 )$$

That is, an axis with a small node-coordinate geometry position is determined as the coordinate axis dirextAxis to be preferentially decoded. Herein, it may be noted that, coordinate axes currently compared include only the x-axis and the y-axis, and do not include the z-axis. Then, geometry information in the coordinate axis dirextAxis to be preferentially decoded is first decoded in the following manner. Assuming that a geometry bit depth to-be-encoded corresponding to the axis to be preferentially decoded is nodeSizeLog 2, and coordinates of the two points are pointPos[0] and pointPos[1] respectively, the specific decoding process is as follows.

```
  Bool sameBit=true;
  while(nodeSizeLog2&& sameBit){
    pointPos[0][ dirextAxis]<<1;
    pointPos[1][ dirextAxis]<<1;
      --nodeSizeLog2;
      int bit=0;
          deEntropyCodeSameBit(sameBits); ///<entropy coding
      if(sameBits){
            bit =decodePosBit( );///<Bypass coding
            pointPos[0][ dirextAxis]|= bit
            pointPos[1][ dirextAxis]|= bit
      }else
              pointPos[1][dirextAxis]|= 1///<The reason herein is that
during encoding, the two points are ordered in a direction of an axis to be preferentially encoded,
and thus it can be ensured that pointPos[0][dirextAxis]< pointPos[1][dirextAxis]. Therefore,
during decoding, if bit information of the two points is different, it may be inferred that a bit of
the first point is 0 and a bit of the second point is 1.
        }
```

After the coordinate axis dirextAxis to be preferentially decoded is decoded, the geometry coordinates of the current point are decoded.

Similarly, a principal axis direction for direct decoding is first obtained based on geometry information nodePos of the current node, and then geometry information in another dimension is decoded based on decoded geometry information in the direction. Likewise, assuming that an axis direction for direct decoding is directAxis, and a bit depth to-be-decoded in the direct decoding is nodeSizeLog 2, the decoding is as follows.

```
for(int idx= nodeSizeLog2[directAxis]; idx; idx--){
  pointPos[directAxis]<<1;
  pointPos[directAxis]|=decodePosBit( );
    }
```

Herein, it may be noted that, all geometry precision information in the direction directAxis is decoded.

After all precision in the coordinate direction directAxis is decoded, LaserIdx of a current node, i.e., nodeLaserIdx, is first calculated. Next, based on LaserIdx of the node, i.e., nodeLaserIdx, predictive decoding is performed on LaserIdx of a point, i.e., pointLaserIdx. A calculation method for LaserIdx of the node or point is the same as that at the encoding end. Finally, prediction residual information between LaserIdx of the current point and LaserIdx of the node is decoded to obtain ResLaserIdx. The decoding is as follows:

$$PointLaserIdx = nodeLaserIdx + ResLaserIdx$$

After LaserIdx of the current point is decoded, predictive decoding is performed on geometry information of the current point in three dimensions based on a collection parameter of a lidar. The specific algorithm is as follows.

As illustrated in FIG. 16, a prediction value of a corresponding horizontal azimuth angle, i.e., φ_{pred}, is first obtained based on LaserIdx of a current node. Next, a horizontal azimuth angle φ_{node} of the node is obtained based on node geometry information of the current node. Assuming that geometry coordinates of the node are nodePos, a calculation method for a horizontal azimuth angle q and node geometry information is as follows.

$$φ = arctan ( nodePos [ 1 ] / nodePos [ 0 ] )$$

Based on a collection parameter of a lidar, the number numPoints of points per rotation of each laser may be obtained, which indicates the number of points obtained by each laser during one rotation. In this case, a rotational angular velocity deltaPhi of each laser can be calculated based on the number of points per rotation of each laser. A calculation method is as follows.

$$deltaPhi = \frac{2 π}{numPoints}$$

Further, a prediction value φ_{predPoint} of a horizontal azimuth angle of a current point, i.e., a prediction value of a horizontal azimuth angle as illustrated in FIG. 17A or FIG. 17B, is calculated based on the horizontal azimuth angle φ_{node} of the node and a horizontal azimuth angle φ_{pred} of a previous coded point for a laser corresponding to the current point. A calculation method is as follows.

$${φ}_{predPoint} = \frac{{φ}_{pred -} {φ}_{node}}{deltaPhi} \times deltaPhi + {φ}_{pred}$$

As such, predictive decoding is performed on geometry information of the current node based on the prediction value φ_{predPoint} of the horizontal azimuth angle, a horizontal azimuth angle φ_{left} of the current node in a low plane, and a horizontal azimuth angle φ_{right} of the current node in a high plane. Details are as follows:

$$int angLel = {φ}_{left} - {φ}_{pred} ;$$

$$int angLeR = {φ}_{right} - {φ}_{pred} ;$$

$$int context = ( angLel \geq 0 \&\& angLeR \geq 0 ) \vert \vert angLel < 0 \&\& angLeR < 0 ) ? 0 : 2 ;$$

$$int absAngleL = abs ( angLel ) ;$$

$$int absAngleR = abs ( angLeR ) ;$$

$$context += absAngleL > absAngleR ? 0 : 1 ;$$

$$context += maxAngle > minAngle ≪ 1 ? 4 : 0.$$

After LaserIdx of the point is decoded, predictive decoding is performed on a z-axis direction of the current point based on LaserIdx of the current point. That is, depth information “radius” in the radar coordinate system is currently calculated based on x and y information of the current point, and then a tangent value of the current point and an offset of the current point in the vertical direction are obtained based on LaserIdx of the current point. In this way, a prediction value Z_pred of the current point in the z-axis direction can be obtained. Details are as follows:

$$int radius = \sqrt{( pointPos [ 0 ] - LidarOrigin [ 0 ] ) 2 + ( pointPos [ 1 ] - LidarOrigin [ 1 ] ) 2 ;}$$

$$int tanTheta = tan {θ}_{laserIdx} ;$$

$$int zOffset = {Z}_{laserIdx} ;$$

$$Z\_pred = radius \times tanTheta - zOffset .$$

Further, geometry information of the current point in the z-axis direction is reconstructed and restored based on decoded Z_res and Z_pred.

For triangle soup (trisoup)-based geometry information encoding, geometry partitioning is also performed first in a trisoup-based geometry information encoding framework. However, different from binary tree/quadtree/octree-based geometry information encoding, in this method, instead of partitioning the point cloud layer-by-layer into 1×1×1 unit cubes, the partitioning is stopped when the side length of a block is W. Based on a surface formed by distribution of the point cloud in each block, up to 12 vertices generated between the 12 edges of the block and the surface are obtained. Then, coordinates of the vertices of each block are encoded in sequence and thus the binary bitstream is generated.

For trisoup-based point cloud geometry information reconstruction, during point cloud geometry information reconstruction at the decoding end, the decoding end first decodes vertex coordinates to complete trisoup reconstruction. This process is illustrated in FIG. 19A, FIG. 19B, and FIG. 19C. There are three vertices (v1, v2, v3) in a block illustrated in FIG. 19A. A structure formed by these three vertices in a certain order is called a triangle soup, i.e., trisoup, as illustrated in FIG. 19B. Then, sampling is performed on the trisoup, and an obtained sampling point(s) is determined as a reconstructed point cloud in the block, as illustrated in FIG. 19C.

The predictive geometry encoding (PredGeom Tree) includes the following operations. First, ordering is performed on an input point cloud. Ordering methods currently used include disordering, Morton ordering, azimuth ordering, and radial distance ordering. At the encoding end, a prediction tree structure is built in two different modes: high-latency slow mode (KD-Tree) and low-latency fast mode (using lidar calibration information). By using the lidar calibration information, each point is assigned to a different laser, and the prediction tree structure is built according to the different laser. Next, based on the prediction tree structure, by traversing each node in the prediction tree, geometry position information of the node is predicted by selecting a different prediction mode to obtain a prediction residual, and the geometry prediction residual is quantized by using a quantization parameter. Finally, the prediction residual of the position information of the prediction tree node, the prediction tree structure, the quantization parameter, and the like are encoded through continuous iteration, to generate a binary bitstream.

For predictive geometry decoding, the decoding end reconstructs a prediction tree structure by continuously parsing a bitstream. Then, the decoding end obtains prediction residual information of a geometry position of each prediction node and a quantization parameter through parsing, and performs inverse quantization on the prediction residual to restore reconstructed geometry position information of each node. Finally, geometry reconstruction at the decoding end is completed.

After completion of geometry encoding, geometry information needs to be reconstructed. Currently, attribute encoding is mainly performed on colour information. First, the colour information is transformed from RGB colour space to YUV colour space. Then, the reconstructed geometry information is used to recolour the point cloud, so that the uncoded attribute information can correspond to the reconstructed geometry information. During encoding of the colour information, there are mainly two transform methods. One is distance-based lifting transform which relies on LOD partitioning, and the other is direct region adaptive hierarchical transform (RAHT), both of which transform the colour information from the spatial domain to the frequency domain to obtain high-frequency coefficients and low-frequency coefficients through transform, and finally quantize and encode the coefficients to generate a binary bitstream. For details, reference can be made to FIG. 4A and FIG. 4B.

Further, during prediction of attribute information based on the geometry information, Morton codes can be used for nearest-neighbour search, and a Morton code corresponding to each point in the point cloud can be obtained from geometry coordinates of the point. A specific method for calculating the Morton code will be described below. For 3D coordinates with each component represented by a d-bit binary digit, three components may be represented as follows.

$$x = {\sum }_{l = 1}^{d} {2}^{d - l} {x}_{l} , y = {\sum }_{l = 1}^{d} {2}^{d - l} {y}_{l} , z = {\sum }_{l = 1}^{d} {2}^{d - l} {z}_{l}$$

xₗ,yₗ,zₗ∈{0,1} are respectively corresponding binary values from the most significant bit (l=1) to the least significant bit (l=d) of x, y, z. The Morton code M is obtained by interleaving xₗ,yₗ,zₗ from the most significant bit to the least significant bit for x, y, z. The calculation formula of M is as follows.

$$M = {\sum }_{l = 1}^{d} {2}^{3 ( d - l )} ( 4 {x}_{l} + 2 {y}_{l} + {z}_{l} ) = {\sum }_{l = 1}^{3 d} {2}^{3 d - {l}^{′}} {m}_{{l}^{′}}$$

mₗ_{^{′}}∈{0,1} are respectively values from the most significant bit (l^{′}=1) to the least significant bit (l^{′}=3d) of M. After the Morton code M of each point in the point cloud is obtained, the points in the point cloud are ordered in an ascending order of the Morton codes, and a weight w of each point is set to 1.

It may also be understood that for the G-PCC coding framework, common test conditions (CTC) are as follows.
(1) There are four test conditions in total: condition 1, limit-lossy geometry position and lossy attribute; condition 2, lossless geometry position and lossy attribute; condition 3, lossless geometry position and limit-lossy attribute; and condition 4, lossless geometry position and lossless attribute.
(2) There are four categories of common test sequences, namely Cat1A, Cat1B, Cat3-fused, and Cat3-frame. Cat2-frame point cloud contains only reflectance attribute information, Cat1A point cloud and Cat1B point cloud each contain only colour attribute information, and Cat3-fused point cloud contains both the colour attribute information and the reflectance attribute information.
(3) Technical route: based on algorithms used for geometry compression, there are two technical routes in total.

### Technical Route 1: Octree Coding Branch

At the encoding end, a bounding box is sequentially partitioned into sub-cubes, and non-empty (containing points in a point cloud) sub-cubes are continued to be partitioned until a resulting leaf node is 1×1×1 unit cube. In case of lossless geometry encoding, the number of points contained in the leaf node is encoded, and finally encoding of a geometry octree is completed, to generate a binary bitstream.

At the decoding end, the decoding end obtains an occupancy code of each node through continuous parsing in the order of breadth-first search, and sequentially partitions a node until a 1×1×1 unit cube is obtained. In case of lossless geometry decoding, the decoding end needs to parse out the number of points contained in each leaf node and finally restore geometry-reconstructed point cloud information.

### Technical Route 2: Prediction Tree Coding Branch

At the encoding end, a prediction tree structure is built in two different modes: based on KD-Tree (high-latency slow mode) and based on lidar calibration information (low-latency fast mode). By using the lidar calibration information, each point is assigned to a different laser, and the prediction tree structure is built based on the different laser. Next, based on the prediction tree structure, by traversing each node in the prediction tree, geometry position information of the node is predicted by selecting a different prediction mode to obtain a prediction residual, and the geometry prediction residual is quantized by using a quantization parameter. Finally, the prediction residual of the position information of the prediction tree node, the prediction tree structure, the quantization parameter, and the like are encoded through continuous iteration, to generate a binary bitstream.

At the decoding end, the decoding end reconstructs a prediction tree structure by continuously parsing a bitstream. Then, the decoding end obtains prediction residual information of a geometry position of each prediction node and a quantization parameter through parsing, and performs inverse quantization on the prediction residual to restore reconstructed geometry position information of each node. Finally, geometry reconstruction at the decoding end is completed.

It may also be noted that as illustrated in FIG. 4A or FIG. 4B, in the current G-PCC coding framework, there are three attribute coding methods: predicting transform (PT), lifting transform (LT), and RAHT. In the first two methods, predictive coding is performed on a point cloud based on the order of LOD generation, and in RAHT, adaptive transform is performed on attribute information from the bottom to the top based on a hierarchy of octree construction. These three point cloud attribute coding methods will be described in detail below.

### (a) Predictive Coding of Attribute Information of a Point Cloud

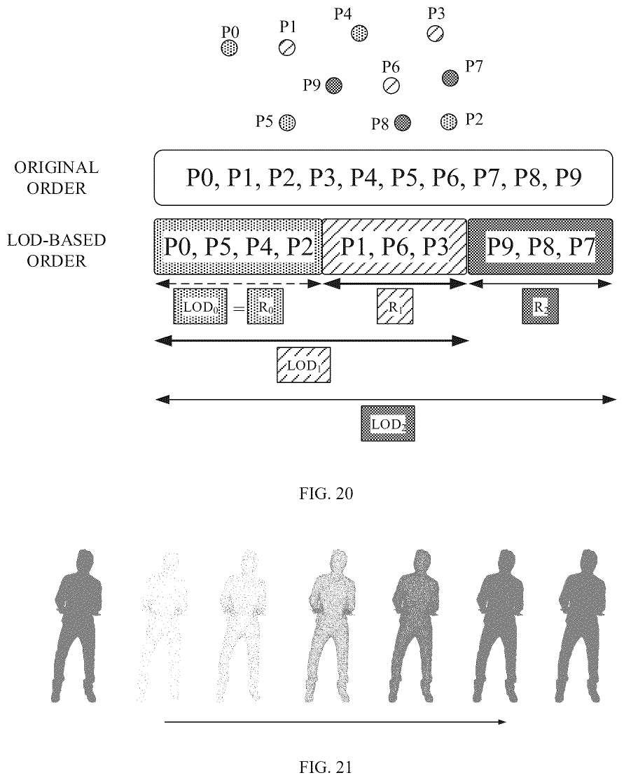

Currently, an attribute prediction module in G-PCC uses a nearest-neighbour attribute prediction coding scheme based on a LOD structure. A method for LOD construction includes a distance-based LOD construction scheme, a fixed sampling rate-based LOD construction scheme, an octree-based LOD construction scheme, and the like. In the distance threshold-based LOD construction scheme, before LOD construction, Morton ordering is first performed on the point cloud to ensure strong attribute correlation between neighbouring points. FIG. 20 is a schematic diagram illustrating distance-based LOD construction. As illustrated in FIG. 20, according to L Manhattan distances (dl), l=0, 1, . . . , L−1 preset by a user, point clouds are partitioned into L different refinement levels (Rl), l=0, 1, . . . , L−1. Herein, (dl)l=0, 1, . . . , L−1 satisfies dl<dl−1. The LOD construction is described as follows.
(1) First, all points in the point cloud are labelled as non-visited, and a set l′ is established to store a set of visited points. (2) At each iteration l, the points in the point cloud are traversed. If a current point has been visited, the current point is ignored. Otherwise, the minimum distance D of the current point to the set V of points is calculated. If D<dl, the current point is ignored. Otherwise, the current point is labelled as visited and added to the refinement level Rl and the set V of points. (3) Points in the level of detail LODl include points in refinement levels R0, R1, R2 . . . . Rl. (4) The above operations are repeated until all the points are labelled as visited.

Based on the LOD structure, a reconstructed attribute value of a point in the same or higher LOD layer is used for linear weighted prediction on an attribute value of each point. The maximum number of reference prediction neighbours is determined by a high-level syntax element in the encoder. For an attribute of each point, at the encoding end, based on a rate-distortion optimization algorithm, attributes of N nearest neighbouring points found are selected for weighted prediction or an attribute of a single nearest neighbouring point is selected for prediction. Finally, a selected prediction mode and prediction residual are encoded.

$${Attr}_{i}^{′} = Round ( \frac{1}{N} {\sum }_{m ∈ {p}_{i}} \frac{\frac{1}{{D}_{m}^{2}}}{{\sum }_{m ∈ {p}_{i}} \frac{1}{{D}_{m}^{2}}} A t t {r}_{m} )$$

N represents the number of prediction points in a set of nearest neighbouring points of point i, Pᵢ represents the sum of N nearest neighbouring points of point i, Dₘ represents a spatial geometry distance between nearest neighbouring point m and current point i, Attrₘ represents a reconstructed attribute value of nearest neighbouring point m, Attrᵢ′ represents an attribute prediction value of current point i, and the number N of points is a preset value.

To keep tradeoff of attribute coding efficiency and parallel processing between different LOD layers, a switch is introduced in a high-level syntax element in the encoder to control whether to introduce intra LOD prediction. If the switch is switched on, intra LOD prediction is enabled, and thus points in the same LOD layer may be used for prediction. It may be noted that, intra LOD prediction is always used when the number of LOD layers is 1,

FIG. 21 is a schematic diagram illustrating a visualization result of LOD generation. As illustrated in FIG. 21, a subjective example of distance-based LOD generation is provided herein. Specifically (from left to right), points in the first layer represent an outer contour of a point cloud, and as the number of LODs increases, details of the point cloud gradually become clear.

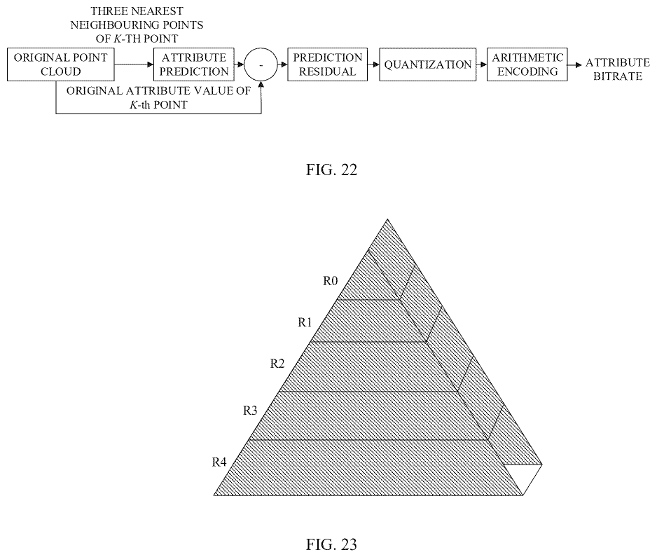

FIG. 22 is a schematic flowchart of attribute prediction coding. As illustrated in FIG. 22, in the specific process of G-PCC attribute prediction, for an original point cloud, three nearest neighbouring points of the K-th point are first searched, and then attribute prediction is performed. A difference between an attribute prediction value of the K-th point and an original attribute value of the K-th point is calculated to obtain a prediction residual of the K-th point. Then, quantization and arithmetic encoding are performed, and finally an attribute bitrate is generated.

### (i) Selection of an Optimal Prediction Value

After LOD construction is completed, according to the order of LOD generation, three nearest neighbouring points of a current point to-be-encoded are first found from encoded data points. Reconstructed attribute values of these three nearest neighbouring points are determined as candidate prediction values of the current point to-be-encoded. Then, an optimal prediction value is selected therefrom according to rate-distortion optimization (RDO). For example, during encoding of an attribute value of point P2 in FIG. 20, a predictor index of an attribute value of first-nearest neighbouring point P4 is set to 1, an attribute predictor index of second-nearest neighbouring point P5 and an attribute predictor index of third-nearest neighbouring point P0 are set to 2 and 3 respectively, and a predictor index of a weighted average value of points P0, P5, and P4 is set to 0, as illustrated in Table 1. Finally, an optimal predictor is selected according to RDO. A formula for weighted averaging is as follows.

$${\hat{a}}_{i} = Round ( {\sum }_{j = 0}^{2} \frac{{\tilde{w}}_{ij}}{{\sum }_{j = 0}^{2} {\tilde{w}}_{ij}} {\tilde{a}}_{j} )$$

In the above, \tilde{w}ᵢⱼ represents a spatial geometry weight from a nearest neighbouring point j to the current point i.

$${\tilde{w}}_{ij} = \frac{1}{{( {x}_{i} - {x}_{ij} )}^{2} + {( {y}_{i} - {y}_{ij} )}^{2} + {( {z}_{i} - {z}_{ij} )}^{2}}$$

â, represents an attribute prediction value of the current point i, j represents indexes of three nearest neighbouring points, ãⱼ represents a reconstructed attribute value of the nearest neighbouring point, xᵢ,yᵢ,zᵢ represent geometry position coordinates of the current point i, and xᵢⱼ,yᵢⱼ,zᵢⱼ represent geometry coordinates of the nearest neighbouring point j.

Exemplarily, Table 1 provides an example of samples of candidate predictors for attribute coding.

TABLE 1

| Prediction mode | Prediction value |
|---|---|
| 0 | Weighted average of attributes |
| | of three nearest neighbours |
| 1 | P4 (attribute value of first- |
| | nearest neighbour) |
| 2 | P5 (attribute value of second- |
| | nearest neighbour |
| 3 | P0 (attribute value of third- |
| | nearest neighbour) |

### (ii) Attribute Prediction Residual and Quantization

The attribute prediction value (âᵢ)_{i∈0 . . . k-1} (where k is the total point number of the point cloud) of the current point i is obtained through the above prediction. Assuming that (aᵢ)_{i∈0 . . . k-1} is an original attribute value of the current point, an attribute residual (rᵢ)_{i∈0 . . . k-1} is denoted as:

$${r}_{i} = {a}_{i} - {\hat{a}}_{i}$$

Further, a prediction residual is quantized:

$${Q}_{i} = \frac{{r}_{i}}{Q s}$$

Qᵢ represents a quantized attribute residual of the current point i. Qs is a quantization step (Qs), which can be calculated from a quantization parameter (QP) specified in CTC.

(iii) Reconstruction of an Attribute Value at the Encoding End

The purpose of reconstruction at the encoding end is for prediction of a subsequent point(s). Before reconstruction of the attribute value, inverse quantization needs to be performed on a residual. \hat{r}ᵢ is denoted as an inverse-quantized residual:

$${\hat{r}}_{i} = {Q}_{i} \times Q s$$

A reconstructed value ãᵢ of the point i is obtained by adding \hat{r}ᵢ and the prediction value ãᵢ.

$${\tilde{a}}_{i} = {\hat{r}}_{i} + {\hat{a}}_{i}$$

There are currently two main categories of algorithms for attribute nearest-neighbour search based on LOD partitioning: intra nearest-neighbour search and inter nearest-neighbour search. An algorithm for inter nearest-neighbour search will be described in detail below, and intra nearest-neighbour search can be classified into inter-layer nearest-neighbour search and intra-layer nearest-neighbour search.

### (i) Intra Nearest-Neighbour Search

For intra nearest-neighbour search, there are two algorithms: inter-layer nearest-neighbour search and intra-layer nearest-neighbour search. After LOD partitioning, it resembles a pyramid structure, as illustrated in FIG. 23.

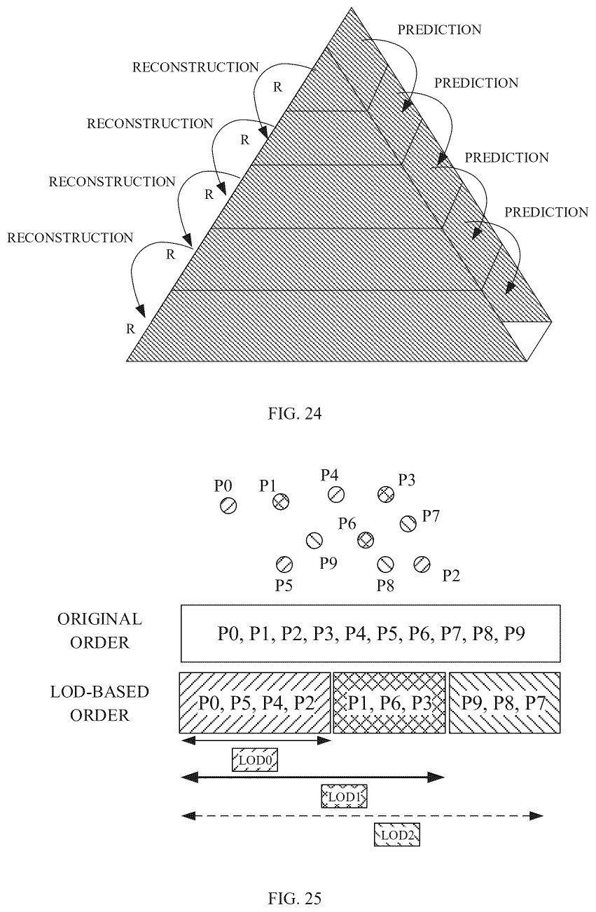

In a specific implementation, for inter-layer nearest-neighbour search, a pyramid structure is illustrated in FIG. 24. FIG. 25 is a schematic diagram illustrating an LOD construction process for inter-layer nearest-neighbour search. As illustrated in FIG. 25, different LOD layers, LOD0, LOD1, and LOD2, are obtained through partitioning based on geometry information. A point in LOD0 is used for prediction of an attribute of a point in a next LOD layer during inter-layer nearest-neighbour search.

The whole process of intra nearest-neighbour search will be described in detail below.

In the whole LOD partitioning process, there are three sets: O(k), L(k), and I(k). Herein, k is an index of an LOD layer during LOD partitioning, and I(k) is an input point set during partitioning of a current LOD layer. After LOD partitioning, sets O(k) and L(k) are obtained. The set O(k) stores a set of sampling points, and L(k) is a set of points in the current LOD layer. That is, the whole LOD partitioning process is as follows.

```
  (1) Initialization
  if k=0, (k)←{ }. Otherwise, (k)←L(k−1);
  O(k)←{ };
  (2) According to an LOD partitioning algorithm, sampling points are stored in O(k),
and remaining points are partitioned into L(k).
  (3) When the next iteration proceeds, 1←O(k).
```

It may be noted herein that, since the whole LOD partitioning is performed based on Morton codes, Morton code indexes corresponding to points are stored in O(k), L(k), and I(k).

During inter-layer nearest-neighbour search, i.e., nearest-neighbour search for points in the set L(k) in the set O(k), a specific search algorithm is as follows.

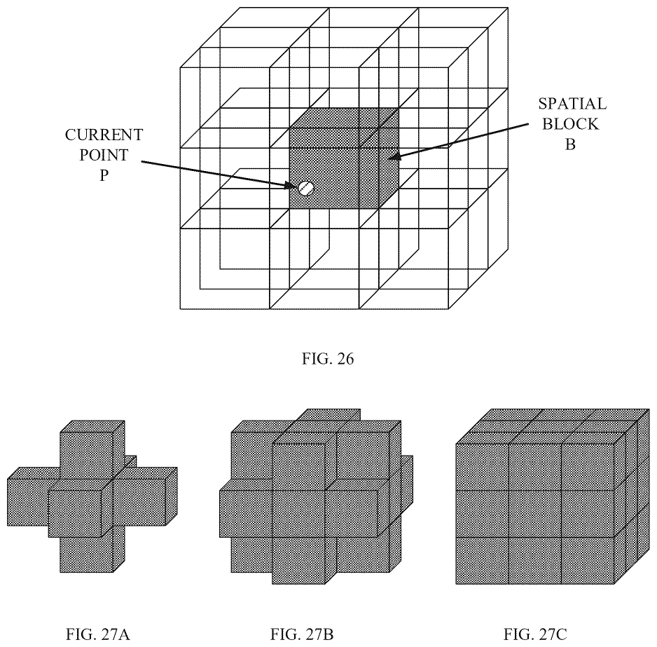

Taking nearest-neighbour search based on a spatial relationship as an example, during prediction of current point P, a parent block (block B) corresponding to point P is used for neighbour search, as illustrated in FIG. 26, and points in a neighbouring block that is coplanar or collinear with the current parent block are searched for attribute prediction.

FIG. 27A is a schematic diagram illustrating a coplanar spatial relationship, where there are a total of 6 spatial blocks having a relationship with the current parent block. FIG. 27B is a schematic diagram illustrating a coplanar or collinear spatial relationship, where there are a total of 18 spatial blocks having a relationship with the current parent block. FIG. 27C is a schematic diagram illustrating a coplanar, collinear, or concurrent spatial relationship, where there are a total of 26 spatial blocks having a relationship with the current parent block.

First, a corresponding spatial block is obtained based on coordinates of a current point. Second, N nearest neighbours of the current point are obtained through nearest-neighbour search for a spatial block that is coplanar, collinear, or concurrent with a current block in a previously-encoded LOD layer.

After the coplanar, collinear, or concurrent nearest-neighbour search, if the N nearest neighbours of the current point are still not obtained, then the N nearest neighbours of the current point may be obtained based on a fast search algorithm. A specific algorithm is as follows.

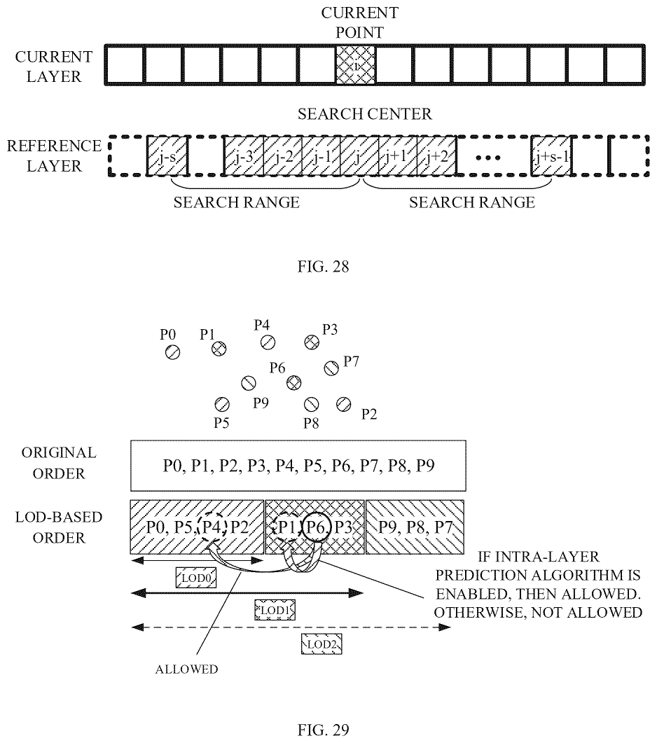

As illustrated in FIG. 28, during attribute inter-layer prediction, a Morton code of a current point to-be-encoded is first obtained based on geometry coordinates of the current point. Next, based on the Morton code of the current point, the first reference point (j) with Morton code greater than the Morton code of the current point is found in a reference picture. Then, nearest-neighbour search is performed within a range of [j-searchRange, j+searchRange].

Other specific algorithms for updating nearest neighbours are the same as the algorithm for inter nearest-neighbour search and will not be described in detail herein. The specific algorithms will be mentioned in the algorithm for inter nearest-neighbour search.

In another specific implementation, for intra-layer nearest-neighbour search, FIG. 29 is a schematic diagram of an LOD structure for attribute intra-layer nearest-neighbour search. As illustrated in FIG. 29, if an intra-layer prediction algorithm is enabled, that is, a syntax element EnableRefferingSameLoD=1, then nearest-neighbour search may be allowed within a layer, for example, a nearest neighbouring point of current point P6 may be P1 in LOD1, and nearest-neighbour search is not allowed in other layers. If the syntax element EnableRefferingSameLoD=0, then inter-layer search is allowed in other layers, for example, the nearest neighbouring point of current point P6 may be P4 in LOD1. In other words, when the intra-layer prediction algorithm is enabled, nearest-neighbour search is performed in a set of encoded points in the same layer within the same LOD layer, to obtain N nearest neighbours of the current point (inter-layer nearest-neighbour search is also performed).

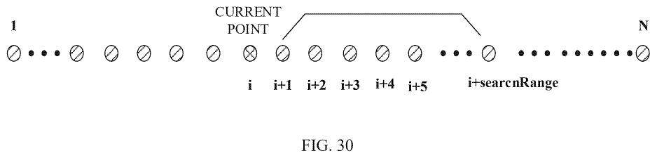

During attribute intra-layer prediction, nearest-neighbour search is performed based on a fast search algorithm. A specific algorithm is illustrated in FIG. 30. A current point is represented by grids. Assuming that a Morton code index of the current point is i, then nearest-neighbour search is performed in [i+1, it searchRange]. A specific algorithm for nearest-neighbour search is the same as an inter block-based fast search algorithm and will not be described in detail herein.

### (ii) Inter Nearest-Neighbour Search

FIG. 28 is a schematic diagram illustrating attribute inter prediction. As illustrated in FIG. 28, during attribute inter prediction, a Morton code of a current point to-be-encoded is first obtained based on geometry coordinates of the current point. Next, based on the Morton code of the current point, the first reference point (j) with Morton code greater than the Morton code of the current point is found in a reference picture. Then, nearest-neighbour search is performed within a range of [j-searchRange, j+searchRange].

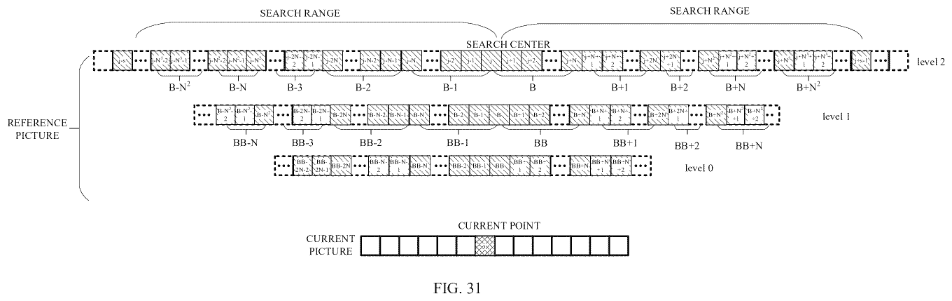

Currently, during intra and inter nearest-neighbour search, neighbourhood search is performed based on a block. For details, reference can be made to FIG. 31. As illustrated in FIG. 31, during neighbourhood search for a current point (with a Morton code index i), points in a reference picture are first partitioned into N (N=3) layers according to Morton codes. A specific partitioning algorithm is as follows.

For the first layer, assuming that the number of points in the reference picture are numPoints, the points in the reference picture are first partitioned into one block every M (M=2⁵=32) points.

For the second layer, based on the first layer, blocks in the first layer are also partitioned into one block every M (M=2⁵=32) blocks in the order of Morton codes. For the third layer, based on the second layer, blocks in the second layer are also partitioned into one block every M (M=2⁵=32) blocks in the order of Morton codes. Finally, a prediction structure illustrated in FIG. 31 is obtained.

During attribute prediction based on the prediction structure illustrated in FIG. 31, assuming that a Morton code index of a current point to-be-encoded is i, the first point with Morton code greater than or equal to the Morton code of the current point is first obtained in the reference picture, and an index of the first point is j. Then, a block index of a reference point is calculated based on j. The specific calculation method is as follows.
For the first layer, BucketSize_0=2⁵-32.
For the second layer, BucketSize_1−2⁵=32×BucketSize_0=1024.
For the third layer, BucketSize_2=2⁵-32×BucketSize_1=32768.

Assuming that a reference range of a prediction picture of the current point is [j-searchRange, j+searchRange], a start index of the third layer is calculated based on j-searchRange, and an end index of the third layer is calculated based on j+searchRange. Next, whether nearest-neighbour search is needed for some blocks in the second layer is first determined in blocks in the third layer. Then, proceed to the second layer, and whether the search is needed for each block in the first layer is determined. If nearest-neighbour search is needed for some blocks in the first layer, then point-by-point determination is performed on points in those blocks in the first layer to update a nearest neighbour(s).

The following will introduce an algorithm for index-based block calculation.

Assuming that a Morton code index of a current point is index, then an index of a corresponding block in the third layer is:

$$idx\_ 2 = index / BucketSize\_ 2$$

After the index idx_2 of the block in the third layer is obtained, a start index and an end index of a block corresponding to a current block in the second layer can be obtained based on idx_2.

$$startIdx 1 = idx\_ 2 \times BucketSize\_ 1$$

$$endIdx = idx\_ 2 \times BucketSize\_ 1 + BucketSize\_ 1 - 1$$

Similarly, based on the same algorithm, an index of a block in the first layer is obtained based on an index of a block in the second layer.

During block-based nearest-neighbour search, whether nearest-neighbour search is needed for the current block is first determined, that is, to filter blocks for nearest-neighbour search. Each spatial block can be obtained based on two variables minPos and maxPos, where minPos represents a minimum value of the block, and maxPos represents a maximum value of the block.

It is assumed that a distance of the farthest point among N nearest neighbours found for the current point is Dist, coordinates of a point to-be-encoded are (x, y, z), and the current block is represented by (minPos, maxPos), where minPos is a minimum value of a bounding box in three dimensions, and maxPos is a maximum value of the bounding box in three dimensions. In this case, a distance D between the current point and the bounding box is calculated as follows:

$$int dx = int ( std \text{::} max ( std \text{::} max ( minPos [ 0 ] - point [ 0 ] , 0 ) , point [ 0 ] - maxPos [ 0 ] ) ) ;$$

$$int dy = int ( std \text{::} max ( std \text{::} max ( minPos [ 1 ] - point [ 1 ] , 0 ) , point [ 1 ] - maxPos [ 1 ] ) ) ;$$

$$int dz = int ( std \text{::} max ( std \text{::} max ( minPos [ 2 ] - point [ 2 ] , 0 ) , point [ 2 ] - maxPos [ 2 ] ) ) ;$$

$$D = dx + dy + dz ;$$

points in the current block are traversed only when D is less than or equal to Dist.

### (b) Lifting Transform Coding of Attribute Information of a Point Cloud

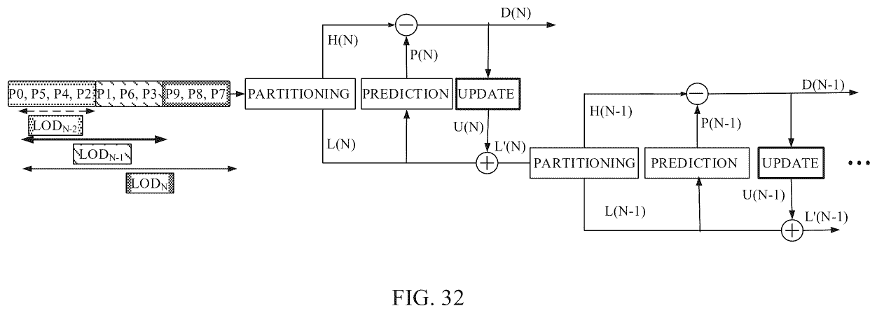

FIG. 32 is a schematic flowchart of lifting transform coding. Lifting transform also refers to predictive coding of attributes of the point cloud based on LOD. Different from predicting transform, in lifting transform, LOD is first partitioned into high and low layers, prediction is performed in the reverse order of LOD generation layers, and an update operator is introduced in the prediction process to update quantization weights of points in the low LOD layer, thereby improving the accuracy of prediction. This is because the points in the low LOD layer are more influential since attribute values of the points in the low LOD layer are frequently used for prediction of attribute values of points in the high LOD layer.

### Step 1, Partitioning Process

In the partitioning process, the complete LOD is partitioned into a low LOD layer(s) L(N) and a high LOD layer(s) H(N). If a point cloud has three LOD layers, that is, (LODₗ)_{l=0, 1, 2′} then after partitioning, LOD₂ is the high LOD layer and denoted as H(N), and (LODₗ)_{l=0, 1} is the low LOD layer and denoted as L(N).

### Step 2, Prediction Process

For a point in the high LOD layer, attribute information of a nearest neighbouring point is selected from the low layer as an attribute prediction value P(N) of a current point to-be-encoded, and a prediction residual D(N) is denoted as:

$$D ( N ) = H ( N ) - P ( N )$$

### Step 3, Update Process

The attribute prediction residual D(N) of the high LOD layer is updated to obtain U(N), and an attribute value of a point in the low LOD layer is lifted based on U(N), as illustrated in the following formula:

$${L}^{′} ( N ) = L ( N ) + U ( N )$$

In the descending order of LODs, the above processes will be continuously iterated until the lowest LOD layer.

Since the LOD-based prediction scheme makes points in the low LOD layer more influential, a quantization weight is introduced in a transform scheme based on lifting wavelet transform, a prediction residual is updated based on the prediction residual D(N) and a distance between a prediction point and a neighbouring point, and finally the prediction residual is adaptively quantized by using a quantization weight during transform. It may be noted herein that, a quantization weight of each point may be determined through geometry reconstruction at the decoding end, and thus the quantization weight does not need to be encoded.

### (c) RAHT

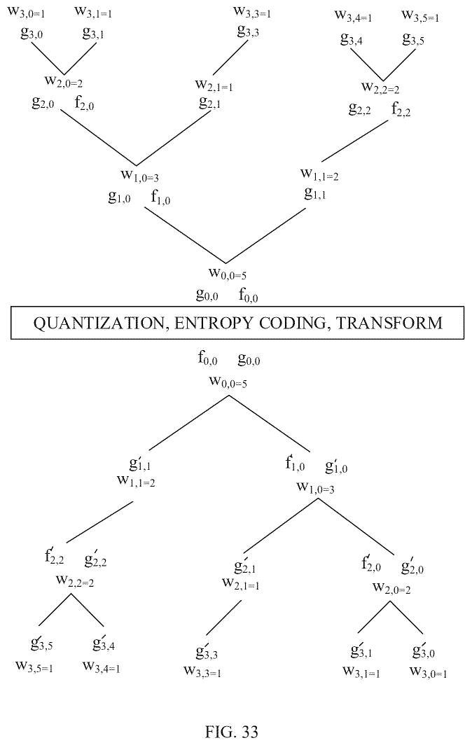

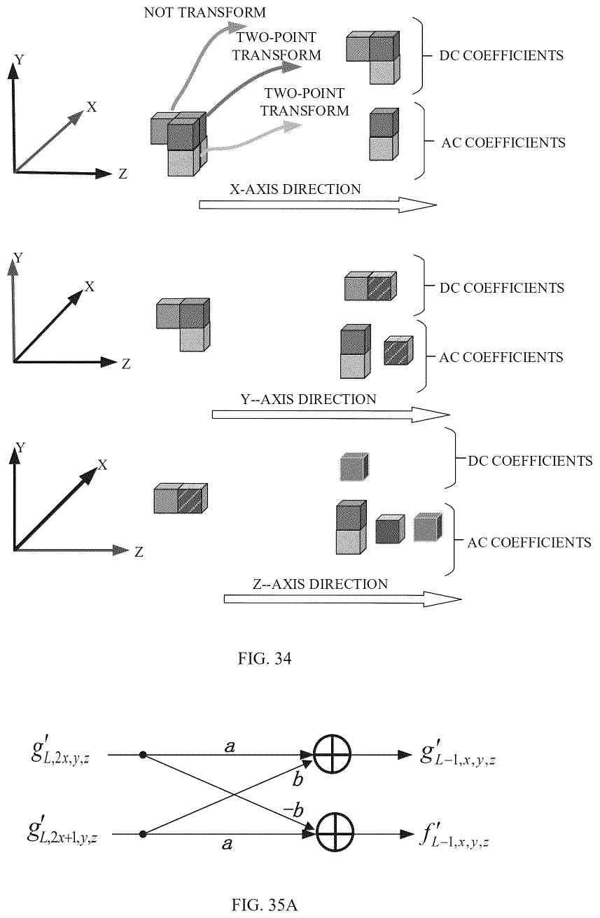

RAHT is a Haar wavelet transform in which attribute information of the point cloud may be transformed from the spatial domain to the frequency domain, further reducing correlation between attributes of the point cloud. The main idea of RAHT is to transform nodes in each layer in x, y, and z dimensions in a bottom-up manner according to an octree structure (as illustrated in FIG. 34), and this process is iterated until a root node of the octree is reached. As illustrated in FIG. 33, the basic idea is to perform wavelet transform based on a hierarchical structure of an octree, associate attribute information with octree nodes, perform recursive transform on attributes of an occupied node(s) in the same parent node in a bottom-up manner, and perform transform on nodes in each layer in x, y, and z dimensions until the root node of the octree is reached. During hierarchical transform, low-pass/low-frequency (DC) coefficients obtained after transform of nodes in the same layer are transmitted to nodes in the next layer for further transform, and all high-pass/high-frequency (AC) coefficients may be encoded using an arithmetic encoder.

In the transform process, transformed DC coefficients (direct-current components) of the nodes in the same layer are transmitted the previous layer for further transform, and transformed AC coefficients (alternating-current components) of each layer are quantized and encoded. The main transform process will be described below.

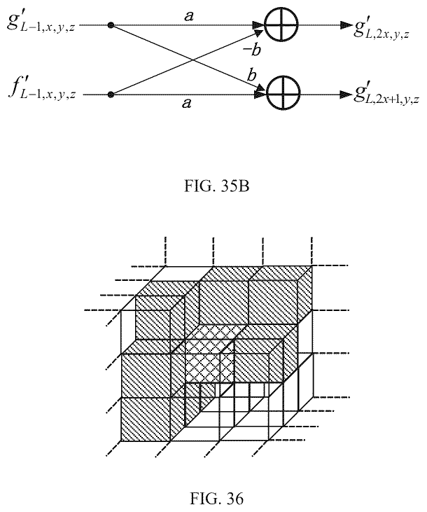

FIG. 35A is a schematic diagram illustrating RAHT forward transform, and FIG. 35B is a schematic diagram illustrating RAHT inverse transform. For the transform and inverse transform processes of RAHT, it is assumed that

$${g}_{L , 2 x , y , z}^{′} and {g}_{L , 2 x + 1 , y , z}^{′}$$

are attribute DC coefficients of two neighbouring points in layer L. After linear transformation, information of layer L−1 includes an AC coefficient

$${{f}^{′}}_{L - 1 , x , y , z}$$

and a DC coefficient

$${g}_{L - 1 , x , y , z}^{′} .$$

### Then,

$${{f}^{′}}_{L - 1 , x , y , z}$$

is no longer transformed and is directly quantized and encoded. For

$${g}_{L - 1 , x , y , z}^{′} ,$$

a nearest neighbour continues to be searched for the transform. If no nearest neighbour is found,

$${g}_{L - 1 , x , y , z}^{′}$$

may be directly transmitted to layer L−2. That is, RAHT transform is valid for only nodes with neighbouring points, and nodes without neighbouring points will be directly transmitted to the previous layer. In the above transform process, if weights (the number of non-empty child nodes in the node) corresponding to

$${g}_{L , 2 x , y , z}^{′} and {g}_{L , 2 x + 2 , y , z}^{′}$$

are respectively

$${w}_{L , 2 x , y , z}^{′} and {w}_{L , 2 x + 1 , y , z}^{′}$$

(respectively abbreviated as

$${w}_{0}^{′} and {w}_{1}^{′} ) ,$$

and a weight corresponding to

$${g}_{L - 1 , x , y , z}^{′} is {w}_{L - 1 , x , y , z}^{′} ,$$

then the general transform formula is:

$$[ \begin{matrix}{g}_{L - 1 , x , y , z}^{′} \\ {{f}^{′}}_{L - 1 , x , y , z}\end{matrix} ] = {T}_{w 0 , w 1} [ \begin{matrix}{g}_{L , 2 x , y , z}^{′} \\ {g}_{L , 2 x + 1 , y , z}^{′}\end{matrix} ]$$

In the above, T_{w0,w1} is a transform matrix:

$${T}_{w 0 , w 1} = \frac{1}{\sqrt{{w}_{0}^{′} + {w}_{1}^{′}}} [ \begin{matrix}\sqrt{{w}_{0}^{′}} & \sqrt{{w}_{1}^{′}} \\ - \sqrt{{w}_{1}^{′}} & \sqrt{{w}_{0}^{′}}\end{matrix} ]$$

The transform matrix is adaptively updated based on a weight corresponding to each point. The above process is iteratively updated according to a partitioning structure of an octree until the root node of the octree is reached.

In a specific implementation, for region adaptive hierarchical intra prediction transform coding, prediction may be performed based on RAHT transform coding. As illustrated in FIG. 33, RAHT attribute transform is based on a hierarchical order of an octree, and the transform proceeds from the voxel level until a root node is obtained, thereby completing hierarchical transform coding of the whole attribute. In prediction transform coding, attribute prediction transform coding is also performed based on the hierarchical order of the octree, but the transform proceeds from the root node down to the voxel level. In each RAHT attribute transform process, attribute prediction transform coding is performed based on a 2×2×2 block. Details are illustrated in FIG. 36. As illustrated in FIG. 36, it can be seen that a grid-filled block is a current block to-be-encoded, and blocks filled with diagonal lines are some neighbouring blocks that are coplanar or collinear with the current block to-be-encoded. An attribute of the current block is normalized in the following manner:

$${A}_{n o d e} = {\sum }_{p ∈ n o d e} attribute ( p ) ;$$

$${w}_{n o d e} = {\sum }_{p ∈ node} 1 = \{ p ∈ node \} ;$$

$${a}_{n o d e} = {A}_{node} / {w}_{node} .$$

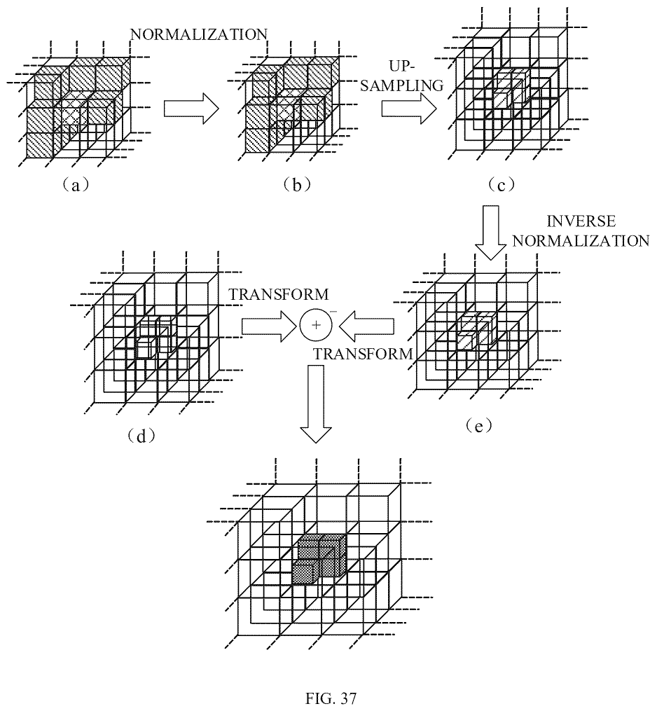

First, the attribute of the current block, i.e., A_{node}, can be obtained based on attributes of points contained in the current block. The attributes of the points contained in the current block are added simply, and then the attribute of the current block is normalized with the number of points in the current block, to obtain an average anode of the attribute of the current block. Attribute transform coding is performed based on the average of the attribute of the current block. For the specific coding process, reference can be made to FIG. 37.

An overall process of RAHT attribute prediction transform coding is illustrated in FIG. 37. Herein, (a) illustrates the current block and some coplanar and collinear neighbouring blocks, (b) illustrates a normalized block, (c) illustrates an up-sampled block, (d) illustrates the attribute of the current block, and (e) illustrates attributes of a prediction block obtained by performing linear weighted fitting based on neighbourhood attributes of the current block. Finally, attribute transform is performed on both (d) and (e) to obtain DC and AC coefficients, and predictive coding is performed on the AC coefficients.

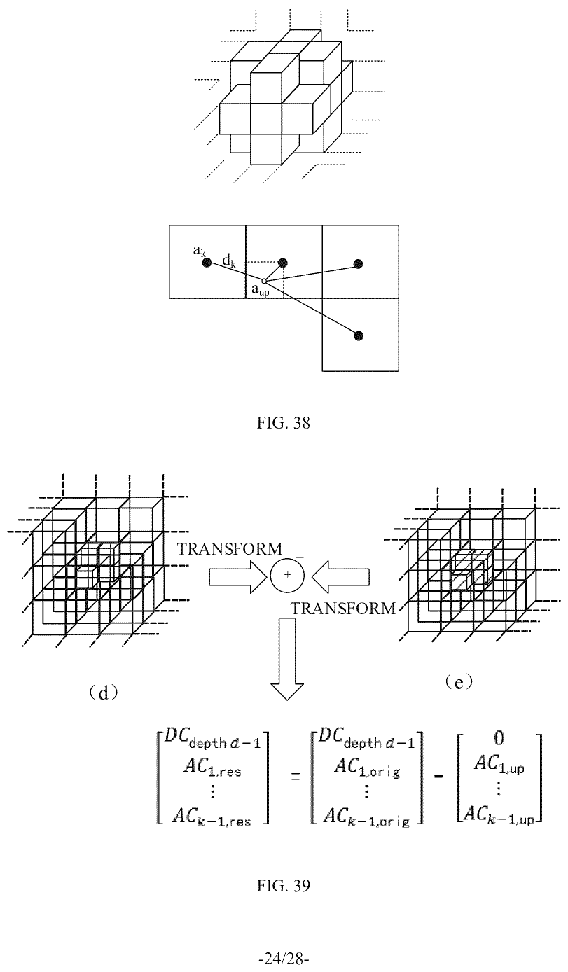

A predicted attribute of the current block can be obtained through linear fitting as illustrated in FIG. 38. As illustrated in FIG. 38, 19 neighbourhood blocks of the current block are first obtained, then linear weighted prediction is performed on an attribute of each sub-block based on spatial geometry distances between the neighbourhood blocks and each sub-block of the current block, and finally, transform is performed based on an attribute of a prediction block obtained through linear weighting. The specific attribute transform is illustrated in FIG. 39.

In FIG. 39, (d) represents an original attribute value, and corresponding attribute transform coefficients are as follows:

$$[ \begin{matrix}* \\ A {C}_{1 , orig} \\ ⋮ \\ A {C}_{k - 1 , orig}\end{matrix} ] = {T}_{node} [ \begin{matrix}{A}_{1} , orig / \sqrt{{w}_{1}} \\ ⋮ \\ {A}_{k , orig} / \sqrt{{w}_{k}}\end{matrix} ]$$

(e) represents an attribute prediction value, and corresponding attribute transform coefficients are as follows:

$$[ \begin{matrix}* \\ A {C}_{1 , up} \\ ⋮ \\ A {C}_{k - 1 , up}\end{matrix} ] = {T}_{node} [ \begin{matrix}{A}_{1 , up} / \sqrt{{w}_{1}} \\ ⋮ \\ {A}_{k , up} / \sqrt{{w}_{k}}\end{matrix} ]$$

By subtracting the attribute prediction value from the original attribute value, a prediction residual can be obtained as follows:

$$[ \begin{matrix}D {C}_{depth d - 1} \\ A {C}_{1 , res} \\ ⋮ \\ A {C}_{k - 1 , res}\end{matrix} ] = [ \begin{matrix}D {C}_{depth d - 1} \\ A {C}_{1 , orig} \\ ⋮ \\ A {C}_{k - 1 , orig}\end{matrix} ] - [ \begin{matrix}0 \\ A {C}_{1 , up} \\ ⋮ \\ A {C}_{k - 1 , up}\end{matrix} ]$$

In another specific implementation, for region adaptive hierarchical inter prediction transform coding, there may be two region adaptive hierarchical inter prediction transform coding schemes as follows.

### I. Region Adaptive Hierarchical Inter Prediction Transform Coding Scheme 1

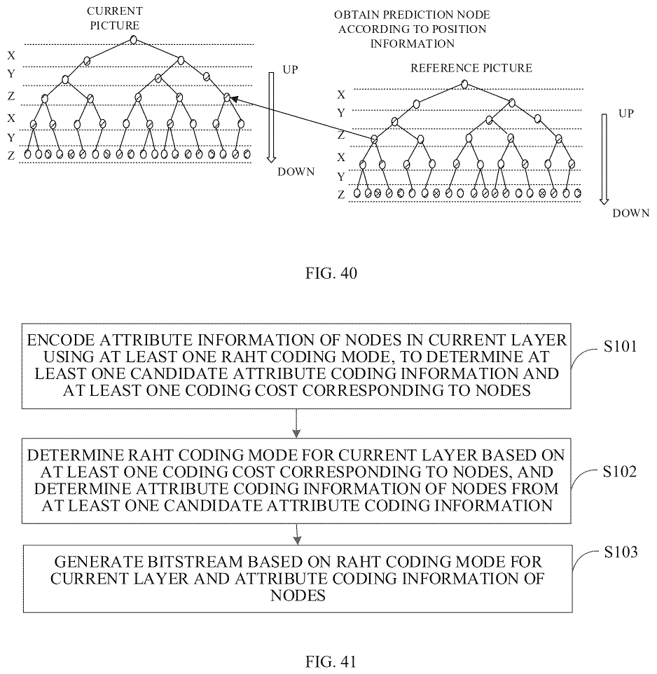

In region adaptive hierarchical inter prediction transform coding scheme 1, similar to intra prediction coding, an RAHT attribute transform coding structure is first constructed based on geometry information. That is, the transform proceeds from the voxel level until a root node is obtained, thereby completing hierarchical transform coding of the whole attribute. In this way, an intra coding structure and an inter attribute coding structure are constructed. For details, reference can be made to FIG. 40.

As illustrated in FIG. 40, a collocated node of a current node to-be-encoded (i.e., a current node) is first obtained in a reference picture based on geometry information of the current node, and then a predicted attribute of the current node is obtained based on geometry information and attribute information of a reference node.

An attribute prediction value of the current node is obtained in the following two different manners.
1. If an inter prediction node of the current node is valid, that is, the collocated node exists, then an attribute of the collocated node is directly used as the attribute prediction value of the current node.
2. If an inter prediction node of the current node is invalid, that is, no collocated node exists, then an attribute prediction value of an intra neighbouring node of the current node is used as the attribute prediction value of the current node.

Finally, the obtained attribute prediction value is used to predict an attribute of the current node, thereby completing predictive coding of the whole attribute.

### II. Region Adaptive Hierarchical Inter Prediction Transform Coding Scheme 2

In region adaptive hierarchical inter prediction transform coding scheme 2, different from intra prediction and inter prediction coding scheme 1, if inter prediction coding scheme 2 is enabled, an RAHT attribute transform coding structure is first constructed based on geometry information of a current node. That is, the node merge proceeds from the voxel level until a root node of the whole RAHT transform tree is obtained, thereby completing a transform coding hierarchical structure of the whole attribute. Next, according to the RAHT transform structure, the root node is partitioned to obtain N child nodes (where N is less than or equal to 8) of each node. In inter prediction coding scheme 2, independent orthogonal transform is first performed on attributes of the N child nodes through RAHT transform to obtain DC and AC coefficients of each child node, and then attribute inter prediction is performed on the AC coefficients of the N child nodes in the following manners.
1. If an inter prediction node of the current node is valid, that is, a collocated node exists, then an attribute of the collocated node is directly used as an attribute prediction value of the current node.
2. For the current node, if a node at exactly the same position as the current node can be found in a buffer of a reference picture, that is, a collocated node exists, then AC coefficients of M child nodes contained in the collocated node may be directly used as attribute prediction values of AC coefficients of N child nodes of the current node. If no AC coefficient exists at a position of a collocated node corresponding to the child node, prediction cannot be enabled.
a. If an AC coefficient of a child node contained in the collocated node is not zero, then the AC coefficient of the child node is directly used as a prediction value of a child node at a corresponding position of the current node.
b. If an AC coefficient of a child node contained in the collocated node is zero, then an AC coefficient of a child node corresponding to intra prediction is used as a prediction value of a child node at a corresponding position of the current node.
3. If an inter prediction node of the current node is invalid, that is, no collocated node exists, then an attribute prediction value of an intra neighbouring node of the current node is used as the attribute prediction value of the current node.

Currently, in common G-PCC RAHT attribute coding, whether RAHT prediction transform coding is used for inter/intra prediction coding of a node(s) in each point cloud in a current point cloud sequence is determined by a high-level syntax element such as a point cloud sequence-level syntax element. In addition, a layer level at which inter prediction coding is enabled is determined by a syntax element such as treeDepth, and only RAHT intra prediction coding is used for a lower RAHT coding layer(s). In the current RAHT coding scheme, whether the number N of neighbourhood nodes of the current node is greater than a certain threshold is first determined, and prediction (intra prediction or inter prediction) is performed on an AC coefficient of the current node only when the number N of neighbourhood nodes is greater than the certain threshold. If the number N of neighbourhood nodes of the current node is less than the certain threshold, it is considered that the current node does not satisfy a condition for predictive coding, and only attribute transform is performed on the current node. In the current coding scheme, spatial correlation of the current node, particularly neighbourhood geometric spatial correlation of the current node, is mainly used for improving the coding efficiency. However, in this coding scheme, inherent distribution characteristics of attribute information of each node are not taken into consideration, and an RAHT coding scheme for the whole point cloud sequence is directly determined at the sequence level. Then, when the prediction transform coding scheme is enabled, a coding mode for the current node is determined only based on the neighbourhood geometric spatial correlation of the current node, without effectively combining attribute distribution characteristics of the current node, resulting in low coding efficiency of the attribute information.

To solve the above problems, attribute distribution characteristics and spatial distribution characteristics of each node are taken into comprehensive consideration in embodiments of the disclosure. The encoder encodes each node in a current layer using at least one RAHT coding mode, to determine at least one coding cost corresponding to each node, and determines an optimal coding mode for the current layer according to the at least one coding cost corresponding to each node and transmits the optimal coding mode to the decoder. Accordingly, the decoder selects a decoding mode for decoding according to the RAHT coding mode for the current layer. As such, by adaptively selecting an optimal coding mode from multiple coding modes, the RAHT attribute coding efficiency and the decoding efficiency of attribute information of the point cloud are improved, and thus the decoding performance of the point cloud is improved.

Embodiments of the disclosure will be elaborated below with reference to the accompanying drawings.

In an embodiment of the disclosure, reference is made to FIG. 41 which is a schematic flowchart of a point cloud encoding method provided in embodiments of the disclosure. As illustrated in FIG. 41, the method may include the following.

At S101, attribute information of nodes in a current layer is encoded using at least one RAHT coding mode, to determine at least one candidate attribute coding information and at least one coding cost corresponding to the nodes.

It may be noted that, an encoding method in embodiments of the disclosure specifically refers to the point cloud encoding method, and the method may be applied to a point cloud encoder (also referred to as “encoder” for short).

Accordingly, in embodiments of the disclosure, the current layer may be an RAHT transform layer to-be-encoded. The encoder may construct an RAHT attribute transform coding structure corresponding to a point cloud based on geometry information of a node in the point cloud.

In embodiments of the disclosure, the RAHT attribute transform coding structure needs to be first constructed based on geometry information of a point in the point cloud. Specifically, based on an octree structure corresponding to the point cloud, the merge may proceed from a voxel level until a root node is obtained, thereby completing a transform coding hierarchical structure of the whole attribute and obtaining the RAHT attribute transform coding structure.

In some embodiments, from a root node, the encoder may perform down-sampling along each spatial coordinate axis direction based on an RAHT attribute transform coding structure, to determine at least one RAHT transform layer corresponding to the point cloud. Herein, the at least one RAHT transform layer includes the current layer.

Exemplarily, for the RAHT attribute transform coding structure, a layer obtained by performing one down-sampling sequentially along preset directions such as the z direction, the y direction, and the x direction each time may be defined as an RAHT transform layer, such as the current layer.

It may be noted that in embodiments of the disclosure, for the current layer, the current layer may include at least one point. In particular, during encoding of the current layer, the at least one point in the current layer may be used as a node to-be-encoded in the current layer.

Further, in embodiments of the disclosure, each point in the current layer corresponds to one geometry information and one attribute information, where the geometry information indicates a spatial relationship of the point, and the attribute information indicates information related to an attribute of the point.

Herein, the attribute information may be colour information, reflectance, or other attributes, which is not limited in embodiments of the disclosure. In particular, when the attribute information is the colour information, the attribute information may be colour information in any colour space. For example, the attribute information may be colour information in RGB space, colour information in YUV space, colour information in YCbCr space, or the like, which is also not limited in embodiments of the disclosure.

In embodiments of the disclosure, the attribute information of the nodes in the current layer is encoded using the at least one RAHT coding mode, to determine the at least one candidate attribute coding information and the at least one coding cost corresponding to the nodes.

In embodiments of the disclosure, the at least one RAHT coding mode may include the RAHT transform coding mode, RAHT intra prediction transform coding mode, and RAHT inter prediction transform coding mode described above. The encoder encodes attribute information of each node in the current layer using the at least one RAHT coding mode, to determine a coding cost corresponding to each RAHT coding mode and coding information corresponding to each RAHT coding mode. The encoder determines the coding information corresponding to each RAHT coding mode as one candidate attribute coding information, to obtain at least one candidate attribute coding information and at least one coding cost corresponding to each node.

It may be noted that in embodiments of the disclosure, in the RAHT transform coding mode, attribute transform coding may be performed based on a hierarchical order of an octree. Based on the hierarchical order of the octree, the encoder may continuously perform transform coding from the voxel level until the root node is obtained, thereby completing RAHT transform coding of attribute information of each node in the point cloud. In RAHT prediction transform coding modes such as the RAHT intra prediction transform coding mode and the RAHT inter prediction transform coding mode, coding may also be performed based on the hierarchical order of the octree, but proceeds from the root node to the voxel level.

In some embodiments, the encoder may preset a buffer corresponding to the at least one RAHT coding mode and store candidate attribute coding information corresponding to each RAHT coding mode in a corresponding buffer. For example, the encoder may set buffer 1 corresponding to the RAHT transform coding mode, buffer 2 corresponding to the RAHT intra prediction transform coding mode, and buffer 3 corresponding to the RAHT inter prediction transform coding mode. The encoder encodes attribute information of a current node using each of the RAHT transform coding mode, the RAHT intra prediction transform coding mode, and the RAHT inter prediction transform coding mode, and stores candidate attribute coding information corresponding to the RAHT transform coding mode in buffer 1, candidate attribute coding information corresponding to the RAHT intra prediction transform coding mode in buffer 2, and candidate attribute coding information corresponding to the RAHT inter prediction transform coding mode in buffer 3.

At S102, an RAHT coding mode for the current layer is determined based on the at least one coding cost corresponding to the nodes, and attribute coding information of the nodes is determined from the at least one candidate attribute coding information.

In embodiments of the disclosure, the encoder may evaluate the coding performance of the at least one RAHT coding mode for the current node based on the at least one coding cost corresponding to the nodes, and determine the attribute coding information of the nodes from the at least one candidate attribute coding information.

In some embodiments, the encoder may determine a coding cost sum of each RAHT coding mode for all nodes in the current layer based on at least one coding cost corresponding to each node in the current layer. According to the coding cost sum of each RAHT coding mode, an RAHT coding mode with a minimum coding cost sum is determined as the RAHT coding mode for the current layer. Further, for each node in the current layer, the encoder determines, from at least one candidate attribute coding information corresponding to/of each node, candidate attribute coding information corresponding to the RAHT coding mode for the current layer as attribute coding information corresponding to each node.

That is to say, the encoder may determine an optimal coding mode for the current layer as the RAHT coding mode for the current layer based on the at least one coding cost corresponding to each node.

In some embodiments, in at least one buffer corresponding to the at least one RAHT coding mode, the encoder may determine as the attribute coding information of each node candidate attribute coding information of each node stored in a buffer corresponding to the RAHT coding mode for the current layer.

At S103, a bitstream is generated based on the RAHT coding mode for the current layer and the attribute coding information of the nodes.

In embodiments of the disclosure, the encoder may determine attribute coding information of the current layer based on attribute coding information of each node in the current layer. The encoder may determine an RAHT coding mode flag of the current layer according to the RAHT coding mode for the current layer. The RAHT coding mode flag indicates an RAHT transform coding mode or an RAHT prediction transform coding mode, and the RAHT prediction transform coding mode includes an inter prediction transform coding mode or an intra prediction transform coding mode.

The encoder performs the same processing on each RAHT transform layer in the point cloud to determine a coding mode flag of each RAHT transform layer and attribute coding information of each RAHT transform layer. The encoder generates the bitstream based on the coding mode flag of each RAHT transform layer and the attribute coding information of each RAHT transform layer.

As such, the encoder transmits the bitstream to a decoder, and the decoder may determine a decoding mode for each RAHT transform layer according to the coding mode flag of each RAHT transform layer of the point cloud in the bitstream, and decode the attribute coding information of each RAHT transform layer according to the decoding mode for each RAHT transform layer.

In some embodiments, the encoder may add an RAHT prediction coding mode for each RAHT transform layer in the point cloud to an attribute brick header (ABH) parameter set. In this way, the decoder can obtain the RAHT prediction coding mode for each RAHT transform layer based on ABH. A form of encoding the ABH parameter set is not limited in embodiments of the disclosure.

It may be understood that in embodiments of the disclosure, the encoder encodes each node in the current layer using the at least one RAHT coding mode, to determine at least one candidate attribute coding information and at least one coding cost and corresponding to each node. In this way, the encoder may determine an optimal coding mode for the current layer according to the at least one coding cost corresponding to each node in the current layer, determine attribute coding information of each node according to this coding mode, and transmits the RAHT coding mode for the current layer and the attribute coding information of the node to the decoding end. Therefore, the decoding end can adaptively decode attribute information of the current layer according to the RAHT coding mode for the current layer. As such, by introducing multiple coding modes and adaptively selecting an optimal mode based on coding costs, attribute distribution characteristics and spatial distribution characteristics of each node are taken into comprehensive consideration, the RAHT attribute coding efficiency and the encoding efficiency of attribute information of the point cloud are improved, and thus the encoding performance of the point cloud is improved.

In some embodiments, the at least one candidate attribute coding information includes transform coding information and prediction transform coding information, and the process in S101 above can be implemented through operations at S1011 to S1013 as follows.

At S1011, attribute transform information and transform coding information of each node in the current layer are determined by performing RAHT transform coding on attribute information of each node in a point cloud.

In some embodiments, from a node of a voxel level until a root node, the encoder may determine attribute transform information and transform coding information of each node in the point cloud by recursively performing RAHT transform and coding on the attribute information of each node in the point cloud based on an RAHT attribute transform coding structure corresponding to the point cloud, to determine the transform coding information of each node in the current layer. The attribute transform information is determined by performing RAHT transform on the attribute information, and the transform coding information is determined by performing coding on the attribute transform information.

Exemplarily, from the node of the voxel level, the encoder may obtain a DC coefficient and an AC coefficient of each node by recursively performing RAHT transform on the attribute information of each node in the point cloud based on an octree structure. The DC coefficient is transmitted to a next layer for further transform, and the AC coefficient is encoded as the attribute transform information of each node to determine the transform coding information of each node in the point cloud. As such, the attribute transform information and the transform coding information of each node in the current layer are determined according to nodes contained in the current layer.

In some embodiments, from a root node, the encoder may also determine N child nodes of each node in the point cloud based on an RAHT attribute transform coding structure corresponding to the point cloud. For the N child nodes of each node, the encoder determines attribute transform information and transform coding information of the N child nodes by performing RAHT attribute transform and coding on attribute information of the N child nodes, to determine attribute transform information and transform coding information of each node in the point cloud, where N is greater than 0 and not greater than a preset threshold of the number of child nodes. The encoder determines the attribute transform information and the transform coding information of each node in the current layer according to the attribute transform information and the transform coding information of each node in the point cloud. Exemplarily, the preset threshold of the number of child nodes may be 8, or may be set to another value according to the actual situation. The specific selection is made according to the actual situation, which is not limited in embodiments of the disclosure.

Exemplarily, the encoder may obtain N child nodes of each node through partitioning from the root node based on an octree structure, where N is greater than 0 and less than or equal to 8. From the root node, the encoder obtains a DC coefficient and an AC coefficient of each child node by performing independent orthogonal transform on the N child nodes of each node. The DC coefficient is also transmitted to a next layer for further transform, and the AC coefficient of each child node is encoded as the attribute transform information to determine transform coding information of each child node. As such, according to a correspondence between a parent node and a child node, the attribute transform information and the transform coding information of each node in the point cloud are obtained through the same processing on each node in the octree structure. According to nodes contained in the current layer, the attribute transform information and the transform coding information of each node in the current layer are determined.

At S1012, predictive coding is performed on the attribute transform information of each node in the current layer, to determine prediction transform coding information of each node in the current layer.

In S1012, the encoder performs predictive coding on the attribute transform information of each node in the current layer. Herein, if inter prediction is disabled, the encoder may perform intra prediction coding on each node in the current layer, to determine intra prediction coding information of each node. If inter prediction is enabled, the encoder may perform intra prediction coding and inter prediction coding on each node in the current layer, to determine intra prediction coding information and inter prediction coding information of each node.

It may be noted that, before RAHT intra/inter prediction transform coding, the encoder first determines whether the current node satisfies a condition for RAHT intra/inter prediction transform coding. The encoder determines whether the number of neighbourhood nodes of a parent node of each node in the current layer is greater than a preset first number threshold. When the number of neighbourhood nodes of the parent node of each node in the current layer is greater than the preset first number threshold, the encoder determines whether the number of neighbourhood nodes of each node in the current layer is greater than a preset second number threshold. When the number of neighbourhood nodes of each node in the current layer is greater than the preset second number threshold, the encoder performs predictive coding on the attribute transform information of each node in the current layer, to determine the prediction transform coding information of each node in the current layer.

When the number of neighbourhood nodes of the parent node of each node in a current layer is not greater than the preset first number threshold, or the number of neighbourhood nodes of each node in the current layer is not greater than the preset second number threshold, the encoder performs RAHT transform coding on the current node.

In some embodiments, for intra prediction coding, an attribute information prediction value of each node in the current layer may be determined according to the above intra prediction coding mode and an attribute information prediction value of a neighbourhood node of each node in the current layer. Further, coding is performed according to the attribute information prediction value of each node, to determine intra prediction transform coding information of each node in the current layer. For example, the attribute information prediction value may be an AC coefficient prediction value.

In some embodiments, inter prediction coding can be implemented by using any one of inter prediction coding scheme 1 and inter prediction coding scheme 2 described above.

Exemplarily, if inter prediction coding is implemented by using inter prediction coding scheme 1, the encoder may determine a collocated node corresponding to a position of each node in the current layer in a reference point cloud corresponding to the point cloud, determine an attribute information prediction value of each node in the current layer based on reconstructed attribute transform information of the collocated node, and perform coding on the attribute transform information of each node in the current layer based on the attribute information prediction value, to determine the prediction transform coding information of each node in the current layer.

In some embodiments, if no collocated node corresponding to a node exists in the reference point cloud, then through intra prediction, an attribute information prediction value of the node is determined according to reconstructed attribute transform information of a neighbourhood node of the node.

Exemplarily, if inter prediction coding is implemented by using inter prediction coding scheme 2, the encoder may determine a collocated node corresponding to each node in the current layer in a reference point cloud corresponding to the point cloud. When each node in the current layer is a parent node in the current layer, the encoder determines an attribute information prediction value of each node in the current layer based on reconstructed attribute transform information of the collocated node. When each node in the current layer is a child node in the current layer, the encoder determines the attribute information prediction value of each node in the current layer based on reconstructed attribute transform information of M child nodes of the collocated node in the reference point cloud, where M is greater than 0 and not greater than a preset threshold of the number of child nodes. The encoder performs coding on the attribute transform information of each node in the current layer based on the attribute information prediction value, to determine the inter prediction transform coding information of each node in the current layer.

Herein, for the parent node in the current layer, the encoder directly determines reconstructed attribute transform information of a collocated node of the parent node in the reference point cloud as an attribute information prediction value of the parent node. For N child nodes of the parent node, the encoder determines, according to the collocated node of the parent node in the reference point cloud, reconstructed attribute transform information of M child nodes of the collocated node in the reference point cloud as attribute information prediction values of the N child nodes of the parent node.

It may be noted that, the above reference point cloud is a point cloud whose attribute information has been encoded and reconstructed. For example, the reference point cloud may be a point cloud whose attribute information has been encoded and reconstructed and which neighbours to a point cloud where the current layer is located. In some embodiments, the reconstructed attribute transform information may be a reconstructed AC coefficient.

In some embodiments, the attribute information prediction value of each node in the current layer may be determined based on the reconstructed attribute transform information of the M child nodes of the collocated node in the reference point cloud through the following processes. A collocated child node corresponding to a position of each child node in the M child nodes is determined. When reconstructed attribute transform information of the collocated child node is greater than a preset information-value threshold, the attribute information prediction value of each node in the current layer is determined based on the reconstructed attribute transform information of the collocated child node. When the reconstructed attribute transform information of the collocated child node is less than or equal to the preset information-value threshold, the attribute information prediction value of each node in the current layer is determined based on reconstructed attribute transform information of a neighbourhood node of each node in the current layer.

Herein, for N child nodes of the parent node, the encoder determines a child node at the same position of each child node in the M child nodes of the collocated node as the collocated child node of each child node. When the reconstructed attribute transform information of the collocated child node is greater than the preset information-value threshold, for example, a reconstructed AC coefficient of the collocated child node is greater than zero, the reconstructed attribute transform information of the collocated child node, for example, the reconstructed AC coefficient of the collocated child node, is directly determined as an attribute information prediction value of each child node. When the reconstructed attribute transform information of the collocated child node is less than or equal to the preset information-value threshold, for example, the reconstructed AC coefficient of the collocated child node is zero, intra prediction is used to determine the attribute information prediction value of each child node based on reconstructed attribute transform information of a neighbourhood node(s) of each child node.

It may be noted that in the above processes, if an AC coefficient of a collocated child node of a child node does not exist, intra prediction or inter prediction is disabled.

In some embodiments, if no collocated node corresponding to a parent node exists in the reference point cloud, then through intra prediction, an attribute information prediction value of the parent node is determined according to reconstructed attribute transform information of a neighbourhood node of the parent node.

In some embodiments, if no collocated child node corresponding to a child node exists in the reference point cloud, then through intra prediction, an attribute information prediction value of the child node is determined according to reconstructed attribute transform information of a neighbourhood node of the child node.

It may be noted that in embodiments of the disclosure, there are two implementations for the RAHT transform coding mode, and the RAHT prediction transform coding mode includes the RAHT intra prediction transform coding mode and the RAHT inter prediction transform coding mode. There are two implementations for the RAHT inter prediction transform coding mode. Therefore, for encoding attribute information of a node(s) according to the at least one RAHT coding mode, the encoder may combine various implementations of the above coding modes. The specific selection is made according to the actual situation, which is not limited in embodiments of the disclosure.

At S1013, the at least one coding cost corresponding to the nodes is determined based on the transform coding information and the prediction transform coding information.

In S1013, when intra prediction is disabled, the encoder may determine the at least one coding cost corresponding to the nodes by performing decoding and reconstruction as well as coding cost calculation based on the transform coding information and intra prediction transform coding information.

Alternatively, when intra prediction is enabled, the encoder may determine the at least one coding cost corresponding to the nodes by performing decoding and reconstruction as well as coding cost calculation based on the transform coding information, intra prediction transform coding information, and inter prediction transform coding information.

In some embodiments, the encoder may determine a first rate-distortion cost corresponding to each node in the current layer by performing decoding and reconstruction based on the transform coding information, determine a second rate-distortion cost corresponding to each node in the current layer by performing decoding and reconstruction based on the intra prediction transform coding information, and determine a third rate-distortion cost corresponding to each node in the current layer by performing decoding and reconstruction based on the inter prediction transform coding information.

As such, the encoder may determine a first coding cost corresponding to the current layer based on the first rate-distortion cost corresponding to each node in the current layer, where the first coding cost corresponds to an RAHT transform coding mode. The encoder may determine a second coding cost corresponding to the current layer based on the second rate-distortion cost corresponding to each node in the current layer, where the second coding cost corresponds to an RAHT intra prediction transform coding mode. The encoder may determine a third coding cost corresponding to the current layer based on the third rate-distortion cost corresponding to each node in the current layer, where the third coding cost corresponds to an RAHT inter prediction transform coding mode. The encoder may determine the RAHT coding mode for the current layer by comparing the first coding cost, the second coding cost, and the third coding cost.

Exemplarily, in a rate-distortion optimization algorithm, a distortion D between reconstructed attribute information and original attribute information of a node is first calculated for each RAHT coding mode, and then a bitrate R required for encoding of each RAHT coding mode is obtained. A rate-distortion cost J corresponding to each RAHT coding mode is calculated according to the following formula.

$$J = D + λ \times R$$

λ may be calculated based on an attribute quantization parameter, for example,

$$λ = {2}^{\frac{QP - 4}{6}} \times N .$$

A parameter N may be preset to a different value according to reflectance and colour.

In the above scheme, the attribute information of the nodes in the current layer is encoded to introduce the at least one coding mode: RAHT transform coding, RAHT intra prediction transform coding, and RAHT inter prediction transform coding. By comparing coding costs of the at least one coding mode, an RAHT coding mode is adaptively selected for all nodes in the current layer. In some embodiments, the encoder may also determine an attribute coding mode for the nodes in the current layer by comprehensively analyzing distribution characteristics of reconstructed attributes of a neighbourhood node of a parent node of the nodes in the current layer.

In some embodiments, the encoder may determine the RAHT coding mode for the current layer based on attribute information of a parent node of the nodes in the current layer and reconstructed attribute information of a neighbourhood node of the parent node, and encode the attribute information of the nodes in the current layer using the RAHT coding mode for the current layer, to determine the attribute coding information of the nodes.

Exemplarily, when an error between the attribute information of the parent node of the nodes in the current layer and the reconstructed attribute information of the neighbourhood node of the parent node is greater than a preset error threshold, an RAHT transform coding mode is determined as the RAHT coding mode for the current layer, where the transform coding mode indicates that RAHT transform and coding are performed on the attribute information. When the error between the attribute information of the parent node of the nodes in the current layer and the reconstructed attribute information of the neighbourhood node of the parent node is less than or equal to the preset error threshold, an RAHT prediction transform coding mode is determined as the RAHT coding mode for the current layer, where the prediction transform coding mode indicates that predictive coding is performed on an attribute transform coefficient determined by performing RAHT transform on the attribute information.

That is to say, if an error between an attribute of a parent node of the current node and a reconstructed attribute of a neighbourhood node of the parent node of the current node is within a certain range, then it is considered that distribution characteristics of neighbourhood attributes of the current node are relatively flat. Based on such distribution characteristics, it may be implicitly inferred that the RAHT prediction transform coding mode is used for the current node. Otherwise, it is considered that the attribute distribution of the neighbourhood range of the current node is relatively fluctuating, and in this case, the RAHT transform coding mode is used. The encoder processes each node in the current layer in the above manner, and thus can determine the RAHT coding mode for the current layer.

It may be understood that, the encoder determines a coding mode for the nodes in the current layer based on the distribution characteristics of the reconstructed attributes of the neighbourhood node of the parent node. In this way, attribute distribution characteristics and spatial distribution characteristics of the nodes are taken into comprehensive consideration, the RAHT attribute coding efficiency and the encoding efficiency of attribute information of the point cloud are improved, and thus the encoding performance of the point cloud is improved.

In some embodiments, the encoder may indicate at the point cloud level whether the prediction transform coding mode is enabled for each RAHT transform layer in the point cloud. The encoder may determine a prediction transform enable flag of the point cloud according to an RAHT coding mode determined for each RAHT transform layer in the point cloud. Herein, the prediction transform enable flag indicates whether the prediction transform coding mode is enabled for the RAHT transform layer in the point cloud.

In some embodiments, the encoder may determine the number of coding mode flags corresponding to the point cloud according to at least one RAHT transform layer in the point cloud for which the RAHT coding mode is determined. Herein, the number of coding mode flags is used for informing the decoder of the number of coding mode flags to be decoded. The encoder signals at least one of the prediction transform enable flag or the number of coding mode flags into the bitstream and transmits to decoder.

In some embodiments, the encoder may partition the nodes in the current layer into at least two node groups. For each node group among the at least two node groups, the encoder determines at least one coding cost corresponding to the node group based on at least one coding cost corresponding to each node in the node group. The encoder determines an RAHT coding mode for the node group based on the at least one coding cost corresponding to the node group. The encoder determines attribute coding information of each node in the node group based on the RAHT coding mode for the node group, to determine attribute coding information of the node group. The encoder determines at least two groups of attribute coding information corresponding to the current layer and an RAHT coding mode corresponding to each group of attribute coding information according to the RAHT coding mode for the node group and the attribute coding information of the node group, and generates the bitstream.

Exemplarily, by partitioning the nodes in the current layer into the at least two node groups, the encoder may realize partitioning of attribute information, such as AC coefficient groups, of the nodes in the current layer, to obtain at least two AC coefficient groups corresponding to the current layer. The encoder selects an optimal coding mode for each coefficient group and transmits the coding mode for each coefficient group to the decoder, so that attribute information of each coefficient group can be reconstructed at the decoding end.

It may be understood that, by partitioning the nodes in the current layer into the at least two node groups, for each node group, the encoder performs coding in at least one RAHT coding mode and compares coding costs, and determines an optimal coding mode for the node group and transmits to the decoder. As such, the RAHT attribute coding efficiency and the encoding efficiency of attribute information of the point cloud are further improved, and thus the encoding performance of the point cloud is improved.

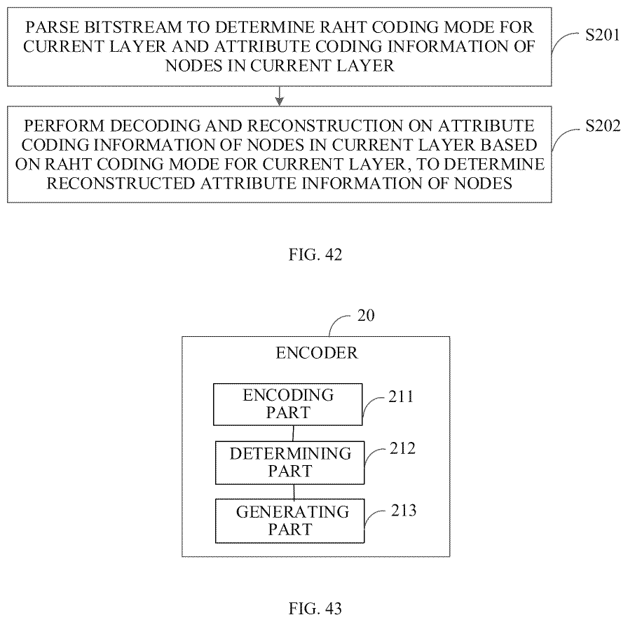

In an embodiment of the disclosure, reference is made to FIG. 42 which is a schematic flowchart of a point cloud decoding method provided in embodiments of the disclosure. As illustrated in FIG. 42, the method may include the following.

At S201, a bitstream is parsed to determine an RAHT coding mode for a current layer and attribute coding information of nodes in the current layer.

It may be noted that, a decoding method in embodiments of the disclosure specifically refers to the point cloud decoding method, and the method may be applied to a point cloud decoder (also referred to as “decoder” for short).

In embodiments of the disclosure, as described above in the method of the encoder, the RAHT coding mode for the current layer is determined by the encoder based on at least one coding cost corresponding to the nodes in the current layer, and the at least one coding cost corresponding to the nodes is determined by the encoder by encoding attribute information of the nodes using at least one RAHT coding mode.

In some embodiments, the decoder may obtain an RAHT coding mode flag of the current layer by parsing the bitstream, and determine the RAHT coding mode for the current layer according to the RAHT coding mode flag. The RAHT coding mode flag indicates an RAHT transform coding mode or an RAHT prediction transform coding mode.

In embodiments of the disclosure, the decoder may determine an RAHT prediction coding mode for each RAHT transform layer in a point cloud by parsing a bitstream corresponding to the point cloud. As such, during decoding of the current layer, an RAHT prediction coding mode for the current layer can be determined. For example, the decoder may obtain the RAHT prediction coding mode for each RAHT transform layer in the point cloud by decoding an ABH parameter set in the bitstream.

In some embodiments, the decoder determines a prediction transform enable flag of the point cloud by parsing the bitstream, where the prediction transform enable flag indicates whether a prediction transform coding mode is enabled for the point cloud. When the prediction transform enable flag indicates that the prediction transform coding mode is enabled, the decoder determines the number of coding mode flags corresponding to the point cloud.

In some embodiments, the decoder may determine the number of coding mode flags corresponding to a point cloud by parsing the bitstream, where the point cloud is a point cloud where the current layer is located. The decoder parses an RAHT coding mode flag in the bitstream according to the number of coding mode flags, to determine an RAHT coding mode flag of each layer in the point cloud.

Exemplarily, the prediction transform enable flag can be determined by a point-cloud-level flag disableAttrInterPred in the bitstream. The number of coding mode flags can be determined by a field attr_code_mode_cnt in the bitstream. Details are as follows.

| | Descriptor | Semantics |
|---|---|---|
| attribute_data_unit_header( ) { | | |
| adu_attr_parameter_set_id | u(4) | 7.4.4.2 |
| adu_reserved_zero_3bits | u(3) | 7.4.4.2 |
| adu_sps_attr_idx | ue(v) | 7.4.4.2 |
| adu_slice_id | ue(v) | 7.4.4.2 |
| if(lod_dist_log2_offset_present) | | |
| lod_dist_log2_offset | se(v) | 10.6.2 |
| if(last_comp_pred_enabled && AttrDim == 3) | | |
| for(dpth = 0; dpth ≤ lod_max_levels_minus1; | | |
| dpth++) | | |
| last_comp_pred_coeff_diff[dpth] | se(v) | 10.6.10.1 |
| if(inter_comp_pred_enabled) | | |
| for(dpth = 0; dpth ≤ lod_max_levels_minus1; | | |
| dpth++) | | |
| for(c = 1; c < AttrDim; c++) | | |
| inter_comp_pred_coeff_diff[dpth][c] | se(v) | 10.6.10.1 |
| if(attr_qp_offsets_present) | | |
| for(qc = 0; qc < Min(2, AttrDim); qc++) | | |
| attr_qp_offset[qc] | se(v) | 10.7.1 |
| attr_qp_layers_present | u(1) | 10.7.1 |
| if(attr_qp_layers_present) { | | |
| attr_qp_layer_cnt_minus1 | ue(v) | 10.7.1 |
| for(dpth = 0; dpth ≤ attr_qp_layer_cnt_minus1; | | |
| dpth++) | | |
| for(qc = 0; qc < Min(2, AttrDim); qc++) | | |
| attr_qp_layer_offset[dpth][qc] | se(v) | 10.7.1 |
| } | | |
| attr_qp_region_cnt | ue(v) | 10.7.1 |
| if(attr_qp_region_cnt) | | |
| attr_qp_region_bits_minus1 | ue(v) | 10.7.1 |
| for(i = 0; i < attr_qp_region_cnt; i++) { | | |
| if(¬attr_coord_conv_enabled) { | | |
| for(k = 0; k < 3; k++) | | |
| attr_qp_region_origin_xyz[i][k] | u(v) | 10.7.1 |
| for(k = 0; k < 3; k++) | | |
| attr_qp_region_size_minus1_xyz[i][k] | u(v) | 10.7.1 |
| } else { | | |
| for(k = 0; k < 3; k++) | | |
| attr_qp_region_origin_rpi[i][k] | u(v) | 10.7.1 |
| for(k = 0; k < 3; k++) | | |
| attr_qp_region_size_minus1_rpi[i][k] | u(v) | 10.7.1 |
| } | | |
| for(ps = 0; ps < Min(2, AttrDim); ps++) | | |
| attr_qp_region_offset[i][ps] | se(v) | 10.7.1 |
| } | | |
| disableAttrInterPred | u(1) | |
| if(attr_coding_type == 0&& !disableAttrInterPred) | | |
| if(raht_prediction_enabled){ | | |
| attr_code_mode_cnt | ue(v) | |
| for(i = 0; i < attr_code_mode_cnt; i++) | | |
| attr_code_mode[i] | u(1) | |
| } | | |
| byte_alignment( ) | | |
| } | | |

At S202, decoding and reconstruction is performed on the attribute coding information of the nodes in the current layer based on the RAHT coding mode for the current layer, to determine reconstructed attribute information of the nodes.

In embodiments of the disclosure, the current layer may be an RAHT transform layer to-be-decoded.

In embodiments of the disclosure, an RAHT attribute transform coding structure needs to be first constructed based on geometry information of a point(s) in the point cloud. Specifically, based on an octree structure corresponding to the point cloud, the merge may proceed from a voxel level until a root node is obtained, thereby completing a transform coding hierarchical structure of the whole attribute and obtaining the RAHT attribute transform coding structure.

In embodiments of the disclosure, a layer obtained by performing one down-sampling sequentially along preset directions such as the z direction, the y direction, and the x direction each time may be defined as an RAHT transform layer, such as the current layer.

It may be noted that in embodiments of the disclosure, for the current layer, the current layer may include at least one point. In particular, during decoding of the current layer, the at least one point in the current layer may be used as a node to-be-decoded in the current layer.

Further, in embodiments of the disclosure, each point in the current layer corresponds to one geometry information and one attribute information, where the geometry information indicates a spatial relationship of the point, and the attribute information indicates information related to an attribute of the point.

Herein, the attribute information may be colour information, reflectance, or other attributes, which is not limited in embodiments of the disclosure. In particular, when the attribute information is the colour information, the attribute information may be colour information in any colour space. For example, the attribute information may be colour information in RGB space, colour information in YUV space, colour information in YCbCr space, or the like, which is also not limited in embodiments of the disclosure.

In some embodiments, the RAHT coding mode may include an RAHT transform coding mode and an RAHT prediction transform coding mode.

When the RAHT coding mode is the RAHT transform coding mode, the decoder determines an RAHT transform decoding mode as a corresponding decoding mode, and performs RAHT transform decoding on the attribute coding information to determine the reconstructed attribute information of the nodes. The RAHT transform coding mode indicates that the encoder performs RAHT transform and coding on the attribute information of the nodes.

Exemplarily, when the RAHT coding mode is the RAHT transform coding mode, the decoder performs entropy decoding on attribute coding information of each node in the current layer to obtain attribute transform information of each node, such as an AC coefficient of each node. The decoder performs RAHT inverse transform on the attribute transform information such as the AC coefficient of each node, to obtain reconstructed attribute information.

When the RAHT coding mode is the RAHT prediction transform coding mode, the decoder performs prediction on attribute transform information of the nodes in the current layer to determine attribute information prediction values of the nodes in the current layer, and performs RAHT transform decoding on the attribute coding information based on the attribute information prediction values, to determine the reconstructed attribute information of the nodes in the current layer. The RAHT prediction transform coding mode indicates that the encoder performs RAHT transform on the attribute information of the nodes and performs predictive coding on the attribute transform information determined through RAHT transform.

Exemplarily, when the RAHT coding mode is the RAHT prediction transform coding mode, the decoder decodes the attribute coding information of the nodes to obtain residual information, and performs intra/inter prediction on the attribute transform information of the nodes to determine attribute information prediction values. Exemplarily, the attribute information prediction value may be an AC coefficient prediction value. The decoder determines, according to the residual and the attribute information prediction values, reconstructed attribute transform information such as reconstructed AC coefficients, and performs RAHT inverse transform on the reconstructed attribute transform information to obtain reconstructed attribute information.

In some embodiments, the RAHT prediction transform coding mode includes an inter prediction transform coding mode or an intra prediction transform coding mode. The decoder determines a corresponding RAHT prediction transform decoding mode according to the inter prediction transform coding mode or the intra prediction transform coding mode, and decodes attribute coding information of each node in the current layer.

It may be understood that in embodiments of the disclosure, the decoder performs decoding and reconstruction on the attribute coding information of the nodes in the current layer according to an RAHT coding mode transmitted by the encoder, to determine the reconstructed attribute information of the nodes. The RAHT coding mode for the current layer is an optimal coding mode for the current layer determined by the encoder according to at least one coding cost corresponding to each node in the current layer. In particular, through comprehensive consideration of attribute distribution characteristics and spatial distribution characteristics of each node, the encoder encodes each node in the current layer using at least one RAHT coding mode, to determine the at least one coding cost corresponding to each node. Accordingly, the decoder selects a decoding mode for decoding according to the RAHT coding mode for the current layer, so that attribute information of the current layer can be adaptively decoded according to the RAHT coding mode for the current layer. As such, by adaptively selecting an optimal coding mode from multiple coding modes, the RAHT attribute coding efficiency and the decoding efficiency of attribute information of the point cloud are improved, and thus the decoding performance of the point cloud is improved.

In some embodiments, the RAHT prediction transform coding mode includes an RAHT intra prediction transform coding mode. When the RAHT coding mode is an intra prediction transform coding mode, the decoder determines the attribute information prediction values of the nodes in the current layer according to attribute information prediction values of neighbourhood nodes of the nodes in the current layer.

In some embodiments, when the RAHT coding mode is an inter prediction transform coding mode, the decoder may determine collocated nodes corresponding to positions of the nodes in the current layer in a reference point cloud. The decoder determines the attribute information prediction values of the nodes in the current layer based on reconstructed attribute transform information of the collocated nodes. When no collocated node exists, the decoder determines the attribute information prediction values of the nodes in the current layer according to attribute information prediction values of neighbourhood nodes of the nodes in the current layer.

In some embodiments, the RAHT prediction transform coding mode includes an RAHT intra prediction transform coding mode. When the RAHT coding mode is an intra prediction transform coding mode, the decoder determines the attribute information prediction values of the nodes in the current layer according to attribute information prediction values of neighbourhood nodes of the nodes in the current layer.

Herein, for the decoder, it may be noted that in some embodiments, before decoding the nodes using an RAHT intra/inter prediction decoding mode, the decoder first determines whether the number of neighbourhood nodes of a parent node of each node in the current layer is greater than a preset first number threshold. When the number of neighbourhood nodes of the parent node of each node in the current layer is greater than the preset first number threshold, the decoder determines whether the number of neighbourhood nodes of each node in the current layer is greater than a preset second number threshold. When the number of neighbourhood nodes of each node in the current layer is greater than the preset second number threshold, it indicates that the RAHT intra/inter prediction decoding mode may be enabled for decoding the nodes. The decoder determines a decoding mode for each node in the current layer according to the RAHT coding mode for the current layer. Otherwise, that is, if the number of neighbourhood nodes of the parent node of each node in the current layer is not greater than the preset first number threshold, or the number of neighbourhood nodes of each node in the current layer is not greater than the preset second number threshold, the decoder performs RAHT transform decoding on each node in the current layer.

In some embodiments, corresponding to determining the RAHT coding mode by the encoder by grouping the nodes in the current layer described above, the decoder determines at least two groups of attribute coding information corresponding to the current layer and an RAHT coding mode corresponding to each group of attribute coding information among the at least two groups of attribute coding information by parsing the bitstream. The at least two groups of attribute coding information correspond to at least two node groups, the at least two node groups are obtained by partitioning the nodes in the current layer, the RAHT coding mode corresponding to each group of attribute coding information is determined based on at least one coding cost corresponding to each node group, and the at least one coding cost corresponds to the at least one RAHT coding mode. The decoder determines reconstructed attribute information corresponding to each group of attribute coding information by performing decoding and reconstruction on each group of attribute coding information according to the RAHT coding mode corresponding to each group of attribute coding information, to determine the reconstructed attribute information of the nodes in the current layer.

It may be understood that, the decoder decodes attribute coding information corresponding to each node group according to an RAHT coding mode corresponding to each node group in the current layer transmitted by the encoder, to obtain reconstructed attribute information corresponding to each node group. The RAHT coding mode corresponding to each node group is an optimal coding mode for each node group determined by the encoder by encoding at least one RAHT coding mode for each node group and comparing coding costs. Therefore, the RAHT attribute coding efficiency and the encoding efficiency of attribute information of the point cloud are further improved, and thus the encoding performance of the point cloud is improved.

Based on the foregoing embodiments, in another embodiment of the disclosure, based on the same inventive concept of the foregoing embodiments, FIG. 43 is a schematic structural diagram of an encoder. As illustrated in FIG. 43, the encoder 20 may include an encoding part 211, a determining part 212, and a generating part 213. The encoding part 211 is configured to encode attribute information of nodes in a current layer using at least one RAHT coding mode, to determine at least one candidate attribute coding information and at least one coding cost corresponding to the nodes. The determining part 212 is configured to determine an RAHT coding mode for the current layer based on the at least one coding cost corresponding to the nodes, and determine attribute coding information of the nodes from the at least one candidate attribute coding information. The generating part 213 is configured to generate a bitstream based on the RAHT coding mode for the current layer and the attribute coding information of the nodes.

In some embodiments, the at least one candidate attribute coding information includes transform coding information and prediction transform coding information. The encoding part 211 is further configured to determine attribute transform information and transform coding information of each node in the current layer by performing RAHT transform coding on attribute information of each node in a point cloud. The encoding part 211 is further configured to perform predictive coding on the attribute transform information of each node in the current layer, to determine prediction transform coding information of each node in the current layer. The encoding part 211 is further configured to determine the at least one coding cost corresponding to the nodes based on the transform coding information and the prediction transform coding information.

In some embodiments, the encoding part 211 is further configured to determine whether the number of neighbourhood nodes of a parent node of each node in the current layer is greater than a preset first number threshold. The encoding part 211 is further configured to determine whether the number of neighbourhood nodes of each node in the current layer is greater than a preset second number threshold, when the number of neighbourhood nodes of the parent node of each node in the current layer is greater than the preset first number threshold. The encoding part 211 is further configured to perform predictive coding on the attribute transform information of each node in the current layer, to determine the prediction transform coding information of each node in the current layer, when the number of neighbourhood nodes of each node in the current layer is greater than the preset second number threshold.

In some embodiments, the encoding part 211 is further configured to: from a node of a voxel level until a root node, determine attribute transform information and transform coding information of each node in the point cloud by recursively performing RAHT transform and coding on the attribute information of each node in the point cloud based on an RAHT attribute transform coding structure corresponding to the point cloud, to determine the transform coding information of each node in the current layer. The attribute transform information is determined by performing RAHT transform on the attribute information, and the transform coding information is determined by performing coding on the attribute transform information.

In some embodiments, the prediction transform coding information includes inter prediction transform coding information. The encoding part 211 is further configured to perform inter prediction coding on the attribute transform information of each node in the current layer, to determine inter prediction transform coding information of each node in the current layer.

In some embodiments, the prediction transform coding information includes intra prediction transform coding information. The determining part 212 is further configured to perform intra prediction coding on the attribute transform information of each node in the current layer, to determine intra prediction transform coding information of each node in the current layer.

In some embodiments, the encoding part 211 is further configured to: from a root node, determine N child nodes of each node in the point cloud based on an RAHT attribute transform coding structure corresponding to the point cloud. The encoding part 211 is further configured to: for the N child nodes of each node, determine attribute transform information and transform coding information of the N child nodes by performing RAHT attribute transform and coding on attribute information of the N child nodes, to determine attribute transform information and transform coding information of each node in the point cloud, where Nis greater than 0 and not greater than a preset threshold of the number of child nodes. The encoding part 211 is further configured to determine the attribute transform information and the transform coding information of each node in the current layer according to the attribute transform information and the transform coding information of each node in the point cloud.

In some embodiments, the encoding part 211 is further configured to determine a collocated node corresponding to a position of each node in the current layer in a reference point cloud corresponding to the point cloud, determine an attribute information prediction value of each node in the current layer based on reconstructed attribute transform information of the collocated node, and perform coding on the attribute transform information of each node in the current layer based on the attribute information prediction value, to determine the inter prediction transform coding information of each node in the current layer.

In some embodiments, the encoding part 211 is further configured to determine a collocated node corresponding to each node in the current layer in a reference point cloud corresponding to the point cloud. The encoding part 211 is further configured to determine an attribute information prediction value of each node in the current layer based on reconstructed attribute transform information of the collocated node, when each node in the current layer is a parent node in the current layer. The encoding part 211 is further configured to determine the attribute information prediction value of each node in the current layer based on reconstructed attribute transform information of M child nodes of the collocated node in the reference point cloud, when each node in the current layer is a child node in the current layer. M is greater than 0 and not greater than a preset threshold of the number of child nodes. The encoding part 211 is further configured to perform coding on the attribute transform information of each node in the current layer based on the attribute information prediction value, to determine the inter prediction transform coding information of each node in the current layer.

In some embodiments, each node in the current layer includes the child node in the current layer. The encoding part 211 is further configured to determine a collocated child node corresponding to a position of each child node in the M child nodes. The encoding part 211 is further configured to determine the attribute information prediction value of each node in the current layer based on the reconstructed attribute transform information of the collocated child node, when reconstructed attribute transform information of the collocated child node is greater than a preset information-value threshold. The encoding part 211 is further configured to determine an attribute information prediction value of each child node based on reconstructed attribute transform information of a neighbourhood node of each child node, when the reconstructed attribute transform information of the collocated child node is less than or equal to the preset information-value threshold.

In some embodiments, the encoding part 211 is further configured to determine the attribute information prediction value of each node in the current layer according to an attribute information prediction value of a neighbourhood node of each node in the current layer, when no collocated node corresponding to a position of each node in the current layer in the reference point cloud corresponding to the point cloud exists.

In some embodiments, the prediction transform coding information includes intra prediction transform coding information and inter prediction transform coding information, and the at least one coding cost includes a first rate-distortion cost, a second rate-distortion cost, and a third rate-distortion cost. The encoding part 211 is further configured to determine a first rate-distortion cost corresponding to each node in the current layer by performing decoding and reconstruction based on the transform coding information, determine a second rate-distortion cost corresponding to each node in the current layer by performing decoding and reconstruction based on the intra prediction transform coding information, and determine a third rate-distortion cost corresponding to each node in the current layer by performing decoding and reconstruction based on the inter prediction transform coding information.

In some embodiments, the determining part 212 is further configured to determine a first coding cost corresponding to the current layer based on the first rate-distortion cost corresponding to each node in the current layer, where the first coding cost corresponds to an RAHT transform coding mode. The determining part 212 is further configured to determine a second coding cost corresponding to the current layer based on the second rate-distortion cost corresponding to each node in the current layer, where the second coding cost corresponds to an RAHT intra prediction transform coding mode. The determining part 212 is further configured to determine a third coding cost corresponding to the current layer based on the third rate-distortion cost corresponding to each node in the current layer, where the third coding cost corresponds to an RAHT inter prediction transform coding mode. The determining part 212 is further configured to determine the RAHT coding mode for the current layer by comparing the first coding cost, the second coding cost, and the third coding cost.

In some embodiments, the determining part 212 is further configured to determine the RAHT coding mode for the current layer based on attribute information of a parent node of the nodes in the current layer and reconstructed attribute information of a neighbourhood node of the parent node, and encode the attribute information of the nodes in the current layer using the RAHT coding mode for the current layer, to determine the attribute coding information of the nodes.

In some embodiments, the determining part 212 is further configured to determine an RAHT transform coding mode as the RAHT coding mode for the current layer, when an error between the attribute information of the parent node of the nodes in the current layer and the reconstructed attribute information of the neighbourhood node of the parent node is greater than a preset error threshold. The transform coding mode indicates that RAHT transform and coding are performed on the attribute information. The determining part 212 is further configured to determine an RAHT prediction transform coding mode as the RAHT coding mode for the current layer, when the error between the attribute information of the parent node of the nodes in the current layer and the reconstructed attribute information of the neighbourhood node of the parent node is less than or equal to the preset error threshold. The prediction transform coding mode indicates that predictive coding is performed on an attribute transform coefficient determined by performing RAHT transform on the attribute information.

In some embodiments, the generating part 213 is further configured to determine an RAHT coding mode flag of the current layer according to the RAHT coding mode for the current layer, where the RAHT coding mode flag indicates an RAHT transform coding mode or an RAHT prediction transform coding mode, and the RAHT prediction transform coding mode includes an inter prediction transform coding mode or an intra prediction transform coding mode. The generating part 213 is further configured to determine attribute coding information of the current layer based on the attribute coding information of the nodes. The generating part 213 is further configured to: for each RAHT transform layer in a point cloud, determine a coding mode flag of the RAHT transform layer and attribute coding information of the RAHT transform layer by processing the RAHT transform layer. The generating part 213 is further configured to generate the bitstream based on the coding mode flag of the RAHT transform layer and the attribute coding information of the RAHT transform layer.

In some embodiments, the encoding part 211 is further configured to: from a root node, perform down-sampling along each spatial coordinate axis direction based on an RAHT attribute transform coding structure, to determine at least one RAHT transform layer corresponding to the point cloud. The at least one RAHT transform layer includes the current layer.

In some embodiments, the determining part 212 is further configured to determine a prediction transform enable flag of the point cloud, where the prediction transform enable flag indicates whether a prediction transform coding mode is enabled for the RAHT transform layer in the point cloud; and/or determine the number of coding mode flags corresponding to the point cloud. The generating part 213 is further configured to signal at least one of the prediction transform enable flag or the number of coding mode flags into the bitstream.

In some embodiments, the encoding part 211 is further configured to partition the nodes in the current layer into at least two node groups; for each node group among the at least two node groups, determine at least one coding cost corresponding to the node group based on at least one coding cost corresponding to each node in the node group; and determine an RAHT coding mode for the node group based on the at least one coding cost corresponding to the node group. The encoding part 211 is further configured to determine attribute coding information of each node in the node group based on the RAHT coding mode for the node group, to determine attribute coding information of the node group; and determine at least two groups of attribute coding information corresponding to the current layer and an RAHT coding mode corresponding to each group of attribute coding information according to the RAHT coding mode for the node group and the attribute coding information of the node group, and generate the bitstream.

It may be understood that in this embodiment, the “unit” may be part of the circuitry, part of the processor, part of the program or software, etc., and of course may also be a module, or may be non-modular. In addition, various components described in this embodiment may be integrated into one processing unit or may be present as a number of physically separated units, or two or more units may be integrated into one. The integrated unit may take the form of hardware or a software functional module.

It may be noted that, the above description of encoder apparatus embodiments is similar to the above description of encoding method embodiments. The apparatus embodiments have similar beneficial effects as the method embodiments. Technical details not disclosed in the apparatus embodiments in the disclosure are understood with reference to the description of method embodiments in the disclosure.

If the integrated unit is implemented as a software function module and not sold or used as a stand-alone product, the integrated unit may be stored in a computer-readable storage medium. Based on such understanding, the technical solution of this embodiment in essential, or a part that contributes to the prior art, or all or part of the technical solution, may be embodied in the form of a software product. The computer software product is stored in a storage medium and includes a number of instructions to enable a computer device (which may be a personal computer, a server, or a network device, etc.) or processor to perform all or part of the operations of the method described in this embodiment. The foregoing storage medium includes a USB stick, a removable hard disk, a read only memory (ROM), a random access memory (RAM), a diskette or a CD-ROM, and other media that may store program codes.

Thus, embodiments of the disclosure provide a storage medium (i.e., a computer-readable storage medium), which is applied to the encoder 20. The computer-readable storage medium is configured to store a computer program which, when executed by a first processor, is operable to implement the method described in any one of the foregoing embodiments.

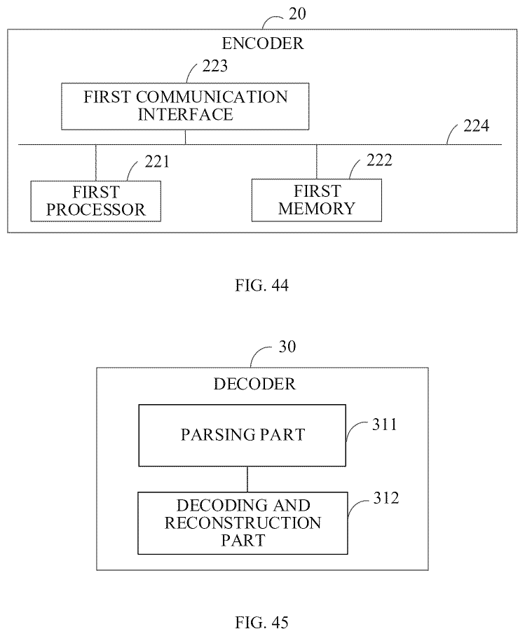

Based on the above structure of the encoder 20 and the computer-readable storage medium, FIG. 44 is schematic structural diagram 2 of an encoder. As illustrated in FIG. 44, the encoder 20 may include a first memory 222, a first processor 221, a first communication interface 223, and a first bus system 224. The first memory 222, the first processor 221, and the first communication interface 223 are coupled together via the first bus system 224. It may be understood that the first bus system 224 is configured to enable connection and communication between these components. The first bus system 224 includes a power bus, a control bus, and a status signal bus in addition to a data bus. For the sake of clarity, however, the various buses are labelled as first bus system 224.

The first communication interface 223 is configured to receive and transmit signals during information transmission with other external network elements.

The first memory 222 is configured to store a computer program executable by the first processor.

The first processor 221 is configured to determine the number of first nodes in nodes in a current layer and the number of second nodes in child nodes of the nodes in the current layer, where the number of first nodes and the number of second nodes are used for determining whether RAHT transform is performed on the nodes in the current layer; and determine reconstructed attribute values of the child nodes of the nodes in the current layer according to the number of first nodes and the number of second nodes.

It will be appreciated that the first memory 222 in embodiments of the disclosure may be a transitory memory or non-transitory memory, or may include both transitory and non-transitory memory. In particular, the non-transitory memory may be an ROM, a programmable ROM (PROM), an erasable PROM (EPROM), an electrically EPROM (EEPROM), or a flash memory. The transitory memory may be an RAM, which is used as an external cache. By way of illustration, but not limitation, many forms of RAM are available, such as a static RAM (SRAM), a dynamic RAM (DRAM), a synchronous DRAM (SDRAM), a double data rate synchronous random access memory (DDRSDRAM), an enhanced SDRAM (ESDRAM), a synchlink DRAM (SLDRAM), and a direct Rambus RAM (DRRAM). The first memory 222 of the system and method described in this disclosure is intended to include, but is not limited to, these and any other suitable types of memory.

The first processor 221 may be an integrated circuit chip with signal processing capabilities. During implementation, the operations in the above method may be accomplished by integrated logic circuitry in the hardware of the first processor 221 or by instructions in the form of software. The first processor 221 described above may be a general-purpose processor, a digital signal processor (DSP), an application specific integrated circuit (ASIC), a field programmable gate array (FPGA), or other programmable logic device, discrete gate or transistor logic device, discrete hardware component. The various methods, steps and logic block diagrams disclosed in embodiments of the disclosure may be implemented or performed. The general-purpose processor may be a microprocessor or the processor may also be any conventional processor, etc. The operations in the method disclosed in conjunction with embodiments of the disclosure may be performed directly by the hardware decoder processor or by a combination of hardware and software modules in the decoder processor. The software module may be located in a random memory, flash memory, read-only memory, programmable read-only memory or electrically erasable programmable memory, registers and other storage media mature in the art. The storage medium is located in the first memory 222, and the first processor 221 reads the information in the first memory 222 and completes the operations of the above method in combination with its hardware.

It will be appreciated that these embodiments described in this disclosure may be implemented in hardware, software, firmware, middleware, microcode, or combinations thereof. For hardware implementations, the processing unit may be implemented in one or more ASIC, DSP, DSP Device (DSPD), programmable logic device (PLD), FPGA, general-purpose processor, controller, microcontroller, microprocessor, other electronic unit for performing the functions described in this disclosure, or a combination thereof. For software implementations, the technology described in this disclosure may be implemented by means of modules (e.g., procedures, functions, etc.) that perform the functions described in this disclosure. The software code may be stored in a memory and executed by a processor. The memory may be implemented in the processor or outside the processor.

Optionally, as another embodiment, the first processor 221 is further configured to perform the method described in any one of the foregoing embodiments when executing the computer program.

FIG. 45 is a schematic structural diagram of a decoder. As illustrated in FIG. 45, the decoder 30 may include a parsing part 311 and a decoding and reconstruction part 312. The parsing part 311 is configured to parse a bitstream to determine an RAHT coding mode for a current layer and attribute coding information of nodes in the current layer, where the RAHT coding mode for the current layer is determined by an encoder based on at least one coding cost corresponding to the nodes in the current layer, and the at least one coding cost corresponding to the nodes is determined by the encoder by encoding attribute information of the nodes using at least one RAHT coding mode. The decoding and reconstruction part 312 is configured to perform decoding and reconstruction on the attribute coding information of the nodes in the current layer based on the RAHT coding mode for the current layer, to determine reconstructed attribute information of the nodes. It may be understood that in this embodiment, the “unit” may be part of the circuitry, part of the processor, part of the program or software, etc., and of course may also be a module, or may be non-modular. In addition, various components described in this embodiment may be integrated into one processing unit or may be present as a number of physically separated units, or two or more units may be integrated into one. The integrated unit may take the form of hardware or a software functional module.

In some embodiments, the decoding and reconstruction part 312 is further configured to perform RAHT transform decoding on the attribute coding information to determine the reconstructed attribute information of the nodes, when the RAHT coding mode is an RAHT transform coding mode. The RAHT transform coding mode indicates that the encoder performs RAHT transform and coding on the attribute information of the nodes.

In some embodiments, the decoding and reconstruction part 312 is further configured to perform prediction on attribute transform information of the nodes in the current layer to determine attribute information prediction values of the nodes in the current layer, when the RAHT coding mode is an RAHT prediction transform coding mode. The decoding and reconstruction part 312 is further configured to perform RAHT transform decoding on the attribute coding information based on the attribute information prediction values, to determine the reconstructed attribute information of the nodes in the current layer. The RAHT prediction transform coding mode indicates that the encoder performs RAHT transform on the attribute information of the nodes and performs predictive coding on the attribute transform information determined through RAHT transform.

In some embodiments, the RAHT prediction transform coding mode includes an RAHT intra prediction transform coding mode. The decoding and reconstruction part 312 is further configured to determine the attribute information prediction values of the nodes in the current layer according to attribute information prediction values of neighbourhood nodes of the nodes in the current layer, when the RAHT coding mode is an intra prediction transform coding mode.

In some embodiments, the RAHT prediction transform coding mode includes an RAHT inter prediction transform coding mode. The decoding and reconstruction part 312 is further configured to: determine collocated nodes corresponding to positions of the nodes in the current layer in a reference point cloud, when the RAHT coding mode is an inter prediction transform coding mode; and determine the attribute information prediction values of the nodes in the current layer based on reconstructed attribute transform information of the collocated nodes.

In some embodiments, the decoding and reconstruction part 312 is further configured to determine the attribute information prediction values of the nodes in the current layer according to attribute information prediction values of neighbourhood nodes of the nodes in the current layer, when no collocated node exists.

In some embodiments, the parsing part 311 is further configured to determine the RAHT coding mode for the current layer according to an RAHT coding mode flag of the current layer. The RAHT coding mode flag indicates an RAHT transform coding mode or an RAHT prediction transform coding mode, and the RAHT prediction transform coding mode includes an inter prediction transform coding mode or an intra prediction transform coding mode.

In some embodiments, the parsing part 311 is further configured to: determine a number of coding mode flags corresponding to a point cloud, where the point cloud is a point cloud where the current layer is located; and parse an RAHT coding mode flag in the bitstream according to the number of coding mode flags, to determine an RAHT coding mode flag of each layer in the point cloud.

In some embodiments, the decoding and reconstruction part 312 is further configured to determine at least two groups of attribute coding information corresponding to the current layer and an RAHT coding mode corresponding to each group of attribute coding information among the at least two groups of attribute coding information by parsing the bitstream. The at least two groups of attribute coding information correspond to at least two node groups, the at least two node groups are obtained by partitioning the nodes in the current layer, the RAHT coding mode corresponding to each group of attribute coding information is determined based on at least one coding cost corresponding to each node group, and the at least one coding cost corresponds to the at least one RAHT coding mode. The decoding and reconstruction part 312 is further configured to determine reconstructed attribute information corresponding to each group of attribute coding information by performing decoding and reconstruction on each group of attribute coding information according to the RAHT coding mode corresponding to each group of attribute coding information, to determine the reconstructed attribute information of the nodes in the current layer.

In some embodiments, the parsing part 311 is further configured to determine a prediction transform enable flag of the point cloud by parsing the bitstream, where the prediction transform enable flag indicates whether a prediction transform coding mode is enabled for the point cloud. The parsing part 311 is further configured to determine the number of coding mode flags corresponding to the point cloud, when the prediction transform enable flag indicates that the prediction transform coding mode is enabled.

In some embodiments, the decoding and reconstruction part 312 is further configured to: determine whether the number of neighbourhood nodes of a parent node of each node in the current layer is greater than a preset first number threshold; determine whether the number of neighbourhood nodes of each node in the current layer is greater than a preset second number threshold, when the number of neighbourhood nodes of the parent node of each node in the current layer is greater than the preset first number threshold; and determine a decoding mode for each node in the current layer according to the RAHT coding mode for the current layer, when the number of neighbourhood nodes of each node in the current layer is greater than the preset second number threshold.

It may be noted that, the above description of decoder apparatus embodiments is similar to the above description of decoding method embodiments. The apparatus embodiments have similar beneficial effects as the method embodiments. Technical details not disclosed in the apparatus embodiments in the disclosure are understood with reference to the description of method embodiments in the disclosure.

If the integrated unit is implemented as a software function module and not sold or used as a stand-alone product, the integrated unit may be stored in a computer-readable storage medium. Based on such understanding, the technical solution of this embodiment in essential, or a part that contributes to the prior art, or all or part of the technical solution, may be embodied in the form of a software product. The computer software product is stored in a storage medium and includes a number of instructions to enable a computer device (which may be a personal computer, a server, or a network device, etc.) or processor to perform all or part of the operations of the method described in this embodiment. The foregoing storage medium includes a USB stick, a removable hard disk, a read only memory (ROM), a random access memory (RAM), a diskette or a CD-ROM, and other media that may store program codes.

Thus, embodiments of the disclosure provide a storage medium, i.e., a computer-readable storage medium, which is applied to the decoder 30. The computer-readable storage medium is configured to store a computer program which, when executed by a second processor, is operable to implement the method described in any one of the foregoing embodiments.

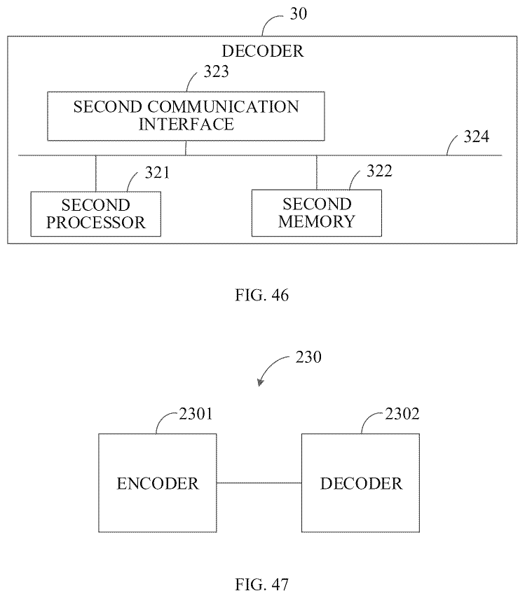

Based on the above structure of the decoder 30 and the computer-readable storage medium, FIG. 46 is schematic structural diagram 2 of a decoder. As illustrated in FIG. 46, the decoder 30 may include a second memory 322, a second processor 321, a second communication interface 323, and a second bus system 324. The second memory 322, the second processor 321, and the second communication interface 323 are coupled together via the second bus system 324. It may be understood that the second bus system 324 is configured to enable connection and communication between these components. The second bus system 324 includes a power bus, a control bus, and a status signal bus in addition to a data bus. For the sake of clarity, however, the various buses are labelled as second bus system 324.

The second communication interface 323 is configured to receive and transmit signals during information transmission with other external network elements.

The second memory 322 is configured to store a computer program executable by the second processor.

The second processor 321 is configured to determine the number of first nodes in nodes in a current layer and the number of second nodes in child nodes of the nodes in the current layer, where the number of first nodes and the number of second nodes are used for determining whether RAHT transform is performed on the nodes in the current layer; and determine reconstructed attribute values of the child nodes of the nodes in the current layer according to the number of first nodes and the number of second nodes.

It will be appreciated that the second memory 322 in embodiments of the disclosure may be a transitory memory or non-transitory memory, or may include both transitory and non-transitory memory. In particular, the non-transitory memory may be an ROM, a PROM, an EPROM, an EEPROM, or a flash memory. The transitory memory may be an RAM, which is used as an external cache. By way of illustration, but not limitation, many forms of RAM are available, such as an SRAM, a DRAM, an SDRAM, a DDRSDRAM, an ESDRAM, an SLDRAM, and a DRRAM. The second memory 322 of the system and method described in this disclosure is intended to include, but is not limited to, these and any other suitable types of memory.

The second processor 321 may be an integrated circuit chip with signal processing capabilities. During implementation, the operations in the above method may be accomplished by integrated logic circuitry in the hardware of the second processor 321 or by instructions in the form of software. The second processor 321 described above may be a general-purpose processor, a DSP, an ASIC, an FPGA, or other programmable logic device, discrete gate or transistor logic device, discrete hardware component. The various methods, steps and logic block diagrams disclosed in embodiments of the disclosure may be implemented or performed. The general-purpose processor may be a microprocessor or the processor may also be any conventional processor, etc. The operations in the method disclosed in conjunction with embodiments of the disclosure may be performed directly by the hardware decoder processor or by a combination of hardware and software modules in the decoder processor. The software module may be located in a random memory, flash memory, read-only memory, programmable read-only memory or electrically erasable programmable memory, registers and other storage media mature in the art. The storage medium is located in the second memory 322, and the second processor 321 reads the information in the second memory 322 and completes the operations of the above method in combination with its hardware.

It will be appreciated that these embodiments described in this disclosure may be implemented in hardware, software, firmware, middleware, microcode, or combinations thereof. For hardware implementations, the processing unit may be implemented in one or more ASIC, DSP, DSPD, PLD, FPGA, general-purpose processor, controller, microcontroller, microprocessor, other electronic unit for performing the functions described in this disclosure, or a combination thereof. For software implementations, the technology described in this disclosure may be implemented by means of modules (e.g., procedures, functions, etc.) that perform the functions described in this disclosure. The software code may be stored in a memory and executed by a processor. The memory may be implemented in the processor or outside the processor.

In yet another embodiment of the disclosure, reference is made to FIG. 47 which is a schematic structural diagram of a coding system provided in embodiments of the disclosure. As illustrated in FIG. 47, the coding system 230 may include an encoder 2301 and a decoder 2302.

In embodiments of the disclosure, the encoder 2301 may be an encoder described in any one of the foregoing embodiments, and the decoder 2302 may be a decoder described in any one of the foregoing embodiments.

In still another embodiment of the disclosure, a bitstream is further provided in embodiments of the disclosure. The bitstream is generated by performing bit encoding according to information to-be-encoded. The information to-be-encoded at least includes an RAHT coding mode for a current layer and attribute coding information of nodes in the current layer. The RAHT coding mode for the current layer is determined based on at least one coding cost corresponding to the nodes in the current layer. The at least one coding cost corresponding to the nodes in the current layer is determined by encoding attribute information of the nodes in the current layer using at least one RAHT coding mode.

It may be noted that in embodiments of the disclosure, the terms “include”, “comprise” or any other variant thereof are intended to cover non-exclusive inclusion, such that a process, method, article or apparatus comprising a range of elements includes not only those elements, but also includes other elements that are not explicitly listed or are also inherent to such a process, method, article or apparatus. Without further limitation, an element qualified by the statement “including a . . . ” does not preclude the existence of another identical element in the process, method, article or apparatus including that element.

The above serial numbers of the embodiments of the disclosure are for descriptive purposes only and do not represent the merits of the embodiments.

The methods disclosed in the several method embodiments provided in this disclosure may be combined in any way to obtain new method embodiments without conflict.

The features disclosed in the several product embodiments provided in this disclosure may be combined in any way to obtain new product embodiments without conflict.

The features disclosed in several method or apparatus embodiments provided in this disclosure may be combined in any way to obtain new method embodiments or apparatus embodiments without conflict.

The foregoing is only a specific implementation of the present disclosure, but the scope of protection of the present disclosure is not limited thereto, and any variation or substitution readily conceivable by any person skilled in the art within the technical scope disclosed in the present disclosure shall be covered by the scope of protection of the present disclosure. Accordingly, the scope of protection of this disclosure shall be governed by the scope of protection of the stated claims.

### INDUSTRIAL APPLICABILITY

A point cloud coding method, an encoder, a decoder, a bitstream, and a storage medium are provided in embodiments of the disclosure. The encoder encodes each node in a current layer using at least one RAHT coding mode, to determine at least one candidate attribute coding information and at least one coding cost corresponding to each node. In this way, the encoder may determine an optimal coding mode for the current layer according to the at least one coding cost corresponding to each node in the current layer, determine attribute coding information of each node according to this coding mode, and transmits the RAHT coding mode for the current layer and the attribute coding information of the node to the decoding end. The decoder performs decoding and reconstruction on attribute coding information of nodes in the current layer according to the RAHT coding mode transmitted by the encoder, to determine reconstructed attribute information of the nodes. As such, by introducing multiple coding modes and adaptively selecting an optimal decoding mode based on coding costs, attribute distribution characteristics and spatial distribution characteristics of each node are taken into comprehensive consideration, the RAHT attribute coding efficiency and the coding efficiency of attribute information of a point cloud are improved, and thus the coding performance of the point cloud is improved.

What is claimed is:

1. A point cloud decoding method, applied to a decoder and comprising:
parsing a bitstream to determine a region adaptive hierarchical transform (RAHT) coding mode for a current layer and attribute coding information of nodes in the current layer, wherein the RAHT coding mode for the current layer is determined by an encoder based on at least one coding cost corresponding to the nodes in the current layer, and the at least one coding cost corresponding to the nodes is determined by the encoder by encoding attribute information of the nodes using at least one RAHT coding mode; and
performing decoding and reconstruction on the attribute coding information of the nodes in the current layer based on the RAHT coding mode for the current layer, to determine reconstructed attribute information of the nodes.

2. The method of claim 1, wherein performing decoding and reconstruction on the attribute coding information of the nodes in the current layer based on the RAHT coding mode for the current layer, to determine the reconstructed attribute information of the nodes comprises:
in response to the RAHT coding mode being an RAHT transform coding mode, performing RAHT transform decoding on the attribute coding information to determine the reconstructed attribute information of the nodes;
wherein the RAHT transform coding mode indicates that the encoder performs RAHT transform and coding on the attribute information of the nodes.

3. The method of claim 1, wherein performing decoding and reconstruction on the attribute coding information of the nodes in the current layer based on the RAHT coding mode for the current layer, to determine the reconstructed attribute information of the nodes comprises:
in response to the RAHT coding mode being an RAHT prediction transform coding mode, performing prediction on attribute transform information of the nodes in the current layer to determine attribute information prediction values of the nodes in the current layer; and
performing RAHT transform decoding on the attribute coding information based on the attribute information prediction values, to determine the reconstructed attribute information of the nodes in the current layer;
wherein the RAHT prediction transform coding mode indicates that the encoder performs RAHT transform on the attribute information of the nodes and performs predictive coding on the attribute transform information determined through RAHT transform.

4. The method of claim 3, wherein the RAHT prediction transform coding mode comprises an RAHT intra prediction transform coding mode, and in response to the RAHT coding mode being the RAHT prediction transform coding mode, performing prediction on the attribute transform information of the nodes in the current layer to determine the attribute information prediction values of the nodes in the current layer comprises:
in response to the RAHT coding mode being an intra prediction transform coding mode, determining the attribute information prediction values of the nodes in the current layer according to attribute information prediction values of neighbourhood nodes of the nodes in the current layer.

5. The method of claim 3, wherein the RAHT prediction transform coding mode comprises an RAHT inter prediction transform coding mode, and in response to the RAHT coding mode being the RAHT prediction transform coding mode, performing prediction on the attribute transform information of the nodes in the current layer to determine the attribute information prediction values of the nodes in the current layer comprises:
in response to the RAHT coding mode being an inter prediction transform coding mode, determining collocated nodes corresponding to positions of the nodes in the current layer in a reference point cloud; and
determining the attribute information prediction values of the nodes in the current layer based on reconstructed attribute transform information of the collocated nodes.

6. The method of claim 5, further comprising:
in response to existence of no collocated node, determining the attribute information prediction values of the nodes in the current layer according to attribute information prediction values of neighbourhood nodes of the nodes in the current layer.

7. The method of claim 1, wherein determining the RAHT coding mode for the current layer comprises:
determining the RAHT coding mode for the current layer according to an RAHT coding mode flag of the current layer;
wherein the RAHT coding mode flag indicates an RAHT transform coding mode or an RAHT prediction transform coding mode, and the RAHT prediction transform coding mode comprises an inter prediction transform coding mode or an intra prediction transform coding mode.

8. The method of claim 7, further comprising:
determining a number of coding mode flags corresponding to a point cloud, wherein the point cloud is a point cloud where the current layer is located; and
parsing an RAHT coding mode flag in the bitstream according to the number of coding mode flags, to determine an RAHT coding mode flag of each layer in the point cloud.

9. The method of claim 1, further comprising:
determining at least two groups of attribute coding information corresponding to the current layer and an RAHT coding mode corresponding to each group of attribute coding information among the at least two groups of attribute coding information by parsing the bitstream, wherein the at least two groups of attribute coding information correspond to at least two node groups, the at least two node groups are obtained by partitioning the nodes in the current layer, the RAHT coding mode corresponding to each group of attribute coding information is determined based on at least one coding cost corresponding to each node group, and the at least one coding cost corresponds to the at least one RAHT coding mode; and
determining reconstructed attribute information corresponding to each group of attribute coding information by performing decoding and reconstruction on each group of attribute coding information according to the RAHT coding mode corresponding to each group of attribute coding information, to determine the reconstructed attribute information of the nodes in the current layer.

10. The method of claim 8, further comprising:
determining a prediction transform enable flag of the point cloud by parsing the bitstream, wherein the prediction transform enable flag indicates whether a prediction transform coding mode is enabled for the point cloud; and
in response to the prediction transform enable flag indicating that the prediction transform coding mode is enabled, determining the number of coding mode flags corresponding to the point cloud.

11. The method of claim 7, further comprising:
determining whether a number of neighbourhood nodes of a parent node of each node in the current layer is greater than a preset first number threshold;
in response to the number of neighbourhood nodes of the parent node of each node in the current layer being greater than the preset first number threshold, determining whether a number of neighbourhood nodes of each node in the current layer is greater than a preset second number threshold; and
in response to the number of neighbourhood nodes of each node in the current layer being greater than the preset second number threshold, determining a decoding mode for each node in the current layer according to the RAHT coding mode for the current layer.

12. A point cloud encoding method, applied to an encoder and comprising:
encoding attribute information of nodes in a current layer using at least one region adaptive hierarchical transform (RAHT) coding mode, to determine at least one candidate attribute coding information and at least one coding cost corresponding to the nodes;
determining an RAHT coding mode for the current layer based on the at least one coding cost corresponding to the nodes, and determining attribute coding information of the nodes from the at least one candidate attribute coding information; and
generating a bitstream based on the RAHT coding mode for the current layer and the attribute coding information of the nodes.

13. The method of claim 12, wherein the at least one candidate attribute coding information comprises transform coding information and prediction transform coding information, and encoding the attribute information of the nodes in the current layer using the at least one RAHT coding mode, to determine the at least one candidate attribute coding information and the at least one coding cost corresponding to the nodes comprises:
determining attribute transform information and transform coding information of each node in the current layer by performing RAHT transform coding on attribute information of each node in a point cloud;
performing predictive coding on the attribute transform information of each node in the current layer, to determine prediction transform coding information of each node in the current layer; and
determining the at least one coding cost corresponding to the nodes based on the transform coding information and the prediction transform coding information.

14. The method of claim 13, wherein performing predictive coding on the attribute transform information of each node in the current layer, to determine the prediction transform coding information of each node in the current layer comprises:
determining whether a number of neighbourhood nodes of a parent node of each node in the current layer is greater than a preset first number threshold;
in response to the number of neighbourhood nodes of the parent node of each node in the current layer being greater than the preset first number threshold, determining whether a number of neighbourhood nodes of each node in the current layer is greater than a preset second number threshold; and
in response to the number of neighbourhood nodes of each node in the current layer being greater than the preset second number threshold, performing predictive coding on the attribute transform information of each node in the current layer, to determine the prediction transform coding information of each node in the current layer.

15. The method of claim 13, wherein determining the attribute transform information and the transform coding information of each node in the current layer by performing RAHT transform coding on the attribute information of each node in the point cloud comprises:
from a node of a voxel level until a root node, determining attribute transform information and transform coding information of each node in the point cloud by recursively performing RAHT transform and coding on the attribute information of each node in the point cloud based on an RAHT attribute transform coding structure corresponding to the point cloud, to determine the transform coding information of each node in the current layer, wherein the attribute transform information is determined by performing RAHT transform on the attribute information, and the transform coding information is determined by performing coding on the attribute transform information.

16. The method of claim 13, wherein the prediction transform coding information comprises inter prediction transform coding information, and performing predictive coding on the attribute transform information of each node in the current layer, to determine the prediction transform coding information of each node in the current layer comprises:
performing inter prediction coding on the attribute transform information of each node in the current layer, to determine inter prediction transform coding information of each node in the current layer.

17. The method of claim 13, wherein the prediction transform coding information comprises intra prediction transform coding information, and performing predictive coding on the attribute transform information of each node in the current layer, to determine the prediction transform coding information of each node in the current layer comprises:
performing intra prediction coding on the attribute transform information of each node in the current layer, to determine intra prediction transform coding information of each node in the current layer.

18. The method of claim 13, wherein determining the attribute transform information and the transform coding information of each node in the current layer by performing RAHT transform coding on the attribute information of each node in the point cloud comprises:
from a root node, determining N child nodes of each node in the point cloud based on an RAHT attribute transform coding structure corresponding to the point cloud;
for the N child nodes of each node, determining attribute transform information and transform coding information of the N child nodes by performing RAHT attribute transform and coding on attribute information of the N child nodes, to determine attribute transform information and transform coding information of each node in the point cloud, wherein Nis greater than 0 and not greater than a preset threshold of a number of child nodes; and
determining the attribute transform information and the transform coding information of each node in the current layer according to the attribute transform information and the transform coding information of each node in the point cloud.

19. The method of claim 16, wherein performing inter prediction coding on the attribute transform information of each node in the current layer, to determine the inter prediction transform coding information of each node in the current layer comprises:
determining a collocated node corresponding to a position of each node in the current layer in a reference point cloud corresponding to the point cloud;
determining an attribute information prediction value of each node in the current layer based on reconstructed attribute transform information of the collocated node; and
performing coding on the attribute transform information of each node in the current layer based on the attribute information prediction value, to determine the inter prediction transform coding information of each node in the current layer.

20. A non-transitory storage medium storing a computer program and a bitstream, wherein when executed by a processor, the computer program causes the processor to implement a point cloud encoding method to generate the bitstream, and the point cloud encoding method comprises:
encoding attribute information of nodes in a current layer using at least one region adaptive hierarchical transform (RAHT) coding mode, to determine at least one candidate attribute coding information and at least one coding cost corresponding to the nodes;
determining an RAHT coding mode for the current layer based on the at least one coding cost corresponding to the nodes, and determining attribute coding information of the nodes from the at least one candidate attribute coding information; and
generating the bitstream based on the RAHT coding mode for the current layer and the attribute coding information of the nodes.
